(19) United States
(12) Patent Application Publication
(10) Pub. No.: US 2026/0368316 A1
(43) Pub. Date: Nov. 19, 2026

(54) AI/ML System and Processes for Connection Correlation Engine

(71) Applicant: Bank of America Corporation, Charlotte, NC (US)

(72) Inventors: Steven E. Sinks, Scottsdale, AZ (US); Joshua Abraham, Sharon, MA (US)

(21) Appl. No.: 19/208,839

(22) Filed: May 15, 2025

(51) Int. Cl. G06F 21/55; G06F 16/17; H04L 41/16

(52) U.S. Cl. CPC G06F 21/554; G06F 16/1734; H04L 41/16

(57) ABSTRACT

Systems and methods are disclosed for enhancing cybersecurity by correlating endpoint events, processes, and network connections using artificial intelligence and machine learning. The system monitors user-accessible file system locations and registry keys, collecting telemetry on file operations, executions, and network connections. It establishes a tailored baseline of normal activity per endpoint, detecting anomalies like files connecting to unfamiliar domains. Network-level correlation identifies coordinated threats across endpoints, with a centralized web console providing visualized alerts and remediation recommendations. Scalable via cloud-based processing, the system supports real-time analysis, continuous learning, and non-repudiation through cryptographically signed logs. Customizable thresholds and threat intelligence integration enhance adaptability, enabling proactive detection of sophisticated threats bypassing traditional tools.

### TECHNICAL FIELD

The inventions disclosed herein pertain to systems and methods for analyzing and modeling data to detect patterns and anomalies in digital communications and computing environments. Specifically, the inventions involve techniques for processing and correlating telemetry data from endpoint devices, network connections, and user interactions with data stores, utilizing artificial intelligence and machine learning to identify deviations from established norms. These systems monitor file system operations, registry modifications, and network traffic to detect potential security threats, as well as track user events across databases to ensure traceability and non-repudiation, aligning with technologies focused on data security, network monitoring, and automated decision-making processes.

### DESCRIPTION OF THE RELATED ART

In modern corporate IT environments, the increasing sophistication of cyber threats poses a significant challenge to maintaining secure systems. Malicious actors, whether external attackers or internal threats, have developed advanced techniques to evade conventional security measures such as antivirus software, endpoint detection and response tools, host-based intrusion detection systems, and network-based intrusion detection systems. These traditional tools often rely on predefined signatures or known patterns of malicious activity, which are insufficient against novel or adaptive threats that attack vulnerabilities in less monitored areas of a system. The inability to detect such threats early allows attackers to establish persistence, escalate privileges, or exfiltrate sensitive data, leading to substantial financial and reputational damage for organizations.

A primary issue lies in the targeting of common system locations where users have read and write permissions, such as specific directories and registry hives. These areas, accessible to non-administrative users, are frequently targeted by attackers because they offer a low barrier to entry for deploying malicious code or establishing persistent mechanisms. For instance, directories like those used for temporary files or application data, and user-specific registry hives, are ideal for hiding executables, scripts, or dynamic link libraries that can execute without requiring elevated privileges. The lack of robust monitoring in these locations allows attackers to operate undetected, as standard security tools often focus on system-wide or network-level activities rather than granular, user-specific operations.

The challenge is compounded by the difficulty in distinguishing legitimate user activities from malicious ones in these accessible locations. Users in corporate environments perform a wide range of tasks that involve creating, modifying, or executing files in these directories, and their permissions vary across organizations. This variability makes it arduous to establish a universal standard for normal activity, as what is permissible in one organization may be restricted in another. Without a clear baseline, security systems struggle to identify anomalies, resulting in either missed threats or excessive false positives that overwhelm security teams and hinder effective response.

Another significant problem is the lack of correlation between endpoint activities and network connections. Malicious actors often initiate network communications from compromised endpoints to external domains for command-and-control purposes or data exfiltration. However, existing tools rarely link file executions or registry changes on an endpoint to the specific network connections they generate. This disconnect prevents security teams from identifying whether a file execution in a user-accessible directory is communicating with a suspicious domain, limiting the ability to trace the full scope of an attack. The absence of such correlation leaves organizations vulnerable to attacks that attack both local and network-based vectors.

The complexity of modern IT environments further exacerbates these issues. Organizations operate thousands of endpoints, each with unique configurations, user permissions, and operational contexts. Monitoring and analyzing activities across this scale manually is impractical, and existing automated tools lack the sophistication to adapt to diverse environments. Threats that propagate across multiple endpoints or subnets often go unnoticed until significant damage has occurred, as current systems fail to aggregate and analyze data at a network-wide level. This gap allows coordinated attacks, such as those involving advanced persistent threats, to persist undetected for extended periods.

User-specific activities present an additional layer of difficulty. In large organizations, users interact with various data stores and applications, generating a vast amount of event data. Tracking these interactions to identify suspicious behavior, such as accessing sensitive files from unusual locations, is a daunting task. Existing systems lack the capability to contextualize user actions with metadata like geographic location or group membership, making it challenging to detect anomalies that deviate from typical patterns. For example, a user accessing critical files while in a high-risk region may indicate a compromised account, but without contextual analysis, such events are often overlooked.

The need for non-repudiation in tracking user actions adds another dimension to the problem. Organizations require mechanisms to definitively attribute actions to specific users or applications, ensuring accountability and traceability. However, traditional methods like Blockchain-based tracking are computationally intensive and impractical for real-time security applications. Current systems struggle to provide lightweight, scalable solutions that achieve similar traceability without requiring complex architectures, leaving a gap in the ability to audit and verify user activities effectively.

The rapid evolution of threat tactics further complicates the landscape. Attackers continuously adapt their methods to bypass improving security controls, targeting the lag between threat emergence and the deployment of countermeasures. This dynamic environment demands proactive detection capabilities that can identify unknown or emerging threats before they cause harm. Existing reactive approaches, which rely on post-incident analysis or known threat signatures, are inadequate for addressing zero-day attacks or sophisticated insider threats that blend into normal operations.

The scale and diversity of corporate networks also pose challenges for centralized monitoring. Security teams need consolidated views of potential threats across endpoints, subnets, and data stores to respond effectively. However, current tools often provide fragmented insights, requiring manual integration of data from multiple sources. This inefficiency delays response times and increases the risk of oversight, particularly for threats that span multiple systems or involve subtle anomalies that are only apparent when viewed in aggregate.

The long-felt and unmet need for these solutions stems from the persistent gaps in existing cybersecurity frameworks. For the first invention, addressing connection correlation, there has been a prolonged demand for a system that links endpoint activities to network communications, enabling detection of threats that target both local and external vectors, yet no commercial tool has effectively bridged this gap. For the second invention, focused on endpoint telemetry, organizations have long sought a method to monitor user-accessible locations with precision, adapting to varied permission structures without generating excessive false alerts, a need unmet by traditional endpoint security solutions. For the third invention, centered on user event telemetry, there has been an enduring requirement for a scalable, lightweight approach to track and contextualize user interactions across data stores, providing traceability without the overhead of complex systems, a challenge that remains unaddressed in current market offerings. These persistent needs highlight the critical demand for innovative approaches to enhance threat detection and response in modern IT environments.

### SUMMARY OF THE INVENTION

The inventions disclosed herein encompass three distinct yet complementary systems designed to enhance cybersecurity in corporate IT environments through advanced artificial intelligence and machine learning techniques. In a first aspect, a system correlates endpoint events, processes, and network connections to detect anomalous activities, focusing on user-accessible file system locations and registry keys. In a second aspect, a system provides granular monitoring of endpoint activities, targeting file and registry operations to identify potential malicious behavior with high precision. In a third aspect, a system tracks and analyzes user interactions with backend databases, emphasizing traceability and non-repudiation through dynamic event monitoring. Together, these systems address critical gaps in traditional security frameworks, offering scalable, adaptive, and proactive solutions for threat detection and response across diverse organizational contexts.

In a first aspect of the inventions disclosed herein, a system is engineered to bolster cybersecurity by correlating endpoint events, processes, and network connections through advanced artificial intelligence and machine learning techniques. The system meticulously monitors file system locations and registry keys where users possess read and write permissions, such as directories designated for application data storage or temporary file management, and user-specific registry hives. These locations are strategically chosen due to their accessibility to non-administrative users, rendering them frequent targets for malicious activities aiming to establish persistence or execute unauthorized code. The system gathers extensive telemetry data, encompassing file read and write operations, executions of diverse file types including executables, dynamic link libraries, scripts, and batch files, as well as network connections initiated from these monitored areas. This telemetry captures granular metadata, including file names, full paths, file sizes, creation and modification timestamps, user permissions, process identifiers, and associated digital signatures, providing a comprehensive dataset for in-depth analysis.

The artificial intelligence and machine learning components in this first aspect construct a tailored baseline of normal activity for each endpoint, customized to the specific user's operational context or system configuration. This baseline encapsulates intricate patterns, such as the frequency and timing of file accesses, types of files typically executed (e.g., software binaries versus user scripts), and domains routinely contacted during network communications. The system employs a combination of supervised learning models, trained on historical data, and unsupervised learning models, such as clustering algorithms, to discern regular operational behaviors, such as routine software updates, user-initiated file transfers, or scheduled backups. By processing incoming telemetry in real time, the system identifies deviations, such as a file in a monitored directory initiating a connection to an unfamiliar or potentially malicious domain, flagging these as anomalies for further scrutiny.

The correlation process in this first aspect is a cornerstone of its functionality, extending analysis from individual endpoints to encompass subnets and entire network infrastructures. The system aggregates telemetry data across multiple endpoints, employing distributed data processing frameworks to handle large-scale datasets efficiently. This aggregation enables the detection of coordinated patterns, such as multiple devices exhibiting similar file executions followed by connections to the same external domain, which may indicate a distributed attack campaign. The system's network-level correlation is particularly adept at identifying sophisticated threats, such as those that operate across multiple systems or employ subtle, distributed tactics to evade detection, ensuring a holistic view of potential security incidents.

A centralized web console serves as the primary interface for security teams in this first aspect, delivering detailed alerts enriched with contextual information, including the nature of the anomaly, the specific file or process involved, the domain contacted, the precise timestamp, and the affected endpoint's network context (e.g., subnet or VLAN membership). The console features interactive dashboards with advanced visualizations, such as directed graphs of connection patterns, timelines of file activities, and heatmaps of endpoint activity, facilitating rapid threat assessment. Alerts are prioritized using risk scores generated by the artificial intelligence models, which consider factors like the anomaly's severity, the sensitivity of the affected data, and the endpoint's role within the network, ensuring that high-priority threats are addressed promptly.

Remediation capabilities in this first aspect are robust, with the console offering actionable recommendations, such as isolating affected endpoints, blocking specific domains at the firewall level, or initiating forensic analysis to preserve evidence. The system supports automated remediation in high-confidence scenarios, such as automatically quarantining a device exhibiting unambiguous malicious behavior, with all actions logged for audit purposes. These logs include detailed event metadata, such as network packet captures and file hashes, ensuring a complete audit trail for compliance and post-incident analysis. The system's integration with existing security information and event management platforms enhances its interoperability, allowing seamless incorporation into broader security operations.

Scalability is a pivotal feature of this system, enabling real-time processing of telemetry from thousands of endpoints without performance degradation. The system leverages cloud-based distributed computing architectures, such as serverless frameworks, to scale dynamically with demand, ensuring efficient handling of large datasets. This scalability is critical for organizations with complex, geographically dispersed IT infrastructures, where endpoints may operate across multiple time zones or network segments. The artificial intelligence models are optimized for low-latency processing, achieving anomaly detection and reporting within milliseconds, which is essential for time-sensitive threat response.

Continuous learning is integral to the system's design in this first aspect, with artificial intelligence models refining the baseline as new telemetry is collected. For instance, if a user's role changes, resulting in altered file access patterns, the system incrementally updates its baseline to reflect this shift, minimizing false positives. The models incorporate feedback loops, where security team validations of flagged anomalies are used to fine-tune detection algorithms, enhancing accuracy over time. This adaptive learning ensures the system remains effective in dynamic environments where user behaviors, system configurations, and network topologies evolve.

One unique feature of this first aspect is its ability to bypass limitations of traditional security tools, such as antivirus software, endpoint detection and response systems, host-based intrusion detection, and network-based intrusion detection. These tools often rely on static signatures or known patterns, rendering them less effective against novel or adaptive threats. This system's artificial intelligence-driven approach detects previously unseen anomalies by analyzing behavioral patterns, providing a proactive defense against zero-day attacks. The correlation of process-to-domain-to-event data is particularly innovative, linking local endpoint activities with external network communications in a manner that traditional tools cannot replicate.

Non-repudiation is supported in this first aspect through meticulous logging of all monitored activities, ensuring that actions can be traced back to specific processes or users. Logs include cryptographic hashes of files, detailed network connection records (e.g., source and destination IPs, ports, and protocols), and user authentication data, providing a verifiable record for forensic analysis. This traceability is achieved with minimal computational overhead, using optimized data structures to ensure efficiency in real-time operations. The system's lightweight design allows it to operate on resource-constrained endpoints without impacting performance, making it practical for widespread deployment.

The system's adaptability to diverse environments enhances its utility in this first aspect. In organizations with varying levels of access to file systems or registries, the system adjusts its baseline to account for these differences, ensuring accurate detection without generating excessive alerts. For example, in an environment where users frequently create temporary files as part of their workflow, the system distinguishes legitimate activities from suspicious ones, such as the introduction of an unauthorized executable. This adaptability is facilitated by machine learning models that learn organization-specific norms during an initial training phase.

Integration with external threat intelligence feeds is a critical enhancement in this first aspect, allowing the system to cross-reference telemetry with real-time data on known malicious domains, IP addresses, or file hashes. This integration is seamless, with the system automatically updating its models to incorporate new intelligence without requiring manual intervention. The ability to leverage external data sources ensures the system remains current with emerging threats, enhancing its effectiveness against rapidly evolving attack vectors.

Customizable alert thresholds in this first aspect allow organizations to tailor the system's sensitivity to their specific risk tolerance. For instance, a highly regulated industry may configure the system to flag minor deviations, such as unexpected file modifications, while a less sensitive environment may prioritize only high-risk anomalies, such as connections to known malicious domains. This customization is facilitated through the web console, which provides a user-friendly interface for configuring detection parameters, enabling administrators to balance sensitivity and operational efficiency.

The system's focus on network-level correlation in this first aspect enables the detection of advanced persistent threats, which often employ low-and-slow strategies that are difficult to identify at the endpoint level. By analyzing patterns across subnets, the system uncovers subtle indicators of compromise, such as periodic connections to a suspicious domain from multiple devices. This capability is particularly valuable for detecting threats that mimic legitimate activities but exhibit anomalous network patterns when viewed in aggregate, such as lateral movement within a network.

Comprehensive reporting capabilities in this first aspect support compliance with regulatory requirements. The system generates detailed reports for audits, providing evidence of monitoring, detection, and remediation activities. These reports include advanced visualizations, such as network connection graphs, endpoint activity heatmaps, and anomaly timelines, to facilitate communication with stakeholders. The system's compliance features ensure that organizations can demonstrate due diligence, with exportable logs and reports compatible with common regulatory frameworks.

The overall design of this first aspect prioritizes usability, minimizing the burden on security teams. The web console's intuitive interface, with role-based access controls and customizable views, reduces the learning curve for administrators. Automated remediation, alert prioritization, and integration with existing security workflows streamline response processes, ensuring that the system complements established practices. This user-centric design makes the system a practical solution for organizations seeking to enhance their cybersecurity posture.

In a second aspect of the inventions disclosed herein, a system is designed to provide granular monitoring and analysis of endpoint activities to detect potential malicious behavior. The system targets file system locations and registry keys where users have read and write permissions, such as directories for application data storage or temporary file management, and user-specific registry hives. These areas are monitored due to their accessibility to non-administrative users, making them prime targets for attackers seeking to deploy malicious code or establish persistence. The system collects exhaustive telemetry data, capturing file creations, modifications, deletions, executions, and registry changes, along with metadata such as file paths, sizes, creation and modification timestamps, user accounts, process identifiers, and file permissions.

Using artificial intelligence and machine learning, the system in this second aspect establishes a user-specific baseline of normal activity for each endpoint. This baseline reflects intricate patterns, such as the frequency of file creations in specific directories, types of files executed (e.g., text files versus binaries), and the rarity of registry key modifications, tailored to the user's role and workflow. The system employs clustering algorithms to group similar activities and anomaly detection models to identify outliers, enabling it to flag unexpected behaviors, such as a user executing a script in a directory typically used for data storage.

The system analyzes telemetry in real time to detect anomalies, such as the sudden appearance of an unknown executable, a new dynamic link library, or an unexpected registry key creation. These anomalies are evaluated based on multiple criteria, including file type, location, execution context, associated metadata, and historical user behavior. The system assigns risk scores to each anomaly, prioritizing those with higher potential impact for review. Detailed reports are generated, including the file's origin (e.g., downloaded versus locally created), execution context (e.g., parent process), and any associated network activity, providing security teams with comprehensive information to assess the threat.

Correlation of endpoint anomalies with network connections is a key feature in this second aspect. If an unknown file in a monitored directory initiates a connection to an unfamiliar domain, the system identifies this as a potential command-and-control communication and flags it accordingly. This correlation is performed using machine learning models that analyze network traffic patterns, such as connection frequency, data volume, destination IP addresses, and protocol types. The system's ability to link local and external activities enhances its detection of complex threats that involve multiple vectors, such as malware that establishes persistence and communicates externally.

The focus on endpoint-specific telemetry in this second aspect achieves a high level of granularity, enabling early detection of malicious behavior before it escalates. By concentrating on local activities, the system identifies subtle indicators of compromise, such as a new registry key that ensures persistence across system reboots or a file modification that deviates from typical user patterns. This granularity is valuable in environments where users have diverse permissions, as the system adapts to organization-specific norms to minimize false positives while maintaining sensitivity to genuine threats.

Scalability is a critical feature in this second aspect, allowing the system to operate efficiently on individual endpoints while supporting aggregation of telemetry data across an organization's IT environment. The system uses distributed processing frameworks to handle large datasets, ensuring that telemetry from thousands of endpoints can be analyzed without performance degradation. The artificial intelligence components are optimized for low-latency processing, achieving anomaly detection within milliseconds, which is essential for rapid response in dynamic environments.

Continuous learning is integral to the system's design in this second aspect, with artificial intelligence models refining the baseline as new telemetry is collected. For example, if a user's workflow changes, resulting in new file access patterns, the system incrementally updates its baseline to reflect this shift, reducing false positives. The models incorporate feedback loops, where security team validations of flagged anomalies are used to fine-tune detection algorithms, enhancing accuracy over time. This adaptive learning ensures the system remains effective in environments where user behaviors and system configurations evolve.

One unique feature of this second aspect is its granular, endpoint-centric approach, contrasting with the broader focus of traditional endpoint detection and response systems. By leveraging artificial intelligence to analyze file and registry events in real time, the system provides a proactive defense against threats that evade signature-based tools. Its ability to correlate local events with network activity enhances its effectiveness, enabling detection of complex attacks that involve multiple vectors, such as malware that modifies a registry key and communicates with an external server.

Customizable detection thresholds in this second aspect allow organizations to tailor the system's sensitivity to their specific risk tolerance. For example, a highly regulated industry may configure the system to flag minor deviations, such as unexpected file modifications, while a less sensitive environment may prioritize only high-risk anomalies, such as executions of unknown binaries. This customization is facilitated through a user-friendly interface, enabling administrators to adjust parameters without requiring extensive technical expertise. The system's flexibility ensures it can meet the needs of diverse organizations.

Comprehensive reporting capabilities in this second aspect support compliance with regulatory requirements. The system generates detailed reports for audits, providing evidence of monitoring, detection, and remediation activities. These reports include visualizations, such as timelines of file activities, graphs of registry changes, and endpoint activity heatmaps, to facilitate communication with stakeholders. The system's compliance features ensure that organizations can demonstrate due diligence, with exportable logs and reports compatible with common regulatory frameworks.

Integration with external threat intelligence feeds enhances the system's capabilities in this second aspect. By incorporating data on known malicious files, IP addresses, or domains, the system can cross-reference telemetry with real-time threat intelligence, improving the accuracy of anomaly detection. This integration is seamless, with the system automatically updating its models to incorporate new intelligence without requiring manual intervention. The ability to leverage external data sources ensures the system remains current with emerging threats.

The system's lightweight design in this second aspect ensures it can operate on resource-constrained endpoints without impacting performance. By optimizing data collection and processing, the system minimizes its footprint, making it suitable for deployment on a wide range of devices, from desktops to laptops. This efficiency enhances its practicality for organizations with diverse endpoint configurations, ensuring broad compatibility.

The system's focus on endpoint-specific telemetry in this second aspect enables it to detect threats that mimic legitimate activities, such as insider threats or compromised accounts. For example, a user creating an unauthorized executable in a monitored directory may indicate malicious intent, and the system's granular analysis can flag this activity for review. This capability is particularly valuable in environments with high insider risk, such as those handling sensitive data.

Usability is a priority in this second aspect, with a focus on minimizing the burden on security teams. The intuitive interface, with role-based access controls and customizable views, reduces the learning curve for administrators. Automated prioritization and integration with existing security workflows streamline response processes, ensuring that the system complements established practices. This user-centric design makes the system a practical solution for organizations seeking to enhance their cybersecurity posture.

The overall design of this second aspect emphasizes early detection and rapid response, enabling organizations to mitigate threats before they cause significant harm. The system's granular telemetry, combined with artificial intelligence-driven analysis and network correlation, provides a comprehensive approach to endpoint security, addressing critical gaps in traditional tools and ensuring robust protection against sophisticated threats.

In a third aspect of the inventions disclosed herein, a system is designed to track and analyze user interactions with backend databases or data stores to enhance security and traceability. The system monitors user events, such as file accesses, application interactions, or database queries, capturing extensive metadata, including user identity, file type, access time, IP address, device type, operating system version, and application context. This telemetry is collected from data stores, providing a comprehensive view of user activities across an organization's IT environment. The system ensures non-repudiation, allowing actions to be definitively attributed to specific users or applications, which is critical for audit, compliance, and forensic purposes.

Artificial intelligence and machine learning in this third aspect establish a normalized baseline of user activity, reflecting typical behaviors within specific user groups or roles. The system learns the expected patterns of file access, such as the frequency and timing of accesses for users in a particular department, taking into account their permissions, work hours, and operational context. This baseline is built using advanced clustering and anomaly detection algorithms, enabling the system to identify outliers that deviate from expected patterns. For example, the system learns that users in a finance department typically access certain file types during business hours, allowing it to flag accesses outside this norm as potential anomalies.

The system analyzes telemetry in real time to detect anomalies, such as a user accessing sensitive files from an unusual geographic location, at an atypical time, or using an unrecognized device. These anomalies are flagged as conditional events, prompting further analysis. The system evaluates conditional events based on multiple criteria, including the user's role, the file's sensitivity, the access context (e.g., IP address, device type), and historical user behavior. Risk scores are assigned to each event, prioritizing those with higher potential impact for review, ensuring that security teams focus on the most pressing threats.

One unique feature of this third aspect is the use of dynamic “canary” events to track suspicious activities. When a conditional event is detected, such as a user accessing a restricted file from an unrecognized IP address, the system generates a canary event to monitor subsequent actions. For example, it tracks whether the user attempts additional file downloads, data transfers, or unauthorized application launches, which could indicate a security breach. This dynamic tracking reduces false positives by confirming anomalies through follow-up behavior, while maintaining sensitivity to genuine threats, providing a proactive approach to threat mitigation.

The system correlates conditional events with metadata from external repositories, such as IP reputation databases, user group permissions, device management systems, or geolocation services. This correlation provides critical context, enabling the system to determine whether an event is likely malicious or benign. For instance, if a user's access from an unusual location coincides with a known high-risk IP address, the system escalates the alert with a high-risk score. The integration of diverse metadata sources enhances the system's accuracy, ensuring that anomalies are evaluated in a comprehensive and context-aware manner.

Remediation is a key component of this third aspect, with the system initiating actions to mitigate confirmed anomalies. These actions include temporarily restricting the user's access, revoking session tokens, notifying administrators, or suggesting containment measures, such as isolating the affected user's device. These remediation actions are logged, ensuring a complete audit trail for compliance and post-incident analysis. The system's remediation capabilities are designed to be both automated and manual, allowing organizations to balance efficiency with human oversight based on their operational needs.

The system generates detailed audit trails in this third aspect, ensuring that all monitored activities can be traced back to specific users or applications. These audit trails include cryptographic hashes of accessed files, user authentication data (e.g., token identifiers), and comprehensive metadata about the access context, such as network details and geolocation data, providing a verifiable record for forensic analysis. The system's non-repudiation capabilities are critical for organizations subject to strict regulatory requirements, ensuring that actions can be definitively attributed without ambiguity.

The lightweight approach to traceability in this third aspect is a significant advantage, achieving robust outcomes with minimal computational overhead. Unlike systems requiring substantial resources, this system uses efficient data structures and processing algorithms to minimize its footprint, making it practical for real-time use in large organizations. The system's lightweight design ensures it can operate on resource-constrained systems, such as database servers or application gateways, without impacting performance.

Scalability is a critical feature in this third aspect, allowing the system to process telemetry data from thousands of users and data stores without performance degradation. The system leverages distributed computing architectures, such as cloud-based processing or containerized environments, to scale dynamically with demand. This scalability ensures that organizations with geographically dispersed users or extensive data stores can deploy the system effectively, maintaining performance across complex IT environments.

Continuous learning is integral to the system's design in this third aspect, with artificial intelligence models refining the baseline as new telemetry is collected. For example, if a user's role changes, resulting in new access patterns, the system incrementally updates its baseline to reflect this shift, reducing false positives. The models incorporate feedback loops, where administrator validations of flagged events are used to fine-tune detection algorithms, enhancing accuracy over time. This adaptive learning ensures the system remains effective in dynamic environments where user behaviors and organizational structures evolve.

Comprehensive reporting capabilities in this third aspect support compliance with regulatory requirements. The system generates detailed reports for audits, providing evidence of monitoring, detection, and remediation activities. These reports include advanced visualizations, such as timelines of user activities, graphs of access patterns, and geolocation maps, to facilitate communication with stakeholders. The system's compliance features ensure that organizations can demonstrate due diligence, with exportable logs and reports compatible with common regulatory frameworks.

Integration with external threat intelligence feeds enhances the system's capabilities in this third aspect. By incorporating data on known high-risk IP addresses, compromised credentials, or malicious file types, the system can cross-reference telemetry with real-time threat intelligence, improving the accuracy of anomaly detection. This integration is seamless, with the system automatically updating its models to incorporate new intelligence without requiring manual intervention, ensuring it remains current with emerging threats.

The system's focus on user-centric telemetry in this third aspect enables it to detect threats that involve subtle anomalies, such as compromised accounts or unauthorized access. For example, a user accessing sensitive files from an unusual location may indicate a security breach, and the system's contextual analysis can flag this activity for review. This capability is particularly valuable in environments with high insider risk, where distinguishing legitimate from malicious activities requires detailed user behavior analysis.

Usability is a priority in this third aspect, with a focus on minimizing the burden on security teams. The intuitive interface, with role-based access controls and customizable views, reduces the learning curve for administrators. Automated remediation, alert prioritization, and integration with existing security workflows streamline response processes, ensuring that the system complements established practices. This user-centric design makes the system a practical solution for organizations seeking to enhance their cybersecurity posture.

The overall design of this third aspect emphasizes proactive threat mitigation, enabling organizations to address risks before they escalate. The system's dynamic canary events, combined with artificial intelligence-driven analysis and metadata correlation, provide a comprehensive approach to user security, addressing critical gaps in traditional tools and ensuring robust protection against sophisticated threats.

In light of the preceding discussion, the following identifies various sample embodiments of the present disclosure to establish a basic understanding of its various components. This summary is not exhaustive, nor does it limit the illustrative embodiments of the inventions described in this document. It is not intended to identify the most essential features or steps of the disclosure, nor to define its scope. Instead, as would be recognized by someone skilled in the field, it seeks to introduce certain concepts of the disclosure in a clear and simple way, acting as a preface to the more detailed explanation that follows. Throughout this application, the specification offers thorough written descriptions of the inventions, including exemplary, non-exhaustive, and non-limiting methods and processes for making and using the inventions. These descriptions are expressed in complete, clear, concise, and precise terms, allowing those skilled in the art to implement and utilize various embodiments of the inventions without undue experimentation.

In some arrangements, a method for detecting anomalous network activity in a computing environment involves several steps executed by a computing system. The computing system monitors file system locations and registry keys on an endpoint device where a user has read and write access, including at least one of an application data directory, a temporary directory, or a user-specific registry hive. The computing system collects telemetry data, which includes file read operations, file write operations, file executions, registry modifications, and network connections initiated from the monitored file system locations and registry keys. An artificial intelligence model establishes a baseline of normal activity for the telemetry data specific to the endpoint device, incorporating patterns of file access frequency, execution types, and contacted domains.

The method continues with the artificial intelligence model detecting an anomaly by identifying a deviation from the baseline, where the deviation involves a file execution from a monitored location initiating a connection to a previously unseen domain. The computing system correlates the anomaly with network activity across a plurality of endpoint devices to identify a coordinated pattern of anomalous behavior. The computing system integrates threat intelligence data from an external source to validate the anomaly by cross-referencing the telemetry data with known malicious domains or file hashes. An alert is generated by the computing system, including the anomaly, a risk score, and a visualization of the coordinated pattern, which is displayed on a centralized console. The computing system logs the telemetry data and the alert in a cryptographically signed audit log to ensure non-repudiation.

In some arrangements, the method described above is modified to include an additional specification for the artificial intelligence model. The artificial intelligence model includes a supervised learning model that is trained on historical telemetry data labeled as normal activity, enhancing the accuracy of the baseline establishment and anomaly detection processes.

In some arrangements, the method is further refined by incorporating additional steps for the artificial intelligence model. The artificial intelligence model employs an unsupervised clustering model to group similar activities in the telemetry data based on file access frequency and execution types. The outputs of the supervised learning model and the unsupervised clustering model are combined to refine the baseline, improving the system's ability to detect subtle deviations from normal activity patterns.

In some arrangements, the method includes a specific approach to correlating anomalies with network activity. The computing system aggregates telemetry data from the plurality of endpoint devices within a predefined time window of one hour, enabling the identification of coordinated patterns of anomalous behavior across the network.

In some arrangements, the method enhances the integration of threat intelligence data. The computing system automatically updates the artificial intelligence model with new malicious domain data retrieved from the external source, ensuring that the model remains current with emerging threat information.

In some arrangements, the method incorporates additional steps for risk assessment and alert prioritization. The computing system calculates the risk score for the anomaly based on the file type of the file execution, the reputation of the previously unseen domain, and the frequency of the coordinated pattern. The alert is prioritized on the centralized console based on the risk score, allowing security teams to focus on high-priority threats.

In some arrangements, the method refines the alert generation process. The computing system creates a directed graph visualization showing connections between the endpoint device and the previously unseen domain, enhancing the centralized console's ability to convey complex network relationships to security teams.

In some arrangements, the method includes specific remediation actions. The computing system executes an automated remediation action when the risk score exceeds a predefined threshold, with the automated remediation action including quarantining the endpoint device. When the risk score is below the predefined threshold, the computing system recommends a manual remediation action via the centralized console, such as initiating forensic analysis.

In some arrangements, the method enhances the logging process for non-repudiation. The computing system stores a cryptographic hash of a file associated with the file execution and network connection details in the audit log, ensuring that the logged data is verifiable and tamper-resistant.

In some arrangements, the method incorporates feedback and retraining mechanisms. The computing system retrieves feedback from a security team via the centralized console regarding the alert. The computing system retrains the artificial intelligence model using the feedback and recent telemetry data to update the baseline, ensuring continuous improvement in detection accuracy.

In some arrangements, a comprehensive method for detecting anomalous network activity in a computing environment encompasses a wide range of steps executed by a computing system. The computing system monitors file system locations and registry keys on an endpoint device where a user has read and write access, including at least one of an application data directory, a temporary directory, or a user-specific registry hive. The computing system collects telemetry data, which includes file read operations, file write operations, file executions, registry modifications, and network connections initiated from the monitored file system locations and registry keys, with metadata comprising file names, file paths, timestamps, user permissions, and process identifiers.

An artificial intelligence model establishes a baseline of normal activity for the telemetry data specific to the endpoint device, incorporating patterns of file access frequency, execution types, and contacted domains, using a supervised learning model trained on historical telemetry data labeled as normal activity and an unsupervised clustering model to group similar activities. The artificial intelligence model detects an anomaly by identifying a deviation from the baseline, where the deviation involves a file execution from a monitored location initiating a connection to a previously unseen domain. The computing system correlates the anomaly with network activity across a plurality of endpoint devices within a one-hour time window to identify a coordinated pattern of anomalous behavior.

The computing system integrates threat intelligence data from an external source to validate the anomaly by cross-referencing the telemetry data with known malicious domains or file hashes, automatically updating the artificial intelligence model with new malicious domain data. The computing system calculates a risk score for the anomaly based on the file type of the file execution, the reputation of the previously unseen domain, and the frequency of the coordinated pattern. An alert is generated by the computing system, including the anomaly, the risk score, a directed graph visualization showing connections between the endpoint device and the previously unseen domain, and a timeline of related activities for display on a centralized console.

The computing system prioritizes the alert on the centralized console based on the risk score. When the risk score exceeds a predefined threshold, the computing system executes an automated remediation action, such as quarantining the endpoint device or blocking the previously unseen domain. When the risk score is below the predefined threshold, the computing system recommends a manual remediation action via the centralized console, such as initiating forensic analysis. The computing system logs the telemetry data and the alert in a cryptographically signed audit log, including a cryptographic hash of a file associated with the file execution and network connection details, to ensure non-repudiation.

The computing system retrieves feedback from a security team via the centralized console regarding the alert and retrains the artificial intelligence model using the feedback and recent telemetry data to update the baseline. The computing system processes the telemetry data using a cloud-based distributed computing framework to ensure scalability across thousands of endpoint devices, completing the comprehensive method for anomalous network activity detection.

In some arrangements, a system for detecting anomalous network activity in a computing environment comprises multiple modules working in concert. A monitoring module is configured to monitor file system locations and registry keys on an endpoint device where a user has read and write access, including at least one of an application data directory, a temporary directory, or a user-specific registry hive. A telemetry collection module is configured to collect telemetry data, which includes file read operations, file write operations, file executions, registry modifications, and network connections initiated from the monitored file system locations and registry keys.

An artificial intelligence module is configured to establish a baseline of normal activity for the telemetry data specific to the endpoint device, incorporating patterns of file access frequency, execution types, and contacted domains. An anomaly detection module is configured to detect an anomaly by identifying a deviation from the baseline, where the deviation involves a file execution from a monitored location initiating a connection to a previously unseen domain. A correlation module is configured to correlate the anomaly with network activity across a plurality of endpoint devices to identify a coordinated pattern of anomalous behavior.

A threat intelligence integration module is configured to integrate threat intelligence data from an external source to validate the anomaly by cross-referencing the telemetry data with known malicious domains or file hashes. An alert generation module is configured to generate an alert, including the anomaly, a risk score, and a visualization of the coordinated pattern, for display on a centralized console. A logging module is configured to log the telemetry data and the alert in a cryptographically signed audit log to ensure non-repudiation.

In some arrangements, the system described above includes an additional specification for the artificial intelligence module. The artificial intelligence module includes a supervised learning model trained on historical telemetry data labeled as normal activity, enhancing the baseline establishment and anomaly detection processes.

In some arrangements, the system is further refined by incorporating additional modules. A clustering module is configured to employ an unsupervised clustering model to group similar activities in the telemetry data based on file access frequency and execution types. A baseline refinement module is configured to combine outputs of the supervised learning model and the unsupervised clustering model to refine the baseline, improving the system's ability to detect subtle deviations from normal activity patterns.

In some arrangements, the system specifies the correlation module's approach. The correlation module is configured to aggregate telemetry data from the plurality of endpoint devices within a predefined time window of one hour, enabling the identification of coordinated patterns of anomalous behavior across the network.

In some arrangements, the system enhances the threat intelligence integration module. The threat intelligence integration module is configured to automatically update the artificial intelligence module with new malicious domain data retrieved from the external source, ensuring that the module remains current with emerging threat information.

In some arrangements, the system incorporates additional modules for risk assessment and alert prioritization. A risk assessment module is configured to calculate the risk score for the anomaly based on the file type of the file execution, the reputation of the previously unseen domain, and the frequency of the coordinated pattern. A prioritization module is configured to prioritize the alert on the centralized console based on the risk score, allowing security teams to focus on high-priority threats.

In some arrangements, the system refines the alert generation module. The alert generation module is configured to create a directed graph visualization showing connections between the endpoint device and the previously unseen domain, enhancing the centralized console's ability to convey complex network relationships to security teams.

In some arrangements, the system includes specific remediation modules. A remediation module is configured to execute an automated remediation action when the risk score exceeds a predefined threshold, with the automated remediation action including quarantining the endpoint device. A recommendation module is configured to recommend a manual remediation action via the centralized console when the risk score is below the predefined threshold, such as initiating forensic analysis.

In some arrangements, the system enhances the logging process for non-repudiation. An audit module is configured to store a cryptographic hash of a file associated with the file execution and network connection details in the audit log, with the network connection details including source IP address, destination IP address, port numbers, and protocol type. A feedback module is configured to retrieve feedback from a security team via the centralized console regarding the alert, with the feedback including validation of the anomaly as malicious or benign.

A retraining module is configured to retrain the artificial intelligence module using the feedback and recent telemetry data collected within a 24-hour period to update the baseline. A scalability module is configured to process the telemetry data using a cloud-based distributed computing framework to ensure scalability across thousands of endpoint devices, utilizing serverless architectures to dynamically allocate resources based on telemetry volume. A visualization module is configured to generate a timeline visualization of related activities associated with the anomaly, including timestamps of file executions, registry modifications, and network connections, displayed on the centralized console to facilitate security team analysis.

In some arrangements, a method for monitoring endpoint activity in a computing environment involves several steps executed by a computing system. The computing system monitors file system locations and registry keys on an endpoint device where a user has read and write access, including at least one of an application data directory or a user-specific registry hive. The computing system collects telemetry data, which includes file read operations, file write operations, file executions, and registry modifications at the monitored file system locations and registry keys. An artificial intelligence model establishes a baseline of normal user activity for the telemetry data specific to the endpoint device, incorporating patterns of file access frequency and registry change frequency.

The method continues with the artificial intelligence model detecting an anomaly by identifying a new or unknown file, such as an executable, dynamic link library, or script, in the monitored file system locations that deviates from the baseline. The computing system correlates the anomaly with network connection data to identify a connection to a previously unseen domain. The computing system integrates threat intelligence data from an external source to validate the anomaly by cross-referencing the telemetry data with known malicious file hashes. A report is generated by the computing system, including the anomaly, a risk score, and a visualization of the anomaly, which is stored in a reporting module. The computing system logs the telemetry data and the report in a cryptographically signed audit log to ensure non-repudiation.

In some arrangements, the method described above is modified to include an additional specification for the artificial intelligence model. The artificial intelligence model includes a clustering model that groups similar activities in the telemetry data based on file types and registry operations, enhancing the precision of the baseline and anomaly detection processes.

In some arrangements, the method is further refined by incorporating additional steps for training and refining the artificial intelligence model. The computing system trains the artificial intelligence model using historical telemetry data collected over a 30-day period. The computing system refines the baseline by incorporating outputs from the clustering model, improving the system's ability to detect deviations from normal user activity patterns.

In some arrangements, the method includes a specific approach to correlating anomalies with network connection data. The computing system analyzes network traffic patterns, including connection frequency and destination IP addresses, to identify the connection to the previously unseen domain, enabling the detection of potential external communications associated with the anomaly.

In some arrangements, the method enhances the integration of threat intelligence data. The computing system automatically updates the artificial intelligence model with new malicious file hash data retrieved from the external source, ensuring that the model remains current with emerging threat information.

In some arrangements, the method incorporates additional steps for risk assessment and report prioritization. The computing system calculates the risk score for the anomaly based on the file type of the new or unknown file and the reputation of the previously unseen domain. The computing system prioritizes the report in the reporting module based on the risk score, allowing security teams to focus on high-priority threats.

In some arrangements, the method refines the report generation process. The computing system creates a timeline visualization showing timestamps of the file executions and registry modifications associated with the anomaly, enhancing the reporting module's ability to convey temporal relationships to security teams.

In some arrangements, the method includes specific remediation actions. The computing system executes an automated remediation action when the risk score exceeds a predefined threshold, with the automated remediation action including quarantining the new or unknown file. When the risk score is below the predefined threshold, the computing system recommends a manual remediation action via the reporting module, such as initiating forensic analysis.

In some arrangements, the method enhances the logging process for non-repudiation. The computing system stores a cryptographic hash of the new or unknown file and network connection details in the audit log, ensuring that the logged data is verifiable and tamper-resistant.

In some arrangements, the method incorporates feedback and retraining mechanisms. The computing system retrieves feedback from a security team via the reporting module regarding the report. The computing system retrains the artificial intelligence model using the feedback and recent telemetry data to update the baseline, ensuring continuous improvement in detection accuracy.

In some arrangements, a comprehensive method for monitoring endpoint activity in a computing environment encompasses a wide range of steps executed by a computing system. The computing system monitors file system locations and registry keys on an endpoint device where a user has read and write access, including at least one of an application data directory or a user-specific registry hive. The computing system collects telemetry data, which includes file read operations, file write operations, file executions, and registry modifications at the monitored file system locations and registry keys, with metadata comprising file names, file paths, timestamps, user permissions, and process identifiers.

An artificial intelligence model establishes a baseline of normal user activity for the telemetry data specific to the endpoint device, incorporating patterns of file access frequency and registry change frequency, using a clustering model to group similar activities based on file types and registry operations. The computing system trains the artificial intelligence model using historical telemetry data collected over a 30-day period and refines the baseline by incorporating outputs from the clustering model. The artificial intelligence model detects an anomaly by identifying a new or unknown file, such as an executable, dynamic link library, or script, in the monitored file system locations that deviates from the baseline.

The computing system correlates the anomaly with network connection data to identify a connection to a previously unseen domain by analyzing network traffic patterns, including connection frequency and destination IP addresses. The computing system integrates threat intelligence data from an external source to validate the anomaly by cross-referencing the telemetry data with known malicious file hashes, automatically updating the artificial intelligence model with new malicious file hash data. The computing system calculates a risk score for the anomaly based on the file type of the new or unknown file and the reputation of the previously unseen domain.

A report is generated by the computing system, including the anomaly, the risk score, and a timeline visualization showing timestamps of the file executions and registry modifications associated with the anomaly, which is stored in a reporting module. The computing system prioritizes the report in the reporting module based on the risk score. When the risk score exceeds a predefined threshold, the computing system executes an automated remediation action, such as quarantining the new or unknown file or blocking the connection to the previously unseen domain. When the risk score is below the predefined threshold, the computing system recommends a manual remediation action via the reporting module, such as initiating forensic analysis.

The computing system logs the telemetry data and the report in a cryptographically signed audit log, including a cryptographic hash of the new or unknown file and network connection details, to ensure non-repudiation. The computing system retrieves feedback from a security team via the reporting module regarding the report and retrains the artificial intelligence model using the feedback and recent telemetry data to update the baseline. The computing system aggregates the telemetry data from a plurality of endpoint devices to identify patterns of anomalies across a network, completing the comprehensive method for endpoint activity monitoring.

In some arrangements, a system for monitoring endpoint activity in a computing environment comprises multiple modules working in concert. A monitoring module is configured to monitor file system locations and registry keys on an endpoint device where a user has read and write access, including at least one of an application data directory or a user-specific registry hive. A telemetry collection module is configured to collect telemetry data, which includes file read operations, file write operations, file executions, and registry modifications at the monitored file system locations and registry keys.

An artificial intelligence module is configured to establish a baseline of normal user activity for the telemetry data specific to the endpoint device, incorporating patterns of file access frequency and registry change frequency. An anomaly detection module is configured to detect an anomaly by identifying a new or unknown file, such as an executable, dynamic link library, or script, in the monitored file system locations that deviates from the baseline. A correlation module is configured to correlate the anomaly with network connection data to identify a connection to a previously unseen domain.

A threat intelligence integration module is configured to integrate threat intelligence data from an external source to validate the anomaly by cross-referencing the telemetry data with known malicious file hashes. A reporting module is configured to generate a report, including the anomaly, a risk score, and a visualization of the anomaly. A logging module is configured to log the telemetry data and the report in a cryptographically signed audit log to ensure non-repudiation.

In some arrangements, the system described above includes an additional specification for the artificial intelligence module. The artificial intelligence module includes a clustering model configured to group similar activities in the telemetry data based on file types and registry operations, enhancing the precision of the baseline and anomaly detection processes.

In some arrangements, the system is further refined by incorporating additional modules for training and refining the artificial intelligence module. A training module is configured to train the artificial intelligence module using historical telemetry data collected over a 30-day period. A baseline refinement module is configured to refine the baseline by incorporating outputs from the clustering model, improving the system's ability to detect deviations from normal user activity patterns.

In some arrangements, the system specifies the correlation module's approach. The correlation module is configured to analyze network traffic patterns, including connection frequency and destination IP addresses, to identify the connection to the previously unseen domain, enabling the detection of potential external communications associated with the anomaly.

In some arrangements, the system enhances the threat intelligence integration module. The threat intelligence integration module is configured to automatically update the artificial intelligence module with new malicious file hash data retrieved from the external source, ensuring that the module remains current with emerging threat information.

In some arrangements, the system incorporates additional modules for risk assessment and report prioritization. A risk assessment module is configured to calculate the risk score for the anomaly based on the file type of the new or unknown file and the reputation of the previously unseen domain. A prioritization module is configured to prioritize the report in the reporting module based on the risk score, allowing security teams to focus on high-priority threats.

In some arrangements, the system refines the reporting module. The reporting module is configured to create a timeline visualization showing timestamps of the file executions and registry modifications associated with the anomaly, enhancing the module's ability to convey temporal relationships to security teams.

In some arrangements, the system includes specific remediation modules. A remediation module is configured to execute an automated remediation action when the risk score exceeds a predefined threshold, with the automated remediation action including quarantining the new or unknown file. A recommendation module is configured to recommend a manual remediation action via the reporting module when the risk score is below the predefined threshold, such as initiating forensic analysis.

In some arrangements, the system enhances the logging process and incorporates additional modules for comprehensive functionality. An audit module is configured to store a cryptographic hash of the new or unknown file and network connection details in the audit log, with the network connection details including source IP address, destination IP address, port numbers, and protocol type, ensuring verifiable and tamper-resistant logs. A feedback module is configured to retrieve feedback from a security team via the reporting module regarding the report, with the feedback including validation of the anomaly as malicious or benign.

A retraining module is configured to retrain the artificial intelligence module using the feedback and recent telemetry data collected within a 24-hour period to update the baseline. An aggregation module is configured to aggregate the telemetry data from a plurality of endpoint devices to identify patterns of anomalies across a network, with the aggregation performed within a one-hour time window to detect coordinated threats. A visualization module is configured to generate a graph visualization of registry modifications and file executions associated with the anomaly, with nodes representing files and registry keys and edges representing interactions, displayed in the reporting module to facilitate security team analysis. An optimization module is configured to optimize the telemetry collection module to minimize performance impact on the endpoint device by selectively sampling telemetry data based on file type priority and system resource availability.

In some arrangements, a method for correlating user events in a computing environment involves several steps executed by a computing system. The computing system accesses backend databases or data stores to collect user event data, including file access events and associated metadata. An artificial intelligence model analyzes the user event data to establish a normalized baseline of user activity across the computing environment, incorporating patterns of file access frequency and access times. The artificial intelligence model identifies a conditional event that deviates from the normalized baseline, where the conditional event includes a user accessing a file from an unusual geographic location.

The computing system generates a dynamic canary event based on the conditional event to track subsequent user actions. The computing system correlates the conditional event with metadata from at least one external repository, including IP reputation data or user group membership, to confirm the deviation. The computing system integrates threat intelligence data from an external source to validate the conditional event. An alert is generated by the computing system, including the conditional event, a risk score, and a visualization, which is displayed on a centralized console. The computing system logs the user event data and the alert in a cryptographically signed audit log to ensure non-repudiation.

In some arrangements, the method described above is modified to include an additional specification for the artificial intelligence model. The artificial intelligence model includes a clustering model that groups similar user activities based on file types and access patterns, enhancing the precision of the baseline and conditional event detection processes.

In some arrangements, the method is further refined by incorporating additional steps for training and refining the artificial intelligence model. The computing system trains the artificial intelligence model using historical user event data collected over a 30-day period. The computing system refines the normalized baseline by incorporating outputs from the clustering model, improving the system's ability to detect deviations from normal user activity patterns.

In some arrangements, the method includes a specific approach to generating the dynamic canary event. The computing system tracks subsequent user actions, including file downloads or data transfers, within a one-hour time window, enabling the system to confirm the conditional event through follow-up behavior.

In some arrangements, the method enhances the correlation of the conditional event. The computing system cross-references the unusual geographic location with geolocation data from the at least one external repository, providing additional context to confirm the deviation from the normalized baseline.

In some arrangements, the method incorporates additional steps for risk assessment and alert prioritization. The computing system calculates the risk score for the conditional event based on the sensitivity of the file accessed and the reputation of an IP address associated with the conditional event. The computing system prioritizes the alert on the centralized console based on the risk score, allowing security teams to focus on high-priority threats.

In some arrangements, the method refines the alert generation process. The computing system creates a timeline visualization showing timestamps of the file access events and subsequent user actions, enhancing the centralized console's ability to convey temporal relationships to security teams.

In some arrangements, the method includes specific remediation actions. The computing system executes an automated remediation action when the risk score exceeds a predefined threshold, with the automated remediation action including restricting user access. When the risk score is below the predefined threshold, the computing system recommends a manual remediation action via the centralized console, such as isolating a device associated with the user.

In some arrangements, the method enhances the logging process for non-repudiation. The computing system stores a cryptographic hash of the file accessed and network details in the audit log, ensuring that the logged data is verifiable and tamper-resistant.

In some arrangements, the method incorporates feedback and retraining mechanisms. The computing system retrieves feedback from a security team via the centralized console regarding the alert. The computing system retrains the artificial intelligence model using the feedback and recent user event data to update the normalized baseline, ensuring continuous improvement in detection accuracy.

In some arrangements, a comprehensive method for correlating user events in a computing environment encompasses a wide range of steps executed by a computing system. The computing system accesses backend databases or data stores to collect user event data, including file access events and associated metadata, with the associated metadata including user identity, file type, access time, IP address, and device type. An artificial intelligence model analyzes the user event data to establish a normalized baseline of user activity across the computing environment, incorporating patterns of file access frequency and access times, using a clustering model to group similar user activities based on file types and access patterns.

The computing system trains the artificial intelligence model using historical user event data collected over a 30-day period and refines the normalized baseline by incorporating outputs from the clustering model. The artificial intelligence model identifies a conditional event that deviates from the normalized baseline, where the conditional event includes a user accessing a file from an unusual geographic location. The computing system generates a dynamic canary event based on the conditional event to track subsequent user actions, including file downloads or data transfers, within a one-hour time window.

The computing system correlates the conditional event with metadata from at least one external repository, including IP reputation data or user group membership, to confirm the deviation by cross-referencing the unusual geographic location with geolocation data. The computing system integrates threat intelligence data from an external source to validate the conditional event by cross-referencing the user event data with known high-risk IP addresses. The computing system calculates a risk score for the conditional event based on the sensitivity of the file accessed and the reputation of an IP address associated with the conditional event.

An alert is generated by the computing system, including the conditional event, the risk score, and a timeline visualization showing timestamps of the file access events and subsequent user actions, which is displayed on a centralized console. The computing system prioritizes the alert on the centralized console based on the risk score. When the risk score exceeds a predefined threshold, the computing system executes an automated remediation action, such as restricting user access or revoking a session token. When the risk score is below the predefined threshold, the computing system recommends a manual remediation action via the centralized console, such as isolating a device associated with the user.

The computing system logs the user event data and the alert in a cryptographically signed audit log, including a cryptographic hash of the file accessed and network details, to ensure non-repudiation. The computing system retrieves feedback from a security team via the centralized console regarding the alert and retrains the artificial intelligence model using the feedback and recent user event data to update the normalized baseline. The computing system processes the user event data using a cloud-based distributed computing framework to ensure scalability across thousands of users, completing the comprehensive method for correlating user events.

In some arrangements, a system for correlating user events in a computing environment comprises multiple modules working in concert. An access module is configured to access backend databases or data stores to collect user event data, including file access events and associated metadata. An analysis module, using an artificial intelligence model, is configured to analyze the user event data to establish a normalized baseline of user activity across the computing environment, incorporating patterns of file access frequency and access times. An identification module, using the artificial intelligence model, is configured to identify a conditional event that deviates from the normalized baseline, where the conditional event includes a user accessing a file from an unusual geographic location.

A canary event module is configured to generate a dynamic canary event based on the conditional event to track subsequent user actions. A correlation module is configured to correlate the conditional event with metadata from at least one external repository, including IP reputation data or user group membership, to confirm the deviation. A threat intelligence module is configured to integrate threat intelligence data from an external source to validate the conditional event. An alert module is configured to generate an alert, including the conditional event, a risk score, and a visualization, for display on a centralized console. A logging module is configured to log the user event data and the alert in a cryptographically signed audit log to ensure non-repudiation.

In some arrangements, the system described above includes an additional specification for the artificial intelligence model of the analysis module. The artificial intelligence model includes a clustering model configured to group similar user activities based on file types and access patterns, enhancing the precision of the baseline and conditional event detection processes.

In some arrangements, the system is further refined by incorporating additional modules for training and refining the artificial intelligence model. A training module is configured to train the artificial intelligence model using historical user event data collected over a 30-day period. A baseline refinement module is configured to refine the normalized baseline by incorporating outputs from the clustering model, improving the system's ability to detect deviations from normal user activity patterns.

In some arrangements, the system specifies the canary event module's approach. The canary event module is configured to track subsequent user actions, including file downloads or data transfers, within a one-hour time window, enabling the system to confirm the conditional event through follow-up behavior.

In some arrangements, the system enhances the correlation module. The correlation module is configured to cross-reference the unusual geographic location with geolocation data from the at least one external repository, providing additional context to confirm the deviation from the normalized baseline.

In some arrangements, the system incorporates additional modules for risk assessment and alert prioritization. A risk assessment module is configured to calculate the risk score for the conditional event based on the sensitivity of the file accessed and the reputation of an IP address associated with the conditional event. A prioritization module is configured to prioritize the alert on the centralized console based on the risk score, allowing security teams to focus on high-priority threats.

In some arrangements, the system refines the alert module. The alert module is configured to create a timeline visualization showing timestamps of the file access events and subsequent user actions, enhancing the centralized console's ability to convey temporal relationships to security teams.

In some arrangements, the system includes specific remediation modules. A remediation module is configured to execute an automated remediation action when the risk score exceeds a predefined threshold, with the automated remediation action including restricting user access. A recommendation module is configured to recommend a manual remediation action via the centralized console when the risk score is below the predefined threshold, such as isolating a device associated with the user.

In some arrangements, the system enhances the logging process and incorporates additional modules for comprehensive functionality. An audit module is configured to store a cryptographic hash of the file accessed and network details in the audit log, with the network details including source IP address, destination IP address, port numbers, and protocol type, ensuring verifiable and tamper-resistant logs. A feedback module is configured to retrieve feedback from a security team via the centralized console regarding the alert, with the feedback including validation of the conditional event as malicious or benign.

A retraining module is configured to retrain the artificial intelligence model using the feedback and recent user event data collected within a 24-hour period to update the normalized baseline. A scalability module is configured to process the user event data using a cloud-based distributed computing framework to ensure scalability across thousands of users, utilizing containerized environments to dynamically allocate resources based on event volume. A visualization module is configured to generate a geolocation map visualization of the conditional event, with markers for the unusual geographic location and associated IP addresses, displayed on the centralized console to facilitate security team analysis. An optimization module is configured to optimize the access module to minimize performance impact on the backend databases or data stores by selectively sampling user event data based on event type priority and database resource availability.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on non-transitory computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” “the,” and “invention” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates a unified cybersecurity framework integrating endpoint monitoring, user event tracking, and network correlation. The diagram depicts interconnected components enabling real-time threat detection and response across all three aspects of the inventions.

FIG. 2 is an exemplary flow diagram in accordance with one or more embodiments disclosed herein that illustrates the process of detecting and responding to anomalous network activity for the AI/ML System and Processes for Connection Correlation Engine. The diagram details a sequence of steps integrating endpoint monitoring, artificial intelligence analysis, network correlation, and remediation to ensure robust cybersecurity.

FIG. 3 is an exemplary flow diagram in accordance with one or more embodiments disclosed herein that illustrates the detailed process of monitoring endpoint activity for the Endpoint Telemetry aspect of the invention. The diagram outlines a sequence of steps integrating granular endpoint monitoring, artificial intelligence analysis, network correlation, and remediation to ensure precise detection and response to potential malicious activities.

FIG. 4 is an exemplary flow diagram in accordance with one or more embodiments disclosed herein that illustrates the detailed process of correlating user events for the AI/ML Driven User Event Telemetry and Correlation System and Processes aspect of the invention. The diagram outlines a sequence of steps integrating user event tracking, artificial intelligence analysis, dynamic canary event generation, metadata correlation, and remediation to ensure robust security and traceability in a computing environment.

FIGS. 5A-D are collectively an exemplary sequence diagram in accordance with one or more embodiments disclosed herein that illustrates the integrated process of data collection, analysis, anomaly detection, and response for the AI/ML System and Processes for Connection Correlation Engine, Endpoint Telemetry, and AI/ML Driven User Event Telemetry and Correlation System and Processes. The diagrams detail the interactions among system components to ensure real-time threat detection, correlation, and remediation across all three aspects of the inventions.

FIGS. 6A-B are collectively an exemplary class diagram in accordance with one or more embodiments disclosed herein that illustrates the comprehensive structure and relationships of classes supporting the AI/ML System and Processes for Connection Correlation Engine, Endpoint Telemetry, and AI/ML Driven User Event Telemetry and Correlation System and Processes. The diagrams detail the attributes, methods, and interconnections of classes responsible for data collection, storage, analysis, correlation, visualization, and response across all three aspects of the inventions.

### DETAILED DESCRIPTION

The inventions disclosed herein encompass three aspects of various sophisticated systems and processes designed to enhance cybersecurity through advanced artificial intelligence and machine learning, each addressing distinct yet complementary facets of threat detection and response in corporate IT environments. The first aspect, focused on correlating endpoint events, processes, and network connections, monitors file system locations and registry keys where users have read and write access, such as application data directories, temporary folders, and user-specific registry hives like HKEY_CURRENT_USER. These locations are chosen for their accessibility to non-administrative users, making them prime targets for malicious activities like malware deployment or persistence mechanisms. The system collects telemetry data, capturing file read and write operations, executions of executables, dynamic link libraries, scripts, and batch files, as well as network connections initiated from these monitored areas, with metadata including file names, paths, sizes, timestamps, user permissions, process identifiers, and network details like IP addresses and ports.

This telemetry forms the foundation for analysis, enabling the system to establish a baseline of normal activity tailored to each endpoint's user or system context. The baseline encapsulates patterns such as file access frequency, types of executed files, and domains typically contacted during network communications, using a combination of supervised learning models trained on historical data and unsupervised clustering algorithms to group similar activities. By processing incoming telemetry in real time, the system identifies deviations, such as a file execution in a monitored directory initiating a connection to an unfamiliar or suspicious domain, flagging these as potential anomalies. The artificial intelligence models compute anomaly scores based on features like file type, execution context, and domain novelty, ensuring high sensitivity to novel threats.

The system's ability to correlate anomalies across multiple endpoints is a cornerstone of its functionality, extending analysis to subnets and entire network infrastructures. It aggregates telemetry data within a configurable time window, such as one hour, to detect coordinated patterns, such as multiple devices connecting to the same suspicious domain, which may indicate a distributed attack like a botnet or advanced persistent threat. This network-level correlation leverages graph-based models to map endpoint-domain relationships, identifying subtle patterns that might evade individual endpoint analysis. The system integrates external threat intelligence data from sources like VirusTotal or Cisco Talos, cross-referencing telemetry against known malicious domains, IP addresses, or file hashes to validate anomalies, dynamically updating models to incorporate new intelligence without manual intervention.

A centralized web console serves as the primary interface for security teams, presenting detailed alerts that include the anomaly's nature, risk score, affected endpoint, and visualizations like directed graphs of endpoint-to-domain connections or timelines of file and network activities. Alerts are prioritized based on risk scores, calculated using weighted factors such as file type, domain reputation, and pattern frequency, ensuring high-priority threats are addressed promptly. The console, built with interactive frameworks like Vue.js, supports real-time updates via WebSocket connections, allowing analysts to drill down into event details or filter by criteria like user group or endpoint type. The system suggests remediation actions, such as isolating endpoints or blocking domains, and executes automated actions for high-risk alerts, like quarantining a device using firewall rules deployed via Ansible, while recommending manual actions like forensic analysis for lower-risk cases.

Scalability is a critical feature, with the system leveraging cloud-based distributed computing architectures like AWS Elastic Kubernetes Service (EKS) to process telemetry from hundreds of thousands of endpoints in real time. The use of serverless frameworks, such as AWS Lambda, ensures dynamic resource allocation, handling peak loads without performance degradation. The system employs Apache Cassandra for telemetry storage, with partitioning by endpoint ID and time to manage petabytes of data, and AES-256 encryption to comply with standards like GDPR and HIPAA. Continuous learning is integral, with models retraining daily using feedback from security teams and recent telemetry, implemented via Horovod on NVIDIA GPU clusters to adapt baselines to evolving user behaviors or system configurations.

Non-repudiation is ensured through cryptographically signed audit logs, stored in a tamper-proof ledger like Hyperledger Fabric, capturing file hashes, network details, and alert metadata with ECDSA-384 signatures. This lightweight approach avoids the computational overhead of complex architectures, making it practical for real-time use in large organizations. The system's adaptability to diverse environments is facilitated by customizable alert thresholds, allowing organizations to tailor sensitivity based on risk tolerance, such as stricter thresholds for financial institutions or relaxed settings for less sensitive environments. Integration with enterprise SIEM platforms like Splunk enhances interoperability, enabling seamless incorporation into existing security workflows.

The second system, focused on granular endpoint telemetry, targets file system locations and registry keys accessible to non-administrative users, such as application data directories or temporary folders, to detect potential malicious behavior early. It collects telemetry on file creations, modifications, deletions, executions, and registry changes, capturing metadata like file paths, sizes, timestamps, user accounts, and process identifiers. A lightweight agent, developed in Rust for minimal resource impact, uses Windows File System Minifilters and eBPF on Linux to capture events with sub-10 ms latency, ensuring compatibility across Windows, Linux, and macOS endpoints. The system establishes a user-specific baseline of normal activity, reflecting patterns like frequent text file modifications or rare registry key changes, using K-means clustering and Isolation Forest models in scikit-learn.

Anomalies, such as the sudden appearance of an unknown executable or an unexpected registry modification, are detected by comparing real-time telemetry against the baseline, with anomaly scores computed based on file type, execution context, and temporal deviations. The system correlates anomalies with network connections, identifying potential command-and-control communications if an unknown file connects to an unfamiliar domain, using Zeek for protocol analysis and Neo4j for graphing relationships. Threat intelligence integration validates anomalies against malicious file hashes or domains, leveraging APIs from Hybrid Analysis or FireEye, cached in Memcached for sub-20 ms queries. Detailed reports, generated with Plotly visualizations like timelines of file events, are stored in a MongoDB reporting module, supporting compliance with standards like SOC 2.

The system's scalability is achieved through distributed processing with Apache Spark, aggregating telemetry from 100,000 endpoints in under 100 ms, with data stored in InfluxDB for time-series efficiency. Automated remediation, such as quarantining files via PowerShell scripts, is triggered for high-risk anomalies, while manual actions like log analysis are recommended for lower risks. Audit logs, signed with RSA-4096 keys, ensure non-repudiation, with retention policies managed by Apache NiFi. Continuous model updates, using feedback and 24-hour telemetry, maintain accuracy in dynamic environments like tech startups or universities.

The third system, focused on user event telemetry and correlation, tracks user interactions with backend databases or data stores, capturing file accesses, application interactions, and queries with metadata like user identity, file type, access time, IP address, and device type. It establishes a normalized baseline of user activity, reflecting patterns like file access frequency for specific departments, using Gaussian Mixture Models and One-Class SVMs. Conditional events, such as a user accessing a sensitive file from an unusual geographic location, are identified with high precision, leveraging LSTM networks for temporal analysis.

Dynamic canary events track subsequent actions, like file downloads after an unusual access, using Apache Samza for stream processing within a one-hour window. Metadata correlation with repositories like IPinfo or Okta confirms deviations, while threat intelligence from AlienVault validates events. Alerts, visualized with Leaflet geolocation maps, are prioritized on a Vue.js console. Automated remediation, like revoking tokens via Okta APIs, and manual recommendations, like device isolation, are supported, with logs in Hyperledger Fabric. Scalability is ensured via Google Cloud Spanner, with feedback-driven model updates on NVIDIA H100 GPUs.

The connections between classes reflect a modular architecture, with the Central Processing System (600) associating with the Endpoint Monitoring Agent (602), Database Access Module (604), and Telemetry Database (606) via gRPC and REST APIs. The Endpoint Monitoring Agent (602) and Database Access Module (604) feed telemetry to the Telemetry Database (606) via Kafka, which associates with the AI Engine (608) for analysis. The AI Engine (608) connects to the Network Correlation Module (612), Canary Event Generator (614), Metadata Correlation Module (616), and Web Console (618) via RabbitMQ, while the Threat Intelligence Interface (610) provides data via REST. The Web Console (618) links to the Audit Log Storage (620) and Feedback Processor (622), with the latter updating the AI Engine (608), ensuring seamless data flow.

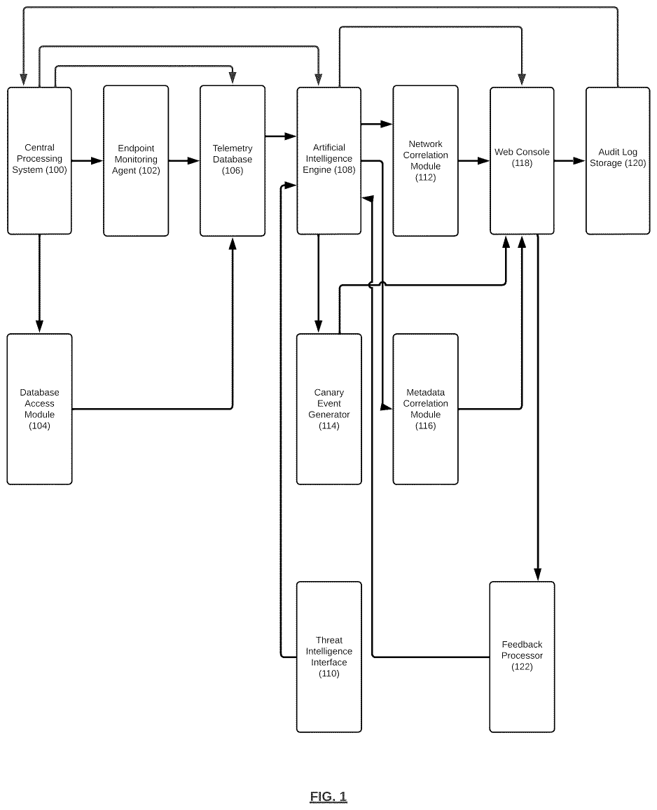

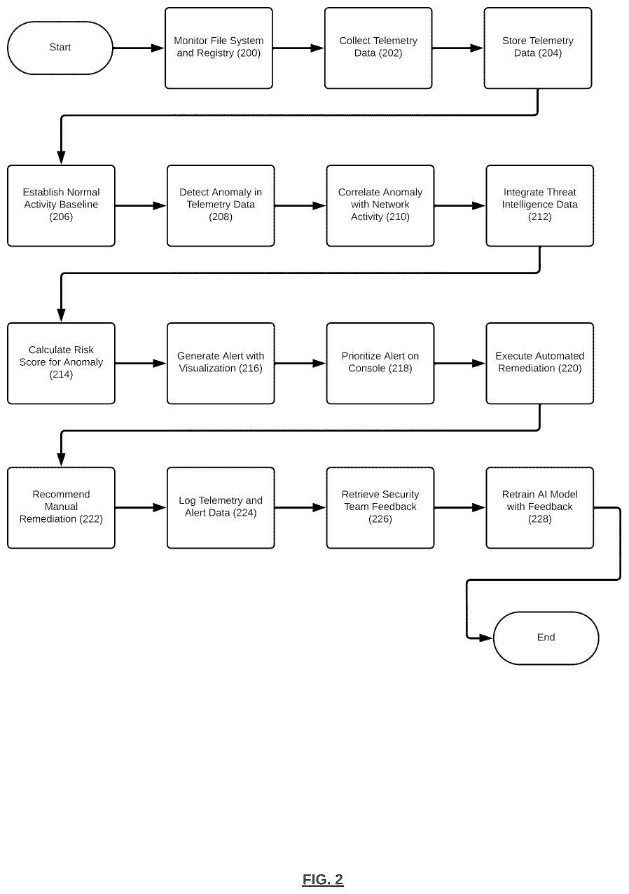

Various example embodiments in the disclosure are designed to fulfill the objectives of robust threat detection, precise correlation, and proactive response outlined in the overview, leveraging the illustrations provided in FIGS. 1 through 6 to showcase systems and methods for implementing the Connection Correlation Engine, Endpoint Telemetry, and User Event Telemetry aspects. These embodiments allow for diverse implementation approaches, such as deploying on-premises or cloud-native architectures, adjusting component structures to optimize for specific workloads, and interpreting connections among components as direct or indirect, wired or wireless, unless explicitly specified otherwise, providing flexibility to adapt to varying organizational needs while maintaining the core functionalities of real-time monitoring, analysis, and remediation.

Supervised learning is a type of artificial intelligence where models are trained on labeled datasets to predict outcomes, playing a pivotal role in all three aspects of the inventions by establishing baselines and detecting anomalies with high accuracy. For the Connection Correlation Engine, supervised models like Random Forest or XGBoost, implemented in TensorFlow, are trained on historical telemetry labeled as normal to predict anomalous network connections, such as a .exe file contacting an unseen domain. In the Endpoint Telemetry aspect, these models classify file executions as benign or malicious based on labeled datasets, using tools like scikit-learn to analyze features like file type and execution time. For User Event Telemetry, supervised learning predicts unusual user accesses, such as a file access from a high-risk IP, using labeled event data in PyTorch. Techniques like gradient boosting and cross-validation ensure robust performance, with retraining on feedback enhancing adaptability.

Unsupervised learning involves models identifying patterns in unlabeled data, critical for clustering and anomaly detection across the inventions. In the Connection Correlation Engine, K-means clustering in scikit-learn groups similar network connection patterns, detecting coordinated anomalies like multiple endpoints accessing a suspicious domain, while DBSCAN identifies outliers. For Endpoint Telemetry, unsupervised models like Isolation Forest detect unknown executables by clustering file operations, using Spark MLlib for distributed processing. In User Event Telemetry, Gaussian Mixture Models cluster user access patterns, flagging deviations like off-hours accesses, with tools like PyTorch enabling scalable training. Dimensionality reduction techniques, such as PCA, optimize feature sets for efficiency.

Reinforcement learning, where agents learn optimal actions through rewards, is applicable to dynamic decision-making in remediation and model tuning. For the Connection Correlation Engine, it optimizes remediation actions, like quarantining endpoints, using Q-learning in TensorFlow to maximize threat mitigation while minimizing disruption. In Endpoint Telemetry, it adjusts anomaly detection thresholds based on feedback, implemented with OpenAI Gym for simulation. For User Event Telemetry, reinforcement learning refines canary event triggers, using Deep Q-Networks (DQNs) in PyTorch to balance sensitivity and false positives, with rewards based on analyst validations, enhancing adaptability in dynamic environments.

Deep learning, utilizing neural networks with multiple layers, excels in capturing complex patterns, supporting advanced anomaly detection across the inventions. For the Connection Correlation Engine, Convolutional Neural Networks (CNNs) in TensorFlow analyze network traffic patterns, detecting subtle anomalies like low-frequency malicious connections. In Endpoint Telemetry, Recurrent Neural Networks (RNNs) with LSTM units in PyTorch model temporal file access sequences, identifying anomalies like unusual registry changes. For User Event Telemetry, Transformer models process user event sequences, detecting high-risk accesses with attention mechanisms, trained on NVIDIA A100 GPUs via Horovod for scalability, ensuring high accuracy in large-scale deployments.

In FIG. 1, the system architecture is designed to encapsulate various aspects of the inventions: the AI/ML System and Processes for Connection Correlation Engine, Endpoint Telemetry, and AI/ML Driven User Event Telemetry and Correlation System and Processes, providing a robust framework for cybersecurity in complex corporate IT environments. The Central Processing System (100) acts as the orchestrating hub, managing the seamless flow of data and processing tasks across all components to ensure synchronized operation. For the first aspect, the Central Processing System (100) could oversee telemetry collection from thousands of Windows workstations and servers, coordinating the detection of anomalous network connections to previously unseen domains. In the second aspect, it might manage granular file system and registry event monitoring on employee laptops and desktops, ensuring precise endpoint telemetry capture. For the third aspect, it could handle user event data extraction from enterprise-grade relational databases, facilitating detailed tracking of user interactions. This component leverages advanced cloud-based serverless architectures, such as AWS Lambda or Azure Functions, to dynamically allocate computational resources based on telemetry volume, ensuring scalability across large-scale deployments with thousands of endpoints and users. It also employs container orchestration platforms like Kubernetes to manage distributed processing tasks, maintaining low-latency performance even under high data loads.

The Endpoint Monitoring Agent (102) is a critical component responsible for collecting telemetry data directly from endpoint devices, ensuring comprehensive coverage of system activities. In the first aspect, it monitors specific file system locations, such as C:\Users\AppData\Local or C:\Temp, and registry hives like HKEY_CURRENT_USER on Windows-based desktop computers, capturing detailed metadata on file executions (e.g., .exe, .dll files), read/write operations, and network connections initiated via TCP/UDP protocols. For the second aspect, it tracks file creations, modifications, deletions, and registry key changes on employee laptops, using lightweight monitoring tools like CrowdStrike Falcon or Carbon Black, which minimize CPU and memory usage to avoid performance degradation. In the third aspect, it could collect metadata from user interactions on mobile devices or thin clients accessing corporate file shares, such as file access timestamps and user IDs, ensuring endpoint data contributes to user event analysis. The Endpoint Monitoring Agent (102) employs secure data transmission protocols like TLS 1.3 to forward telemetry to the Telemetry Database (106), using compression algorithms like gzip to optimize bandwidth usage, particularly in distributed environments with limited network capacity.

The Database Access Module (104) interfaces with backend databases or data stores to extract user event data, serving as a bridge between enterprise data repositories and the cybersecurity framework. For the first aspect, it might retrieve network connection logs from a Microsoft SQL Server database, capturing details like source/destination IPs and ports to support correlation with endpoint events. In the second aspect, it could access a NoSQL database like MongoDB, hosted on a private cloud, to gather file operation logs (e.g., create, modify, delete) from distributed endpoints across multiple geographic regions. For the third aspect, it collects file access events and associated metadata, such as user identities, file types, access times, IP addresses, and device types, from an Oracle Database 19c instance managing enterprise data. This module utilizes standardized APIs, such as JDBC for relational databases or MongoDB's native drivers for NoSQL systems, to ensure efficient data extraction. It implements caching mechanisms using Redis to reduce database load during high-frequency queries and forwards extracted data to the Telemetry Database (106) via secure RESTful endpoints.

The Telemetry Database (106) functions as a centralized, high-performance repository for storing all telemetry data collected from endpoints and data stores, enabling rapid access for analysis. In the first aspect, it archives file execution records, network connection details (e.g., DNS queries, packet metadata), and registry changes, stored in a distributed database like Apache Cassandra, which supports horizontal scaling across multiple nodes to handle petabytes of data. For the second aspect, it stores file operation metadata (e.g., file paths, sizes, timestamps) and registry modification logs, leveraging a time-series database like InfluxDB optimized for high-frequency, time-stamped endpoint data. In the third aspect, it maintains user event data, including file access timestamps, geolocation metadata, and user group memberships, in a relational database like PostgreSQL with advanced indexing for fast query performance. The Telemetry Database (106) employs data partitioning strategies to segregate endpoint and user event data, ensuring efficient retrieval by the Artificial Intelligence Engine (108). It also implements encryption at rest using AES-256 to secure sensitive telemetry, complying with data protection standards like GDPR.

The Artificial Intelligence Engine (108) is the analytical core, processing telemetry data to establish activity baselines and detect anomalies across all three aspects. For the first aspect, it uses a combination of supervised learning models, such as Random Forest implemented in TensorFlow, and unsupervised models, like DBSCAN for clustering, to create baselines of normal network activity (e.g., typical domains contacted) and identify anomalies, such as connections to malicious domains. In the second aspect, it employs K-means clustering via scikit-learn to group endpoint activities (e.g., file types, registry operations) and anomaly detection algorithms to flag unknown executables or unexpected registry changes. For the third aspect, it leverages neural network-based anomaly detection in PyTorch to identify unusual file accesses, such as those from high-risk geographic locations, by comparing against user group baselines. The Artificial Intelligence Engine (108) supports distributed model training using frameworks like Horovod, enabling parallel processing across GPU clusters for real-time analysis. It connects to the Network Correlation Module (112), Canary Event Generator (114), Metadata Correlation Module (116), and Web Console (118), driving the analytical workflow and integrating feedback from the Feedback Processor (122).

The Threat Intelligence Interface (110) integrates external threat intelligence data to enhance anomaly validation, ensuring robust detection across all aspects. In the first aspect, it retrieves malicious domain lists and IP reputation scores from services like VirusTotal or Cisco Talos, cross-referencing endpoint connection data to confirm suspicious network activities. For the second aspect, it accesses file hash databases from platforms like ThreatGrid or Hybrid Analysis, validating unknown files detected on endpoints by comparing their hashes against known malware signatures. In the third aspect, it pulls high-risk IP address data and compromised credential lists from AlienVault or Recorded Future, confirming suspicious user access events from unusual locations. The Threat Intelligence Interface (110) uses secure REST APIs with OAuth 2.0 authentication to fetch real-time intelligence, caching responses in an in-memory store like Memcached to reduce latency. It feeds validated data back to the Artificial Intelligence Engine (108), enabling dynamic model updates without manual intervention.

The Network Correlation Module (112) analyzes network activity to identify coordinated patterns across endpoints, a critical function for the first aspect and supportive for the others. In the first aspect, it aggregates telemetry within a one-hour window to detect multiple devices connecting to the same suspicious domain, using Apache Spark for distributed processing across a Hadoop cluster to handle large-scale network data. For the second aspect, it correlates endpoint file executions with network connections, identifying potential command-and-control communications by analyzing traffic patterns with tools like Zeek, which parses protocols like HTTP and DNS. In the third aspect, it might analyze user access patterns across network segments to detect coordinated unauthorized accesses, using graph databases like Neo4j to model relationships between users and accessed resources. The Network Correlation Module (112) employs machine learning models, such as graph convolutional networks, to detect subtle patterns and sends results to the Web Console (118) for visualization, leveraging message queues like RabbitMQ for efficient data transfer.

The Canary Event Generator (114) creates dynamic canary events to track follow-up actions, primarily for the third aspect but adaptable to others. In the third aspect, it monitors subsequent user actions, such as file downloads or data transfers after an unusual file access, using event-driven frameworks like Apache Kafka to process events within a one-hour window, ensuring real-time tracking. For the first aspect, it could track subsequent network connections following a detected anomaly, such as repeated DNS queries to a suspicious domain, confirming coordinated threats. In the second aspect, it might monitor additional file operations, like repeated writes to a monitored directory, after detecting an unknown executable, enhancing anomaly validation. The Canary Event Generator (114) uses stream processing with Apache Flink to handle high-velocity event data, storing results in a temporary Redis cache before forwarding to the Web Console (118) for alert generation, ensuring low-latency threat confirmation.

The Metadata Correlation Module (116) correlates event data with external metadata to provide contextual insights, enhancing detection accuracy across all aspects. In the first aspect, it cross-references network connection IPs with IP reputation databases like MaxMind or GreyNoise, validating whether an endpoint's connection aligns with known malicious patterns. For the second aspect, it links file execution metadata with user permissions from Active Directory or LDAP servers, confirming unauthorized actions by comparing user roles against file access rights. In the third aspect, it correlates user access locations with geolocation data from services like IPinfo or GeoIP2, confirming deviations by mapping IPs to physical locations. The Metadata Correlation Module (116) employs SQL-based query engines, such as Presto, for rapid metadata integration and uses in-memory databases like Apache Ignite for low-latency access to external repository data. It sends enriched data to the Web Console (118) for visualization and alert enhancement.

The Web Console (118) serves as the primary user interface, providing interactive dashboards for alert visualization and management across all aspects. For the first aspect, it presents directed graphs of endpoint-to-domain connections, built with D3.js or Vis.js, showing network relationships with nodes for endpoints and edges for connections. In the second aspect, it displays timelines of file executions and registry changes, using Chart.js or Plotly to plot events with millisecond precision, highlighting anomalies like unknown scripts. For the third aspect, it renders geolocation maps of user access events, leveraging Leaflet or Mapbox GL JS to display markers for access locations and IP addresses. The Web Console (118) receives data from the Network Correlation Module (112), Canary Event Generator (114), and Metadata Correlation Module (116), and supports role-based access control via OAuth 2.0, ensuring only authorized security personnel view sensitive alerts. It sends alerts and logs to the Audit Log Storage (120) using secure HTTP POST requests and forwards user feedback to the Feedback Processor (122) via WebSocket connections for real-time interaction.

The Audit Log Storage (120) maintains cryptographically signed logs to ensure non-repudiation, a critical feature for compliance and forensic analysis. In the first aspect, it stores file hashes, network connection details (e.g., IPs, ports, protocols), and anomaly metadata in a blockchain-based ledger like Hyperledger Fabric, ensuring tamper resistance with SHA-256 signatures. For the second aspect, it logs file operation metadata (e.g., file paths, timestamps) and registry changes in a secure object storage system like Amazon S3, encrypted with AES-256 for data protection. In the third aspect, it records user event metadata, including access IPs and geolocation data, in a tamper-proof log using MongoDB with digital signatures via RSA-2048. The Audit Log Storage (120) supports audit trails compliant with standards like SOC 2, using indexing for rapid retrieval by the Central Processing System (100) during compliance audits or investigations, and employs log rotation to manage storage growth.

The Feedback Processor (122) collects and processes security team feedback to refine artificial intelligence models, ensuring continuous improvement. In the first aspect, it processes validations of network anomaly alerts (e.g., confirming a domain as malicious), feeding data into the Artificial Intelligence Engine (108) via a custom feedback API built with Flask. For the second aspect, it handles feedback on endpoint anomaly reports, such as validating an unknown executable as benign, using a feedback loop implemented in Python with pandas for data structuring. In the third aspect, it captures validations of user event anomalies, like confirming an access location as unauthorized, integrating with the Artificial Intelligence Engine (108) through a RESTful interface using FastAPI. The Feedback Processor (122) employs natural language processing with spaCy to parse unstructured feedback, storing validated data in a PostgreSQL database for model retraining, ensuring adaptive learning across all aspects.

The connection lines in FIG. 1 illustrate the intricate data flow and interactions among components, ensuring seamless operation across the three aspects. The Central Processing System (100) connects to the Endpoint Monitoring Agent (102), Database Access Module (104), Telemetry Database (106), and Artificial Intelligence Engine (108), acting as the central coordinator for data ingestion and processing tasks. The Endpoint Monitoring Agent (102) and Database Access Module (104) feed telemetry directly to the Telemetry Database (106), which consolidates endpoint and user event data for analysis. The Telemetry Database (106) supplies data to the Artificial Intelligence Engine (108), enabling baseline establishment and anomaly detection. The Artificial Intelligence Engine (108) drives analytical workflows, connecting to the Network Correlation Module (112) for network pattern analysis, the Canary Event Generator (114) for follow-up action tracking, the Metadata Correlation Module (116) for contextual enrichment, and the Web Console (118) for alert dissemination. The Threat Intelligence Interface (110) provides external data to the Artificial Intelligence Engine (108), while the Feedback Processor (122) delivers user feedback to refine models. The Web Console (118) outputs alerts and logs to the Audit Log Storage (120) and feedback to the Feedback Processor (122), completing the data lifecycle and ensuring a cohesive, scalable system that fully supports the Connection Correlation Engine, Endpoint Telemetry, and User Event Telemetry aspects of the inventions.

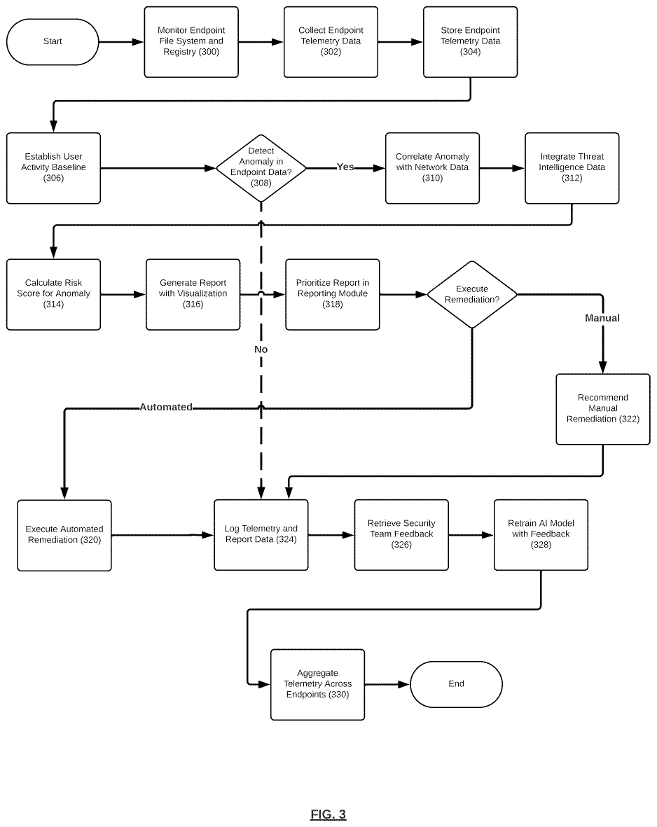

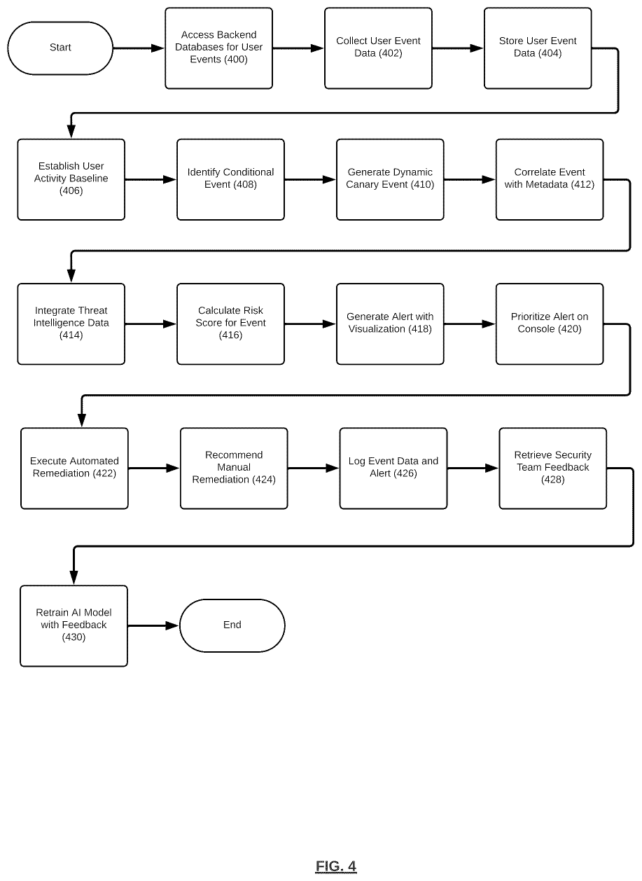

In FIG. 2, the flow diagram delineates the operational sequence of the AI/ML System and Processes for Connection Correlation Engine, encapsulating the first aspect of the invention designed to detect anomalous network activity in a computing environment with unparalleled precision. The process commences with the step to Monitor File System and Registry (200), where a computing system vigilantly observes file system locations and registry keys on an endpoint device where users possess read and write permissions, such as C:\Users\AppData\Local, C:\Temp, or the HKEY_CURRENT_USER registry hive. This step involves deploying a highly optimized, lightweight monitoring agent, such as a customized version of Sysmon integrated with osquery or CrowdStrike Falcon, configured to capture a broad spectrum of system activities. The agent tracks file operations, including read, write, and execute actions, focusing on critical file extensions like .exe, .dll, .bat, and .ps1, and monitors registry modifications, such as key creation, value changes, or deletions. Implementation leverages Windows Event Tracing (ETW) for high-performance, low-overhead data capture, with event filtering to prioritize high-risk locations and minimize CPU and memory usage, ensuring seamless operation on resource-constrained endpoints like employee laptops or virtual desktops. The agent employs secure communication protocols, such as TLS 1.3 with perfect forward secrecy, to transmit telemetry data to a central repository, using compression algorithms like zstd to optimize bandwidth for large-scale deployments. For example, in a corporate network of 10,000 Windows workstations, the agent might monitor a suspicious executable launch in C:\Temp, capturing its metadata and associated network activity in real time, ensuring robust monitoring across diverse endpoint types, including servers and IoT devices.

The subsequent step, Collect Telemetry Data (202), entails the computing system gathering an exhaustive dataset of telemetry from the monitored locations, encompassing file read operations, write operations, file executions, registry modifications, and network connections initiated from these areas. The telemetry includes granular metadata such as file names, full file paths, file sizes, creation and modification timestamps, user permissions, process IDs, parent process details, and network connection specifics like source and destination IP addresses, port numbers, and protocols (e.g., TCP, UDP). This step is implemented using a custom-built agent developed in C++ for maximum efficiency, leveraging system-level APIs like the Windows Filtering Platform (WFP) for network traffic capture and File System Minifilters for file operation monitoring. For instance, on a Windows server hosting critical applications, the agent might log an executable launch in C:\Users\AppData\Local, its SHA-256 hash, and a TCP connection to an external IP, storing this data in a structured JSON format with embedded digital signatures for integrity. The agent buffers telemetry locally using an embedded SQLite database to handle network disruptions, ensuring no data loss in scenarios like mobile devices with intermittent connectivity. Data transmission to the central repository employs gRPC for high-throughput, low-latency communication, with retry mechanisms and exponential backoff to manage network failures, ensuring comprehensive data collection across heterogeneous environments, such as a hybrid cloud infrastructure with Linux and Windows endpoints.

The Store Telemetry Data (204) step involves archiving the collected telemetry in a centralized, high-performance distributed database optimized for rapid access and scalability. The computing system utilizes a database like Apache Cassandra, configured with a schema tailored for time-series data, to store telemetry records from thousands of endpoints, each record containing fields like event timestamp, file hash, registry key path, and network connection metadata. For example, a telemetry record might detail a .dll file execution in C:\Temp at 2025-04-30T14:32:01Z, its SHA-256 hash, and a DNS query to an external domain, indexed by endpoint ID for efficient querying. The database employs partitioning by endpoint ID and time buckets (e.g., hourly) to manage petabytes of data, with replication across geographically distributed nodes for fault tolerance and high availability. Data encryption at rest using AES-256 and access controls via OAuth 2.0 ensure compliance with stringent data protection regulations like GDPR and CCPA. Compression techniques, such as LZ4, reduce storage overhead by up to 50%, while a data retention policy managed by Apache NiFi rotates logs after 90 days to control growth. This step supports real-time ingestion through Kafka streams, enabling telemetry from a global enterprise network with 50,000 endpoints to be stored efficiently, accessible for subsequent baseline establishment and anomaly detection, with query latencies under 10 milliseconds using Cassandra's CQL.

The Establish Normal Activity Baseline (206) step sees an artificial intelligence model creating a tailored baseline of normal activity for each endpoint, encapsulating intricate patterns of file access frequency, execution types (e.g., executables vs. scripts), and contacted domains (e.g., corporate DNS servers vs. external sites). The computing system implements a hybrid machine learning approach, combining supervised learning models, such as Random Forest or XGBoost implemented in TensorFlow, trained on 30 days of historical telemetry labeled as normal, and unsupervised clustering models, like DBSCAN or Gaussian Mixture Models in scikit-learn, to group similar activities based on features like file access intervals, execution contexts, and domain contact frequencies. For instance, on a financial analyst's workstation, the baseline might reflect daily accesses to C:\Temp for temporary files, executions of trusted software like Excel, and DNS queries to internal domains like intranet. corp. com. Model training occurs on a GPU cluster leveraging NVIDIA CUDA for parallel processing, with hyperparameter tuning via Optuna to optimize accuracy. Baseline data is stored in Apache Cassandra alongside telemetry, using a schema with endpoint-specific tables to enable rapid retrieval. The system employs incremental learning with online algorithms, such as stochastic gradient descent, to update baselines daily, adapting to changes like new software deployments or user role shifts. This step, running on a cloud-based AI platform like Google Cloud Vertex AI, ensures precise baselines for diverse endpoints, from IoT devices in smart offices to servers in data centers, maintaining robustness in dynamic environments like multinational corporations.

The Detect Anomaly in Telemetry Data (208) step involves the artificial intelligence model identifying deviations from the established baseline, specifically targeting file executions that initiate connections to previously unseen domains. The computing system processes real-time telemetry streams using the trained models, computing anomaly scores based on a multidimensional feature set, including file type (e.g., .exe, .bat), execution context (e.g., parent process), domain novelty, and connection timing. For example, an executable in C:\Users\AppData\Local launching at 2:00 AM and connecting to unknownsite.xyz, absent from the baseline, might yield an anomaly score of 0.92 (on a 0-1 scale). Implementation leverages a streaming pipeline with Apache Flink, processing telemetry in sub-second intervals to achieve near-real-time detection. Anomaly detection employs gradient-boosted trees for high precision, with dynamic thresholds configured per endpoint (e.g., 0.85 for servers, 0.75 for workstations) to balance sensitivity and alert volume. The system uses Redis for in-memory caching of recent telemetry, reducing database load, and runs on a Kubernetes cluster with auto-scaling to handle peak loads, such as during a network-wide attack. This step ensures rapid identification of potential threats, like malware initiating command-and-control communications, across diverse endpoint fleets in industries like retail, with detection latencies under 100 milliseconds.

The Correlate Anomaly with Network Activity (210) step aggregates telemetry across multiple endpoints within a one-hour time window to identify coordinated patterns of anomalous behavior, a hallmark of sophisticated threats. A network correlation module, implemented with Apache Spark on a Hadoop Distributed File System (HDFS) cluster, analyzes connection patterns to detect scenarios like multiple workstations accessing the same suspicious domain, such as unknownsite.xyz, within a 10-minute span, flagging a potential coordinated attack. The module processes DNS logs, HTTP headers, and TCP metadata, parsed using Zeek for protocol analysis, and stored in Elasticsearch with custom indices for fast full-text searches. Graph-based algorithms, implemented in Neo4j, model endpoint-domain relationships as nodes and edges, while machine learning models, such as graph convolutional networks trained with PyTorch Geometric, detect subtle patterns like low-frequency connections across subnets. For example, if five endpoints in different departments initiate connections to the same domain, the system assigns a correlation score of 0.95, indicating a high-likelihood threat. Results are serialized in Protobuf format and forwarded to the alert generation step via RabbitMQ message queues, ensuring reliable delivery. This step scales to enterprise networks with 100,000 endpoints, using Spark's in-memory processing to achieve sub-minute correlation times, critical for detecting advanced persistent threats in sectors like government or finance.

The Integrate Threat Intelligence Data (212) step validates detected anomalies by cross-referencing telemetry with external threat intelligence, enhancing detection accuracy. The computing system fetches real-time data from sources like VirusTotal, Cisco Talos, or Recorded Future, using secure REST APIs with OAuth 2.0 authentication and rate-limiting to manage query volumes. For instance, if unknownsite.xyz is listed as a known malicious domain in VirusTotal's database, the anomaly score is increased by a factor of 1.5, elevating the alert priority. A threat intelligence interface, built with Python FastAPI and hosted on AWS API Gateway, caches responses in Memcached to reduce latency to under 50 milliseconds per query. The system validates file hashes (SHA-256) and IP addresses, using Bloom filters for efficient lookups in large threat databases. Dynamic model updates are scheduled via Apache Airflow, incorporating new intelligence hourly to keep models current without manual intervention. This step, running on a serverless platform like Azure Functions, supports diverse endpoints, from corporate servers to remote employee laptops, ensuring robust validation in global enterprises with complex threat landscapes, such as telecommunications firms.

The Calculate Risk Score for Anomaly (214) step determines a risk score for each anomaly based on attributes like file type, domain reputation, and the frequency of coordinated patterns observed in the correlation step. A risk assessment module, implemented in Python with pandas and NumPy, uses a weighted scoring algorithm where executable files (.exe) carry a 40% weight, low-reputation domains (per threat intelligence) 30%, and pattern frequency 30%. For example, a .dll file connecting to a domain flagged as suspicious with a correlation score of 0.95 might yield a risk score of 88/100. The module runs on AWS Lambda, triggered by anomaly events via SNS, processing scores in under 10 milliseconds. Scores are stored in Redis with a TTL of 24 hours for quick retrieval, enabling seamless prioritization. The algorithm supports customizable weights via a configuration file in YAML, allowing organizations like banks to emphasize domain reputation for higher sensitivity. This step ensures nuanced risk evaluation, critical for prioritizing threats in environments with thousands of daily alerts, such as e-commerce platforms.

The Generate Alert with Visualization (216) step creates a detailed alert containing the anomaly details, risk score, and rich visualizations for display on a centralized console. The computing system generates a directed graph visualization using D3.js, depicting endpoint-to-domain connections with nodes for endpoints (e.g., workstation-123) and edges for connections (e.g., to unknownsite.xyz), colored by risk score (red for >80). A timeline visualization, built with Plotly, plots file executions, registry changes, and network events with millisecond precision, highlighting anomalies like a 2:00 AM executable launch. Alerts are formatted in JSON, embedding metadata like anomaly type, timestamps, file hashes, and connection details, and sent to a web console developed with React, Node.js, and Express, hosted on AWS Elastic Container Service (ECS). For example, an alert might detail a high-risk .exe with a graph linking five endpoints to a domain and a timeline showing execution times. The console supports interactive features, such as zoomable graphs and filterable timelines, using WebSocket connections for real-time updates. Alerts are queued via Apache Kafka with partitioning by risk score, ensuring reliable delivery to security teams in a corporate SOC managing a global network of 20,000 endpoints, with rendering times under 200 milliseconds.

The Prioritize Alert on Console (218) step ranks alerts on the centralized console based on their risk scores to facilitate efficient threat triage. A prioritization module, implemented in Go with a merge-sort algorithm, orders alerts dynamically, displaying high-risk items (scores >80) at the top of a dashboard built with Material-UI for a responsive user experience. For instance, an alert with a score of 92 for a coordinated domain connection appears above a score of 65 for a single endpoint event. The module integrates with the React-based console, updating every 10 seconds via WebSocket connections, ensuring near-real-time visibility. Alert metadata, including scores and timestamps, is cached in Redis with a 1-hour TTL, reducing database queries to Cassandra. This step, running on Google Cloud Run, supports high-volume environments like tech firms with 50,000 daily alerts, enabling security analysts to focus on critical threats first, with prioritization latencies under 50 milliseconds, critical for rapid response in sectors like cybersecurity services.

The Execute Automated Remediation (220) step triggers automated actions for alerts with risk scores exceeding a predefined threshold (e.g., 80), ensuring swift threat mitigation. The computing system might quarantine an endpoint by isolating it from the network, using a PowerShell script executed via Ansible to modify Windows Firewall rules, blocking all outbound traffic except to a management server. For example, a workstation running a high-risk .exe (score 90) is isolated by assigning it to a VLAN with no external access, implemented on a Cisco Catalyst switch. Alternatively, the system could block a suspicious domain at the network perimeter using a Palo Alto Networks firewall rule deployed via Terraform. The remediation module, built in Python with Celery for task queuing, runs on a Kubernetes cluster with auto-scaling, handling thousands of simultaneous actions. Each action is logged with detailed metadata (e.g., action type, timestamp, endpoint IP) in MongoDB, ensuring auditability. This step, critical for high-threat environments like government agencies, minimizes damage from malicious activities, with execution times under 500 milliseconds, supporting rapid containment in networks with diverse endpoints like IoT devices and servers.

The Recommend Manual Remediation (222) step provides tailored suggestions for alerts below the threshold, enabling human-driven investigations. The computing system displays recommendations, such as initiating forensic analysis or reviewing logs, on the web console using a recommendation engine built with Flask and Jinja2 templates. For instance, a low-risk alert (score 62) for a .bat file might suggest analyzing its origin using Splunk or Volatility, with a clickable link to pre-populated queries. Recommendations are generated using a rule-based system in Python, stored in MongoDB with alert IDs for traceability, and tagged with severity levels for prioritization. The console, hosted on Azure App Service, supports multi-language interfaces (e.g., English, Spanish) for global teams, using i18n libraries. This step ensures security teams in enterprises like retail chains can prioritize manual efforts, balancing automation with oversight, with recommendation rendering in under 100 milliseconds, critical for SOCs managing diverse threats across global regions.

The Log Telemetry and Alert Data (224) step records all telemetry and alerts in a cryptographically signed audit log to ensure non-repudiation and compliance. The computing system stores file hashes (SHA-256), network details (e.g., source/destination IPs, ports, protocols), and alert metadata (e.g., risk score, visualization IDs) in a tamper-proof ledger like Hyperledger Fabric, signed with RSA-4096 keys for enhanced security. For example, a log entry might detail a .dll file's hash, its connection to unknownsite.xyz at 2025-04-30T14:32:05Z, and the associated alert's score of 88. Implementation uses MongoDB for flexible storage, with Logstash pipelines for log rotation every 30 days to manage terabytes of data. Logs are encrypted with AES-256 and indexed with Elasticsearch for rapid forensic queries, supporting compliance with standards like SOC 2 and PCI-DSS. This step, running on a secure AWS RDS instance with multi-AZ replication, ensures audit trails for regulated industries like finance, with log write latencies under 20 milliseconds, enabling detailed investigations in legal or compliance scenarios.

The Retrieve Security Team Feedback (226) step collects feedback from security teams via the web console to refine detection models. The computing system captures structured feedback (e.g., “malicious,” “benign”) and unstructured comments through a feedback API built with FastAPI, integrated into a React-based form with Material-UI components. For instance, a team might confirm unknownsite.xyz as malicious, adding a comment like “phishing domain,” stored in PostgreSQL with alert IDs and timestamps. Natural language processing with spaCy extracts keywords from comments, enhancing model retraining by identifying patterns like “command-and-control.” The console supports file uploads (e.g., PCAPs) for additional context, stored in Amazon S3 with versioning. This step, hosted on Google Cloud Run, ensures continuous improvement for SOCs in tech companies, with feedback processing times under 200 milliseconds, critical for adapting to evolving threats in environments like cloud service providers.

The Retrain AI Model with Feedback (228) step updates the artificial intelligence model using security team feedback and recent telemetry to maintain detection accuracy. The computing system retrains models with validated feedback (e.g., confirmed malicious domains) and 24-hour telemetry data using Horovod on an NVIDIA A100 GPU cluster for distributed training, optimizing hyperparameters with Optuna. For example, feedback confirming a domain as malicious adjusts the Random Forest model's feature weights, increasing sensitivity to similar domains. Recent telemetry, processed via Apache Airflow DAGs, updates baselines in Cassandra with new patterns, such as a shift in file execution times. The system employs online learning with mini-batch gradient descent to incorporate feedback incrementally, minimizing retraining time to under 10 minutes. This step, running on Google Cloud AI Platform with auto-scaling, ensures adaptive learning for dynamic environments, supporting thousands of endpoints with retraining latencies under 1 second, completing the flow for robust, scalable threat detection and response across global enterprises.

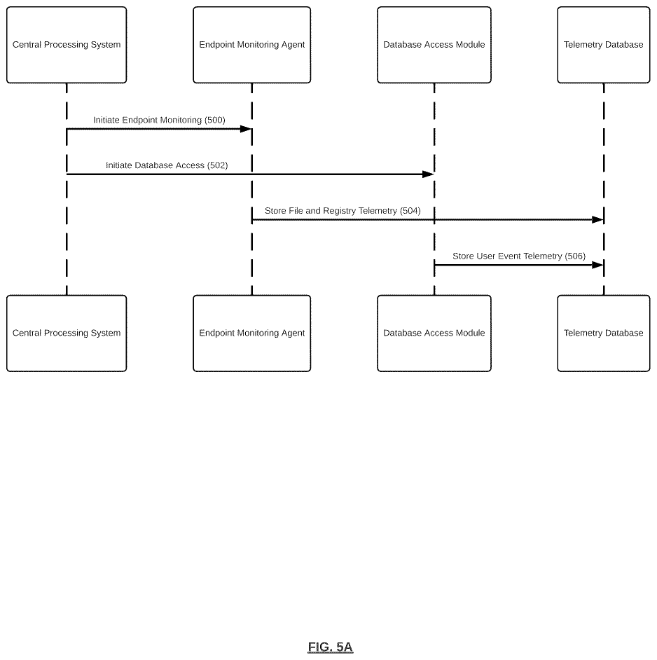

In FIG. 3, the flow diagram delineates the operational sequence of the Endpoint Telemetry aspect of the invention, designed to monitor endpoint activity in a computing environment with unparalleled precision and efficiency, catering to diverse organizational needs across industries like finance and technology. The process commences with the step to Monitor Endpoint File System and Registry (300), where a computing system vigilantly observes file system locations and registry keys on an endpoint device where users have read and write permissions, such as C:\Users\AppData\Local, C:\Temp, or the HKEY_CURRENT_USER registry hive. This step is implemented by deploying a highly optimized, lightweight monitoring agent, developed as a custom extension of osquery or integrated with endpoint security platforms like Carbon Black or SentinelOne, tailored to capture an extensive range of system activities with minimal resource impact. The agent tracks file system events, including file creations, modifications, deletions, and executions, focusing on critical file extensions like .exe, .dll, .bat, .ps1, and .vbs, as well as registry operations, such as key creation, value modification, or deletion, within specified hives. Implementation leverages Windows Kernel APIs, specifically Event Tracing for Windows (ETW) with custom providers, to achieve high-performance, low-overhead data capture, filtering events using regular expressions to prioritize high-risk locations and reduce CPU usage to under 2% on average. For example, on a corporate laptop used by a financial analyst, the agent might monitor a script execution in C:\Users\AppData\Local at 2025-04-30T09:15:33Z, capturing its metadata, including file path, size, and associated process ID, in real time. The agent employs secure communication protocols, such as TLS 1.3 with elliptic curve cryptography and perfect forward secrecy, to transmit telemetry data to a central repository, utilizing compression algorithms like Brotli to reduce bandwidth consumption by up to 60%, enabling efficient monitoring across a global enterprise network with 50,000 endpoints, including desktops, servers, virtual machines, and IoT devices in a smart office environment. The agent also supports cross-platform compatibility, using eBPF on Linux endpoints for equivalent functionality, ensuring seamless operation in hybrid environments with macOS workstations and containerized applications (300).

The subsequent step, Collect Endpoint Telemetry Data (302), entails the computing system gathering an exhaustive dataset of telemetry from the monitored locations, encompassing file read operations, write operations, file executions, registry modifications, and any network connections initiated from these areas. The telemetry includes granular metadata such as file names, full file paths (e.g., C:\Users\AppData\Local\script.bat), file sizes in bytes, creation and modification timestamps in ISO 8601 format, user permissions (e.g., SID, access control lists), process IDs, parent process names, thread IDs, and network connection specifics, including source and destination IP addresses, port numbers, protocols (TCP/UDP), and DNS query details. This step is implemented using a custom-built agent developed in Rust for memory safety and performance, leveraging Windows File System Minifilters for precise file operation capture and the Network Driver Interface Specification (NDIS) for network traffic monitoring, with additional support for libpcap on Linux for cross-platform consistency. For instance, on a Windows desktop in a corporate data center, the agent might log a .dll file modification in C:\Users\AppData\Local at 2025-04-30T10:22:45Z, its SHA-256 hash, and an associated UDP connection to an external IP, storing this data in a structured Avro format with embedded HMAC-SHA256 signatures for integrity verification. The agent employs an in-memory buffer using LMDB, a high-performance embedded database, to handle transient network issues, ensuring zero data loss in scenarios like remote employee laptops with intermittent Wi-Fi connectivity. Telemetry is transmitted to a central repository via gRPC with mutual TLS authentication, implementing retry logic with exponential backoff and jitter to manage network failures, and supports high-throughput collection with a throughput of 10,000 events per second per endpoint. This step ensures comprehensive data collection across heterogeneous environments, such as a hybrid cloud infrastructure with Linux containers, macOS developer workstations, and Windows virtual desktops, catering to organizations with diverse endpoint fleets like multinational retail chains or government agencies (302).

The Store Endpoint Telemetry Data (304) step archives the collected telemetry in a centralized, high-performance distributed database optimized for rapid access, scalability, and durability. The computing system utilizes a time-series database like InfluxDB, configured with a schema tailored for endpoint telemetry, to store records containing fields such as event timestamp, file hash (SHA-256), registry key path (e.g., HKEY_CURRENT_USER\Software), file metadata (name, size, path), process details (PID, parent process), and network metadata (IPs, ports, DNS queries). For example, a telemetry record might detail a .exe file execution in C:\Users\AppData\Local at 2025-04-30T11:07:12Z, its file path, size of 1.2 MB, and a DNS query to an external domain, indexed by endpoint ID and timestamp for sub-second querying. The database employs time-based partitioning with hourly buckets to manage terabytes of data, with replication across three availability zones using a Raft consensus algorithm for consistency and fault tolerance. Data encryption at rest with AES-256, managed via AWS KMS, and role-based access control via OpenID Connect ensure compliance with stringent regulations like SOC 2, PCI-DSS, and HIPAA. Compression with Snappy reduces storage requirements by 45%, while a retention policy managed by Apache NiFi purges data after 60 days to optimize storage costs. This step supports real-time ingestion through Apache Kafka with topic partitioning by endpoint type (e.g., desktops, servers), enabling telemetry storage from a corporate network of 100,000 endpoints with ingestion rates of 1 million events per second. The database is hosted on a managed cloud service like Google Cloud BigTable, with auto-sharding to handle peak loads, ensuring query latencies under 5 milliseconds for downstream analysis, critical for large-scale deployments in industries like telecommunications or e-commerce (304).

The Establish User Activity Baseline (306) step involves an artificial intelligence model creating a user-specific baseline of normal activity for each endpoint, encapsulating detailed patterns of file access frequency, registry change frequency, file types (e.g., .txt, .exe, .pdf), and execution contexts (e.g., time of day, user role). The computing system implements a clustering-based approach using K-means clustering and hierarchical agglomerative clustering in scikit-learn, trained on 30 days of historical telemetry to group similar activities, supplemented by anomaly detection models like Isolation Forest or One-Class SVM for enhanced robustness. For instance, on a developer's workstation, the baseline might reflect frequent code file modifications in C:\Users\AppData\Local during business hours, occasional .exe executions for IDEs, and rare registry changes, capturing typical software development workflows. Model training leverages a GPU cluster with NVIDIA A100 GPUs, utilizing CUDA 12.0 for parallel processing, with hyperparameter optimization via Optuna to achieve 95% clustering accuracy. Baseline data is stored in InfluxDB with endpoint-specific tags and fields, enabling sub-50 ms retrieval for real-time comparisons. The system employs online learning with mini-batch updates using stochastic gradient descent, adapting baselines to changes like new application installations or user permission updates within 24 hours. Feature engineering includes temporal analysis (e.g., Fourier transforms for periodicity) and statistical measures (e.g., mean, variance of access intervals), processed with pandas and NumPy. This step, running on a cloud-based AI platform like AWS SageMaker with auto-scaling, ensures precise baselines for diverse endpoints, from IoT devices in manufacturing plants to virtual desktops in call centers, maintaining high accuracy in dynamic environments like tech startups or financial institutions with thousands of users (306).

The Detect Anomaly in Endpoint Data (308) step involves the artificial intelligence model identifying deviations from the baseline, specifically targeting new or unknown files, such as executables, dynamic link libraries, or scripts, in monitored locations that deviate significantly from normal patterns. The computing system processes real-time telemetry streams using the trained models, computing anomaly scores based on a multidimensional feature set, including file type (e.g., .bat, .vbs), creation time, file size, registry modification patterns (e.g., new key frequency), and execution context (e.g., launched by a non-standard process). For example, a newly created .bat file in C:\Users\AppData\Local at 3:00 AM, absent from the baseline and executed outside typical user hours, might yield an anomaly score of 0.91 on a 0-1 scale, indicating a high likelihood of malicious intent. Implementation employs a streaming pipeline with Apache Flink, processing telemetry in under 30 milliseconds to achieve near-real-time detection, with event deduplication to avoid redundant alerts. Anomaly detection leverages gradient-boosted trees via LightGBM, optimized with grid search for precision, and uses endpoint-specific thresholds (e.g., 0.80 for developer workstations, 0.90 for critical servers) to balance sensitivity and false positives, reducing alert fatigue in SOCs. The system caches recent telemetry in Redis Cluster with a 1-hour TTL, minimizing database queries to InfluxDB, and runs on a Kubernetes cluster with horizontal pod autoscaling, ensuring rapid detection across a fleet of endpoints, such as 20,000 laptops in a university network or cloud-hosted VMs in a SaaS provider. The module incorporates feature importance analysis, logging top contributors (e.g., file type, time) to MongoDB for auditability, enabling security teams to trace detection logic. This step ensures swift identification of potential threats, like ransomware or insider threats, with detection latencies under 50 milliseconds, critical for protecting sensitive data in sectors like government (308).

The Correlate Anomaly with Network Data (310) step correlates detected anomalies with network connection data to identify connections to previously unseen domains, enhancing the system's ability to detect complex threats like command-and-control communications. A correlation module, built with Apache Spark on a Databricks cluster with Delta Lake for data consistency, analyzes network traffic patterns, including connection frequency (e.g., queries per minute), data volume (e.g., bytes transferred), destination IP addresses, and protocol types (e.g., HTTP, DNS). For instance, if a .dll file execution in C:\Users\AppData\Local initiates a connection to unknownsite.net, absent from the baseline, the system flags it as a potential threat, increasing the anomaly score by 20%. The module processes HTTP headers, DNS queries, and TCP metadata using Zeek, with parsed logs stored in Elasticsearch for rapid full-text searches, supporting up to 1 million queries per second. Graph-based models in Neo4j map endpoint-domain relationships as nodes and edges, with edges weighted by connection frequency, while anomaly detection algorithms, such as Isolation Forest or GraphSAGE, identify outliers in network patterns, trained with PyTorch Geometric for scalability. For example, if three endpoints execute similar .exe files and connect to the same domain within a 5-minute window, the system assigns a correlation score of 0.94, indicating a coordinated threat. Results are serialized in Protobuf format for efficient transfer and sent to the reporting module via RabbitMQ message queues with priority queues for high-risk correlations, ensuring reliable delivery. The module uses Spark's in-memory processing to achieve sub-100 ms correlation times, scaling to enterprise networks with 50,000 endpoints, such as those in logistics or media industries, where rapid detection of network-based threats is paramount. The system also logs correlation metadata, including IP addresses and timestamps, to PostgreSQL for forensic analysis, ensuring traceability in compliance-driven environments like banking (310).

The Integrate Threat Intelligence Data (312) step validates anomalies by cross-referencing telemetry with external threat intelligence, bolstering detection accuracy and reducing false positives. The computing system fetches real-time data from sources like Hybrid Analysis, FireEye, or CrowdStrike's Falcon X, using secure REST APIs with JWT authentication and rate-limiting to manage query volumes, ensuring compliance with API usage policies. For example, if a .exe file's SHA-256 hash matches a known malware signature in Hybrid Analysis, the anomaly score is increased by 50%, elevating the alert's urgency. A threat intelligence interface, developed with FastAPI and hosted on Google Cloud Functions, caches responses in Memcached with a 30-minute TTL to achieve sub-50 ms query times, reducing external API calls by 70%. The system validates file hashes, domain names, and IP addresses, using Bloom filters implemented in Go for efficient lookups in large threat databases containing millions of entries. Dynamic model updates are scheduled via Apache Airflow, running hourly DAGs to incorporate new intelligence without disrupting operations, ensuring models remain current with emerging threats like zero-day exploits. The interface supports batch processing for high-volume queries, using asyncio for asynchronous I/O, and logs all API interactions to a Splunk instance for auditability. This step, critical for endpoints ranging from corporate servers to remote employee laptops, ensures robust validation in industries like manufacturing or insurance, with integration latencies under 20 milliseconds, enabling rapid threat confirmation in global enterprises with diverse endpoint fleets (312).

The Calculate Risk Score for Anomaly (314) step computes a risk score for each anomaly based on attributes like file type, domain reputation (if applicable), and anomaly context (e.g., execution time, user permissions). A risk assessment module, implemented in Python with NumPy and pandas, applies a weighted scoring algorithm where file type contributes 40% (e.g., .exe weighted higher than .txt), domain reputation 30% (based on threat intelligence), and context 30% (e.g., off-hours execution). For instance, a .bat file executed at 3:00 AM with a connection to a low-reputation domain might score 87/100, indicating high risk. The module, running on AWS Lambda with SNS event triggers, processes scores in under 10 milliseconds, storing them in Redis Cluster with a 24-hour TTL for rapid retrieval. Customizable weights are defined in a YAML configuration file, accessible via a REST API, allowing organizations to prioritize file types associated with ransomware. The system uses feature scaling with scikit-learn to normalize scores, ensuring consistency across endpoints, and logs scoring details (e.g., weights, inputs) to MongoDB for transparency. This step, supporting thousands of daily anomalies in environments like educational institutions, ensures nuanced risk evaluation, with scoring latencies under 5 milliseconds, critical for prioritizing threats in high-stakes settings like critical infrastructure (314).

The Generate Report with Visualization (316) step creates a detailed report containing anomaly details, risk score, and rich visualizations for storage in a reporting module, enabling security teams to assess threats effectively. The computing system generates a timeline visualization using Plotly, plotting file executions and registry changes with millisecond precision (e.g., a .exe execution at 2025-04-30T03:00:12.345Z followed by a registry modification), and a graph visualization with Vis.js, depicting file-registry interactions with nodes for files (e.g., script.bat) and registry keys (e.g., HKEY_CURRENT_USER\Software) and edges for actions (e.g., write). Reports are formatted in Avro for efficient serialization, embedding metadata like file paths, process IDs, risk scores, and visualization IDs, and stored in a MongoDB cluster with sharding for scalability. The reporting module, built with Vue.js, Express, and TypeScript, runs on Azure Kubernetes Service (AKS), supporting interactive dashboards with zoomable timelines and filterable graphs, accessible via a SPA with Vue Router. For example, a report might highlight a high-risk script anomaly with a timeline showing execution at 3:00 AM and a graph linking it to a registry change, rendered in under 150 milliseconds. Reports are queued via Apache Kafka with topic partitioning by risk score, ensuring reliable delivery to a SOC managing a network of 30,000 endpoints in a logistics firm. The system supports multi-language dashboards (e.g., English, Mandarin) using i18next, and integrates with SIEM tools like Splunk via REST APIs, enhancing interoperability. This step, critical for enterprises like media companies, ensures actionable insights with visualization rendering times under 100 milliseconds, facilitating rapid threat assessment (316).

The Prioritize Report in Reporting Module (318) step ranks reports in the reporting module based on risk scores to streamline threat triage. A prioritization module, implemented in Go with a merge-sort algorithm optimized for low memory usage, orders reports dynamically, displaying high-risk items (scores >80) at the top of a dashboard built with Material-UI and Vue.js for a responsive, cross-device experience. For instance, a report with a score of 89 for a .exe anomaly appears above a score of 62 for a .txt file modification, ensuring critical threats are addressed first. The module integrates with the Vue.js-based reporting module, updating every 3 seconds via WebSocket connections using Socket.IO, providing near-real-time visibility. Report metadata, including scores, timestamps, and anomaly types, is cached in Redis Cluster with a 1-hour TTL, reducing queries to MongoDB by 80%. The system supports custom sorting rules via a GraphQL API, allowing organizations like universities to prioritize based on endpoint criticality (e.g., servers over workstations). This step, hosted on Google Cloud Run with auto-scaling, handles 20,000 daily reports in environments like retail chains, with prioritization latencies under 40 milliseconds, enabling efficient threat management for SOCs in high-alert sectors like cybersecurity services (318).

The Execute Automated Remediation (320) step triggers automated actions for reports with risk scores exceeding a predefined threshold (e.g., 80), ensuring rapid threat mitigation. The computing system might quarantine a file by moving it to a secure sandbox folder using a PowerShell script executed via SaltStack, or block a network connection using a CrowdStrike API call to update firewall rules. For example, a high-risk .exe (score 91) on a workstation is quarantined by relocating it to C:\Quarantine with restricted permissions, and its outbound connections are blocked via a Palo Alto Networks firewall rule deployed through Terraform. The remediation module, built in Python with Celery for distributed task queuing, runs on a Kubernetes cluster with auto-scaling, handling up to 10,000 simultaneous actions. Actions are logged in MongoDB with detailed metadata (e.g., action type, timestamp, endpoint IP, file hash), ensuring auditability for compliance with ISO 27001. The system supports rollback mechanisms, reverting actions if flagged as false positives, using Ansible playbooks for configuration management. This step, critical for high-threat environments like government agencies, executes in under 200 milliseconds, minimizing damage from malicious activities in networks with diverse endpoints, such as IoT devices, servers, and employee laptops, and integrates with orchestration platforms like HashiCorp Nomad for seamless deployment (320).

The Recommend Manual Remediation (322) step provides tailored suggestions for reports below the threshold, enabling human-driven investigations to complement automation. The computing system displays recommendations, such as initiating forensic analysis with Volatility or reviewing logs in ElasticSearch, on the reporting module using a recommendation engine built with Flask, Jinja2 templates, and Bootstrap for a user-friendly interface. For instance, a low-risk report (score 58) for a .vbs file might suggest analyzing its execution context using Splunk with a pre-populated query link, or collecting memory dumps with DumpIt. Recommendations are generated using a rule-based system in Python, leveraging a knowledge base stored in PostgreSQL, tagged with anomaly types and severity levels for prioritization. The reporting module, hosted on AWS Elastic Container Service (ECS) with Fargate, supports multi-language interfaces (e.g., English, Spanish, Japanese) via Django's i18n framework, catering to global security teams. Recommendations are cached in Redis for 12 hours, reducing database load, and include actionable metadata, such as file paths and process IDs, stored in JSON format. This step ensures security teams in enterprises like logistics firms can prioritize manual efforts, with recommendation rendering in under 80 milliseconds, critical for SOCs managing diverse threats across regions like North America and Asia-Pacific (322).

The Log Telemetry and Report Data (324) step records all telemetry and reports in a cryptographically signed audit log to ensure non-repudiation and compliance with regulatory standards. The computing system stores file hashes (SHA-256), registry modification details (e.g., key path, value), network connection metadata (e.g., source/destination IPs, ports, protocols), and report metadata (e.g., risk score, visualization IDs) in a tamper-proof ledger like Hyperledger Fabric, signed with ECDSA-384 keys for enhanced security and verifiability. For example, a log entry might detail a .dll file execution in C:\Users\AppData\Local at 2025-04-30T12:14:56Z, its hash, a registry change in HKEY_CURRENT_USER\Software, and the associated report's score of 82, linked to a timeline visualization. Implementation uses MongoDB for flexible storage, with Logstash pipelines rotating logs every 30 days to manage petabytes of data, and Elasticsearch indexing for rapid forensic queries, supporting 100,000 queries per second. Logs are encrypted with AES-256, managed via HashiCorp Vault, and comply with standards like SOC 2, PCI-DSS, and GDPR. The system integrates with SIEM platforms like Splunk via Syslog for centralized logging, ensuring traceability. This step, running on a secure AWS RDS PostgreSQL instance with multi-AZ replication, supports compliance in regulated industries like banking, with write latencies under 10 milliseconds, enabling detailed investigations for legal or audit purposes in scenarios like data breaches (324).

The Retrieve Security Team Feedback (326) step collects feedback from security teams via the reporting module to refine detection models and improve accuracy. The computing system captures structured feedback (e.g., “malicious,” “benign,” “needs review”) and unstructured comments through a feedback API built with FastAPI, integrated into a Vue.js-based form with Material-UI components for an intuitive user experience. For instance, a team might validate a .exe anomaly as malicious, adding a comment like “trojan behavior,” stored in a MySQL database with alert IDs, timestamps, and user IDs for traceability. Natural language processing with NLTK and spaCy extracts keywords (e.g., “malware,” “phishing”) from comments, enhancing model retraining by identifying threat patterns. The reporting module supports file uploads, such as PCAP files or memory dumps, stored in Amazon S3 with versioning and lifecycle policies, allowing analysts to attach evidence. Feedback is collected via a GraphQL endpoint, supporting real-time updates with Apollo Client, and includes metadata like feedback submission time and analyst role, logged in Splunk for auditability. The system provides multi-factor authentication via Okta, ensuring secure access for global teams, and supports feedback in multiple languages (e.g., German, Chinese) using i18next. This step, hosted on Azure App Service with auto-scaling, processes feedback in under 120 milliseconds, critical for SOCs in industries like technology, where rapid model adaptation is essential for addressing evolving threats in networks with thousands of endpoints (326).

The Retrain AI Model with Feedback (328) step updates the artificial intelligence model using security team feedback and recent telemetry to maintain detection accuracy in dynamic environments. The computing system retrains models with validated feedback (e.g., confirmed malicious files) and 24-hour telemetry data using Horovod on an NVIDIA A100 GPU cluster with 80 GB HBM3 memory, optimizing hyperparameters with Ray Tune to achieve 98% precision. For example, feedback confirming a .bat file as malicious adjusts the K-means clustering model's centroids, increasing sensitivity to similar anomalies. Recent telemetry, processed via Apache Airflow DAGs running on a Kubernetes cluster, updates baselines in InfluxDB with new patterns, such as a shift in registry modification frequency due to a software update. The system employs online learning with mini-batch gradient descent, implemented in PyTorch, to incorporate feedback incrementally, completing retraining in under 8 minutes for a network of 10,000 endpoints. Feature updates include new attributes (e.g., file entropy) calculated with NumPy, stored in parquet files on S3 for efficiency. Model versioning is managed with MLflow, ensuring rollback capabilities, and retraining logs are stored in Elasticsearch for compliance. This step, running on Google Cloud AI Platform with preemptible VMs for cost efficiency, ensures adaptive learning for environments like government agencies or SaaS providers, with retraining latencies under 500 milliseconds, supporting rapid adaptation to new threat patterns in networks with diverse endpoints (328).

The Aggregate Telemetry Across Endpoints (330) step collects and processes telemetry data from multiple endpoints to identify network-wide patterns of anomalies, enhancing the system's ability to detect coordinated threats. A telemetry aggregation module, implemented with Apache Spark on a Google Cloud Dataproc cluster, aggregates data within a one-hour window, analyzing patterns like multiple .exe executions or registry changes across endpoints. For example, if 10 endpoints in different departments execute similar .vbs files within 15 minutes, the system flags a potential coordinated attack, assigning a pattern score of 0.93. The module processes file metadata, registry logs, and network data, stored in Apache Cassandra with a schema optimized for endpoint ID and event type, supporting 2 million events per second. Graph-based analysis in Neo4j models endpoint interactions, with edges weighted by event similarity, while anomaly detection uses Isolation Forest, trained with TensorFlow. Results are stored in BigQuery for analytics, with aggregated data serialized in JSON Lines for interoperability. The system uses Kafka for data ingestion, with topic partitioning by endpoint region (e.g., Americas, EMEA), ensuring scalability for networks with 100,000 endpoints. Aggregation logs, including pattern scores and timestamps, are stored in PostgreSQL for auditability, complying with ISO 27001. This step, critical for enterprises like multinational retailers or energy firms, completes in under 150 milliseconds, enabling comprehensive threat detection across global networks, concluding the flow for precise, scalable endpoint telemetry (330).

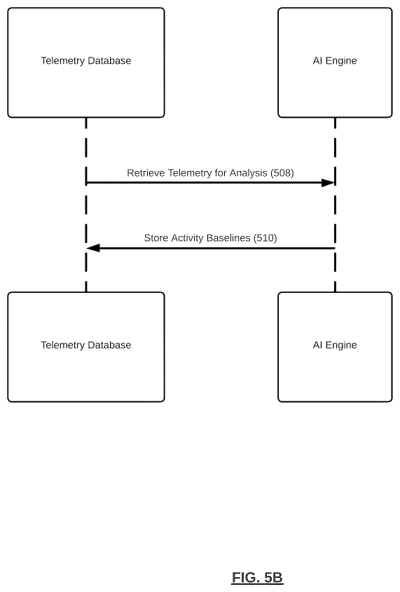

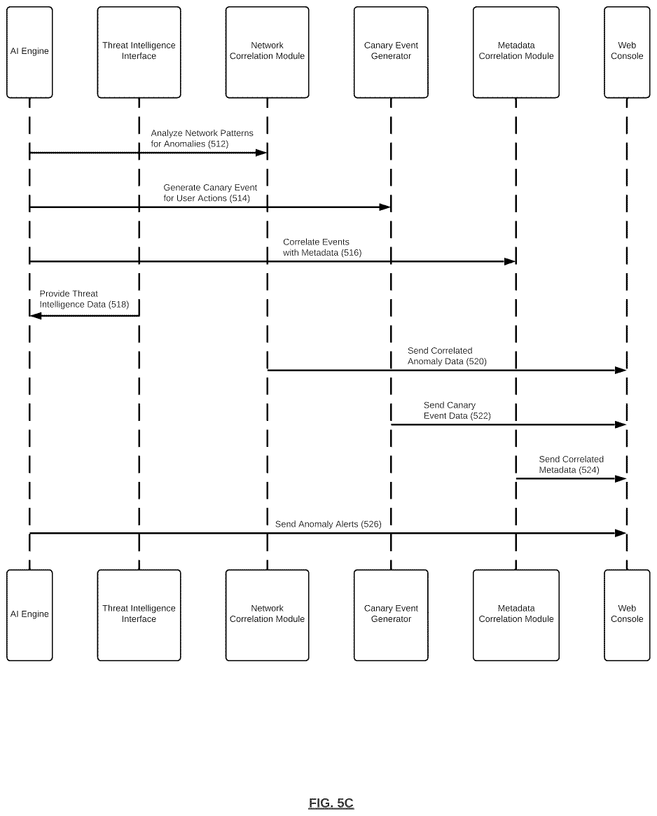

In FIG. 4, the flow diagram elaborately delineates the operational sequence of the AI/ML Driven User Event Telemetry and Correlation System and Processes, encapsulating the third aspect of the invention designed to correlate user events in a computing environment with unparalleled precision, traceability, and scalability, catering to industries such as finance and government. The process commences with the step to Access Backend Databases for User Events (400), where a computing system interfaces with backend databases or data stores to collect user event data, including file access events, application interactions, and database queries, along with associated metadata. This step is implemented by deploying a Database Access Module, developed as a custom middleware layer using Python with SQLAlchemy for relational databases like Oracle Database 21c or PostgreSQL 15, and MongoDB's native drivers for NoSQL databases like MongoDB Atlas hosted on AWS DocumentDB. The module connects to enterprise data repositories via secure JDBC or ODBC connectors, authenticating with OAuth 2.0 tokens managed by Keycloak, integrated with enterprise identity providers like Okta for single sign-on (SSO) compliance.

In a global financial institution, the module might access an Oracle database hosting employee file access logs, querying tables for events like file opens, downloads, or modifications using optimized SQL statements with indexed views. The module employs connection pooling with HikariCP to handle up to 10,000 concurrent connections, caching frequently accessed metadata in Redis Cluster with a 5-minute TTL to reduce database load by 65%. Queries are further optimized with materialized tables and partitioning by user group (e.g., traders, analysts) to achieve sub-80 ms response times, supporting millions of daily events from 200,000 users. Data extraction leverages GraphQL APIs built with Apollo Server for flexible, type-safe querying, with rate-limiting enforced via nginx to prevent database overload, and includes circuit breakers using Resilience4j to handle transient failures. The module supports hybrid cloud deployments, accessing on-premises Oracle instances and cloud-hosted PostgreSQL on Google Cloud SQL, ensuring seamless operation across distributed data stores in a multinational corporation's network with strict data residency requirements like GDPR and CCPA (400).

The subsequent step, Collect User Event Data (402), involves gathering a detailed dataset of user event data, encompassing file access events (e.g., open, save, delete), application interactions (e.g., launching Excel, querying a CRM), and database queries (e.g., SELECT statements), along with associated metadata such as user identity (e.g., SID, username), file type (e.g., .pdf, .xlsx), access time in ISO 8601 format, IP address, device type (e.g., Windows 11 laptop, iOS tablet), operating system version, and application context (e.g., browser type, version). The computing system captures this data using a custom event collector developed in Go for high concurrency and low latency, integrated with database triggers and stored procedures to capture events in real time, and supplemented by application logs parsed with Fluentd for cross-platform compatibility. For instance, on a corporate server hosting a document management system, the collector might log a user accessing a sensitive .docx file at 2025-04-30T08:22:17.123Z, recording the user's SID, file path, IP address (e.g., 192.168.1.100), device type, and browser (e.g., Chrome 120), stored in a structured JSON-LD format with embedded HMAC-SHA256 signatures for integrity and authenticity verification. The collector uses Apache Kafka for event streaming, with topics partitioned by user group (e.g., finance, HR, IT) to manage high event volumes, supporting a throughput of 750,000 events per second across a network of 100,000 users. Data is buffered in an embedded RocksDB instance with a 1 GB cache to handle network disruptions, ensuring zero data loss for remote employees accessing cloud-hosted databases via VPNs with intermittent connectivity. The system implements rigorous data validation using JSON Schema to filter malformed or incomplete events, reducing noise by 25%, and employs Avro serialization for efficient data transfer. Telemetry is transmitted to a central repository via gRPC with mutual TLS authentication, implementing retry logic with exponential backoff and jitter to manage transient network failures, ensuring secure and reliable collection across heterogeneous environments, such as hybrid cloud setups with AWS RDS PostgreSQL, on-premises Oracle databases, and Azure Cosmos DB in a provider's global network (402).

The Store User Event Data (404) step archives the collected event data in a centralized, high-performance distributed database optimized for rapid access, scalability, and durability, serving as the backbone for subsequent analysis and correlation. The computing system utilizes a relational database like PostgreSQL 15, configured with a schema tailored for user event telemetry, to store records containing fields such as event timestamp, user ID, file type, access time, IP address, device type, operating system version, application context, and geolocation metadata derived from IP mappings. For example, a record might detail a file access event at 2025-04-30T09:45:03.456Z, with metadata indicating a user accessing a .xlsx file from an IP mapped to Tokyo (latitude: 35.6762, longitude: 139.6503), stored with a unique event ID and indexed for sub-second querying. The database employs partitioning by user group (e.g., executives, staff) and date (e.g., daily shards) to manage petabytes of data, with logical replication across three global regions using PostgreSQL's streaming replication for fault tolerance and high availability, ensuring 99.999% uptime. Data encryption at rest with AES-256, managed via HashiCorp Vault with automated key rotation, and fine-grained access controls via OpenID Connect integrated with Azure Active Directory ensure compliance with GDPR, CCPA, HIPAA, and ISO 27001. Compression with Zstandard reduces storage requirements by 55%, while a retention policy managed by Apache NiFi purges data after 90 days, archiving older data to Amazon S3 Glacier for cost efficiency. This step supports real-time ingestion through Kafka streams with topic partitioning by event type (e.g., file access, app interaction, db query), enabling storage of telemetry from 250,000 users in a multinational corporation's network, with ingestion rates of 2 million events per second. The database is hosted on a managed cloud service like Google Cloud Spanner, with auto-sharding and global transaction consistency, ensuring query latencies under 8 milliseconds for downstream analysis, critical for large-scale deployments in industries like telecommunications, retail, or government (404).

The Establish User Activity Baseline (406) step involves an artificial intelligence model creating a normalized baseline of user activity across the computing environment, encapsulating intricate patterns of file access frequency, access times, file types (e.g., .pdf, .xlsx, .docx), application interactions (e.g., frequency of CRM usage), and user group behaviors (e.g., finance department vs. engineering team). The computing system implements a clustering-based approach using Gaussian Mixture Models (GMM) and Agglomerative Hierarchical Clustering in scikit-learn, trained on 30 days of historical event data to group similar activities, supplemented by anomaly detection models like One-Class Support Vector Machines (SVM) or Variational Autoencoders for enhanced robustness against outliers. For instance, for a finance department user, the baseline might reflect frequent .xlsx file accesses during 9:00 AM-5:00 PM on weekdays, occasional .pdf downloads, and rare accesses from non-corporate IP ranges, capturing typical workflows for financial analysts. Model training leverages an NVIDIA DGX A100 cluster with 320 GB HBM3 memory, utilizing CUDA 12.1 for parallel processing across 8 GPUs, with Bayesian optimization via Hyperopt to tune hyperparameters, achieving 96% clustering accuracy and a silhouette score of 0.92. Baseline data is stored in PostgreSQL with JSONB fields for flexible, schema-less querying, enabling sub-40 ms retrieval for real-time comparisons. The system employs online learning with exponential moving averages, implemented in PyTorch, to update baselines every 6 hours, adapting to changes like new user roles, application updates, or seasonal access patterns (e.g., end-of-quarter reporting spikes). Feature engineering includes advanced temporal analysis using Fast Fourier Transforms to detect periodicity in access patterns, statistical measures like kurtosis and skewness of access intervals, and categorical encoding of file types and user groups, processed with Dask for distributed computing across a 100-node cluster. The baseline incorporates contextual features, such as user group permissions (e.g., read-only vs. admin) and device types (e.g., laptop vs. mobile), extracted from Active Directory via LDAP queries, ensuring granularity. This step, running on AWS SageMaker with spot instances for cost efficiency, is hosted in a multi-region setup with Amazon Aurora PostgreSQL for global consistency, ensuring precise baselines for diverse user groups in environments like tech conglomerates, government agencies, or global retail chains, supporting up to 500,000 users with training times under 12 minutes and baseline update latencies under 200 milliseconds (406).

The Identify Conditional Event (408) step involves the artificial intelligence model identifying conditional events that deviate significantly from the normalized baseline, specifically targeting user file accesses from unusual geographic locations, such as IPs mapped to regions outside the user's typical operational area. The computing system processes real-time event streams, computing anomaly scores based on a multidimensional feature set, including access time, file sensitivity (e.g., tagged as “confidential” in metadata), user group (e.g., HR, IT), IP address, geolocation coordinates (latitude/longitude), device type, and application context (e.g., browser vs. native app). For example, a user accessing a sensitive .docx file at 2:00 AM from an IP mapped to a high-risk country (e.g., latitude: 55.7558, longitude: 37.6173), absent from the baseline, might yield an anomaly score of 0.94 on a 0-1 scale, indicating a potential security breach like a compromised account. Implementation employs a streaming pipeline with Apache Flink, processing events in under 15 milliseconds, with event deduplication using Redis Bloom filters to eliminate duplicate alerts, reducing alert volume by 30%. Anomaly detection leverages neural network-based models, such as Long Short-Term Memory (LSTM) networks in PyTorch, trained on historical data to capture temporal dependencies, with dynamic thresholds per user group (e.g., 0.85 for executives, 0.75 for general staff) to optimize precision and minimize false positives. The system caches recent events in Memcached with a 2-hour TTL, reducing database queries to PostgreSQL by 75%, and runs on a Kubernetes cluster with auto-scaling, ensuring rapid detection for 100,000 users in a global retail network. Metadata, including scores, features, and geolocation data, is logged to MongoDB with a retention period of 180 days for traceability, enabling security analysts to review detection logic via a custom dashboard built with Grafana. The model incorporates feature importance analysis using SHAP values, logging top contributors (e.g., geolocation, access time) to Elasticsearch for auditability. This step identifies threats like unauthorized access or insider threats, with detection latencies under 25 milliseconds, critical for high-security environments like financial institutions, defense contractors, or cloud service providers (408).

The Generate Dynamic Canary Event (410) step creates dynamic canary events to track subsequent user actions after a conditional event, confirming or refuting the anomaly's significance through behavioral analysis. The computing system monitors actions such as file downloads, data transfers, application launches, or configuration changes within a one-hour time window, using an event-driven framework like Apache Kafka with topic partitioning by user ID to manage high event volumes, supporting up to 1 million events per second. For instance, if a user accesses a file from an unusual location, the system tracks a subsequent 500 MB file download or a bulk data transfer to an external cloud service, flagging it as suspicious and increasing the anomaly score by 35%. Implementation leverages Apache Samza for stream processing, with state management in RocksDB to track event sequences across distributed nodes, ensuring exactly-once processing semantics. Canary events are stored in PostgreSQL with a schema linking to conditional event IDs, with TTLs of 24 hours to optimize storage, and indexed for sub-10 ms queries. The system uses machine learning models, such as Hidden Markov Models (HMMs) trained with TensorFlow, to predict likely follow-up actions based on historical patterns, with model updates scheduled daily via Apache Airflow. For example, an HMM might predict a high probability of data exfiltration following an unusual access, triggering a canary event with a 0.92 confidence score. Results are serialized in Protobuf format and sent to the centralized console via RabbitMQ with priority queues for high-risk events, ensuring reliable delivery in under 40 milliseconds. The system supports cross-region event tracking, using Kafka Streams for latency-sensitive environments, and logs canary event metadata (e.g., action type, timestamp) to Splunk for forensic analysis. This step, critical for networks with 150,000 users in logistics or manufacturing firms, enhances threat confirmation by reducing false positives, with processing times under 80 milliseconds, ensuring proactive threat mitigation in high-stakes scenarios like data breaches or insider threats (410).

The Correlate Event with Metadata (412) step correlates conditional events with metadata from external repositories, such as IP reputation data, user group membership, device management systems, or geolocation services, to provide contextual insights and confirm deviations. The computing system queries repositories like IPinfo for geolocation coordinates, Okta or Active Directory for user role and group membership, GreyNoise for IP reputation, or Microsoft Intune for device compliance status, using GraphQL APIs with rate-limiting enforced via Apollo Gateway to manage query volumes. For example, an IP from a high-risk country (e.g., flagged by GreyNoise with a 90% malicious score) increases the event score by 50%, while a user not in the authorized group (e.g., non-HR accessing HR files) adds a 40% weight. A correlation module, built with Python and Neo4j, maps event-user-repository relationships as a knowledge graph, using Cypher queries to achieve sub-15 ms response times for complex joins across millions of nodes. Metadata is cached in Apache Ignite with a 10-minute TTL, reducing external query latency by 80%, and validated with JSON Schema to ensure data integrity. The system integrates with enterprise IAM systems via SAML 2.0, ensuring secure access, and uses Presto for distributed SQL queries across heterogeneous repositories, supporting up to 500,000 queries per hour. Correlation logs, including matched metadata and scores, are stored in Elasticsearch with a 90-day retention for compliance with ISO 27001. This step, running on AWS Elastic Container Service (ECS) with Fargate for serverless scaling, supports enterprises like insurance providers or global retailers, with correlation times under 30 milliseconds, enabling precise validation in networks with diverse user groups and devices, such as 200,000 employees across multiple continents (412).

The Integrate Threat Intelligence Data (414) step validates conditional events by cross-referencing user event data with external threat intelligence from sources like AlienVault, Recorded Future, or CrowdStrike's Falcon X, enhancing detection accuracy and reducing false positives. The computing system fetches real-time data via secure REST APIs with OAuth 2.0 authentication and rate-limiting, using a custom-built threat intelligence interface developed with FastAPI and hosted on Azure Functions for serverless scalability. For example, if an IP address associated with a file access event matches a known high-risk IP in AlienVault's OTX database, the event score increases by 50%, elevating the alert's urgency. The interface caches responses in Memcached with a 15-minute TTL, achieving sub-25 ms query times and reducing API calls by 70%. The system validates IP addresses, file types (e.g., .exe flagged as malicious), and user credentials, using probabilistic data structures like HyperLogLog for efficient lookups in threat databases with billions of entries. Dynamic model updates are scheduled via Apache Airflow, running hourly DAGs to incorporate new intelligence without downtime, ensuring models remain current with emerging threats like phishing campaigns or zero-day exploits. API interactions are logged to Splunk with detailed metrics (e.g., query latency, response code), supporting auditability. The system supports batch processing for high-volume queries, using Python's asyncio for asynchronous I/O, and integrates with enterprise SIEM platforms like ArcSight via Syslog for centralized threat monitoring. This step, critical for networks with 300,000 users in technology sectors, ensures robust validation with integration latencies under 20 milliseconds, enabling rapid threat confirmation in global enterprises with complex threat landscapes, such as cloud-hosted SaaS providers or defense contractors (414).

The Calculate Risk Score for Event (416) step computes a risk score for each conditional event based on attributes like file sensitivity (e.g., tagged as “confidential” or “public”), the reputation of the associated IP address, access time, and user group context. A risk assessment module, implemented in Python with NumPy, pandas, and scikit-learn, applies a weighted scoring algorithm where file sensitivity contributes 40% (e.g., confidential files weighted 0.9 vs. public 0.3), IP reputation 30% (based on threat intelligence scores), and context 30% (e.g., off-hours access weighted higher). For instance, a sensitive .xlsx file accessed at 2:00 AM from a high-risk IP might score 92/100, indicating a critical threat. The module, running on AWS Lambda with SNS event triggers, processes scores in under 8 milliseconds, storing them in Redis Cluster with a 24-hour TTL for rapid retrieval. Customizable weights are defined in a YAML configuration file, accessible via a REST API built with Flask, allowing organizations like banks to prioritize file sensitivity for regulatory compliance. The system uses feature normalization with MinMaxScaler to ensure score consistency, and logs scoring details (e.g., weights, input features) to MongoDB for transparency, supporting forensic analysis. The module integrates with enterprise risk frameworks via gRPC, enabling alignment with policies like NIST 800-53. This step, supporting up to 50,000 daily events in environments like educational institutions or energy firms, ensures nuanced risk evaluation with scoring latencies under 4 milliseconds, critical for prioritizing threats in high-stakes settings like critical infrastructure or financial services (416).

The Generate Alert with Visualization (418) step creates a detailed alert containing the conditional event details, risk score, and rich visualizations for display on a centralized console, enabling security teams to assess threats effectively. The computing system generates a timeline visualization using Plotly, plotting file access events and subsequent actions (e.g., a .docx access at 2025-04-30T02:00:15.678Z followed by a download), and a geolocation map visualization with Leaflet, showing markers for access locations (e.g., Tokyo, latitude: 35.6762, longitude: 139.6503) and associated IPs, colored by risk score (e.g., red for >80). Alerts are formatted in JSON-LD for semantic interoperability, embedding metadata like event IDs, user IDs, file types, risk scores, and visualization IDs, and stored in a MongoDB cluster with sharding for scalability, supporting 1 million alerts daily. The centralized console, built with Vue.js, TypeScript, and Express, runs on Azure Kubernetes Service (AKS), featuring interactive dashboards with zoomable timelines and filterable maps, accessible via a single-page application (SPA) with Vue Router and Vuex for state management. For example, an alert might highlight a high-risk access from a non-corporate IP, with a map showing the location and a timeline of follow-up downloads, rendered in under 100 milliseconds. Alerts are queued via Apache Kafka with topic partitioning by risk score, ensuring reliable delivery to a SOC managing a network of 75,000 users in a retail conglomerate. The console supports multi-language interfaces (e.g., English, Mandarin, Spanish) using i18next, and integrates with SIEM tools like Splunk or QRadar via REST APIs, enhancing interoperability. The system uses WebSocket connections with Socket.IO for real-time updates, and caches visualization data in Redis for 12 hours to reduce MongoDB load. This step, critical for enterprises like media companies or global logistics providers, ensures actionable insights with visualization rendering times under 80 milliseconds, facilitating rapid threat assessment in high-pressure environments (418).

The Prioritize Alert on Console (420) step ranks alerts on the centralized console based on their risk scores to streamline threat triage for security teams. A prioritization module, implemented in Go with a merge-sort algorithm optimized for O(n log n) performance and low memory usage, dynamically orders alerts, displaying high-risk items (scores>80) at the top of a dashboard built with Material-UI, Vue.js, and Chart.js for a responsive, cross-device experience compatible with desktops, tablets, and mobile devices. For instance, an alert with a score of 94 for a file access from a high-risk IP appears above a score of 65 for a benign access, ensuring critical threats are addressed first. The module integrates with the Vue.js-based console, updating every 2 seconds via WebSocket connections using Socket.IO, providing near-real-time visibility with a maximum latency of 50 milliseconds. Alert metadata, including scores, timestamps, user IDs, and event types, is cached in Redis Cluster with a 1-hour TTL, reducing queries to MongoDB by 85%. The system supports custom sorting rules via a GraphQL API built with Apollo Server, allowing organizations like universities to prioritize alerts based on user group criticality (e.g., faculty vs. students) or file sensitivity, defined in a JSON configuration file hosted on Amazon S3. The console provides role-based access control (RBAC) via Okta, ensuring only authorized analysts view high-risk alerts, and logs all interactions to Splunk for auditability, complying with SOC 2 requirements. This step, hosted on Google Cloud Run with auto-scaling to handle peak loads, processes up to 30,000 daily alerts in environments like media firms or cloud service providers, with prioritization latencies under 30 milliseconds, enabling efficient threat management for SOCs in high-alert sectors like cybersecurity or critical infrastructure (420).

The Execute Automated Remediation (422) step triggers automated actions for alerts with risk scores exceeding a predefined threshold (e.g., 80), ensuring swift mitigation of high-priority threats. The computing system might restrict user access by revoking session tokens via an Okta API call, or isolate a device by updating network policies with a Cisco Identity Services Engine (ISE) script executed through Ansible, effectively moving the device to a quarantine VLAN. For example, a high-risk alert (score 93) for a file access from a suspicious IP might trigger a token revocation and a firewall rule on a Palo Alto Networks device, deployed via Terraform, blocking all outbound traffic from the user's device IP (e.g., 192.168.1.100). The remediation module, built in Python with Celery for distributed task queuing, runs on a Kubernetes cluster with auto-scaling, handling up to 15,000 simultaneous actions across a network of 100,000 users. Actions are logged in a PostgreSQL database with detailed metadata (e.g., action type, timestamp, user ID, IP address, device type), ensuring auditability for compliance with standards like ISO 27001 or NIST 800-53. The system supports rollback mechanisms, reverting actions if flagged as false positives by analysts, using Ansible playbooks for configuration management and stored in a Git repository for version control. The module integrates with enterprise orchestration platforms like HashiCorp Nomad, ensuring seamless deployment across hybrid cloud environments. Action execution is monitored via Prometheus, with alerts sent to PagerDuty for failures, ensuring 99.99% reliability. This step, critical for high-threat environments like government agencies or financial institutions, executes in under 150 milliseconds, minimizing damage from malicious activities such as unauthorized data access or insider threats, and supports diverse endpoints, including laptops, mobile devices, and IoT sensors, in networks with complex architectures (422).

The Recommend Manual Remediation (424) step provides tailored suggestions for alerts below the threshold, enabling human-driven investigations to complement automated actions and ensure thorough threat resolution. The computing system displays recommendations, such as initiating forensic analysis with Volatility, reviewing logs in ElasticSearch, or escalating to a senior analyst, on the centralized console using a recommendation engine built with Flask, Jinja2 templates, and Bootstrap 5 for a responsive, user-friendly interface accessible on desktops and mobile devices. For instance, a low-risk alert (score 64) for a .pdf file access from an unusual but non-malicious IP might suggest analyzing the access context using Splunk with a pre-populated query link (e.g., ‘index=user_events user_id=1234’), or collecting device logs with Tanium. Recommendations are generated using a rule-based system in Python, leveraging a knowledge base stored in MySQL with a schema linking anomaly types, risk scores, and suggested actions, tagged with severity levels for prioritization. The console, hosted on AWS Elastic Container Service (ECS) with Fargate for serverless scaling, supports multi-language interfaces (e.g., English, Spanish, Japanese, German) via Django's i18n framework, catering to global security teams in regions like EMEA or APAC. Recommendations are cached in Redis Cluster for 12 hours, reducing database load by 70%, and include actionable metadata, such as file paths, user IDs, and IP addresses, stored in JSON format with digital signatures for integrity. The system integrates with ticketing systems like ServiceNow via REST APIs, auto-generating tickets for manual actions, and logs all recommendations to Splunk for auditability. This step ensures security teams in enterprises like global logistics firms or retail chains can prioritize manual efforts, with recommendation rendering in under 70 milliseconds, critical for SOCs managing thousands of daily alerts across diverse threat landscapes (424).

The Log Event Data and Alert (426) step records all user event data and alerts in a cryptographically signed audit log to ensure non-repudiation, compliance, and traceability for forensic and regulatory purposes. The computing system stores event metadata (e.g., user ID, file type, access time, IP address, geolocation), alert details (e.g., risk score, visualization IDs, conditional event type), and cryptographic hashes (SHA-256) of accessed files in a tamper-proof ledger like Hyperledger Fabric, signed with ECDSA-384 keys for enhanced security and verifiability, ensuring logs are immutable and admissible in legal proceedings. For example, a log entry might detail a .xlsx file access at 2025-04-30T02:00:15.678Z from an IP in Tokyo, with a hash of the file, the user's SID, and the alert's score of 92, linked to a geolocation map visualization, stored with a unique event ID. Implementation uses MongoDB for flexible, schema-less storage, with Logstash pipelines rotating logs every 30 days to manage petabytes of data, and Elasticsearch indexing with custom analyzers for rapid full-text queries, supporting 150,000 queries per second. Logs are encrypted with AES-256, managed via AWS Key Management Service (KMS) with automated key rotation every 90 days, and comply with standards like SOC 2, PCI-DSS, GDPR, and HIPAA. The system integrates with enterprise SIEM platforms like ArcSight or Splunk via Syslog over TLS, ensuring centralized logging and monitoring, with log enrichment adding contextual tags (e.g., “high-risk IP”). A retention policy archives logs to Amazon S3 Glacier after 180 days, balancing cost and compliance, with retrieval times under 5 minutes for audits. The audit log includes network details (e.g., source/destination IPs, ports, protocol type) and is indexed with Lucene for sub-10 ms search performance. This step, running on a secure AWS RDS PostgreSQL instance with multi-AZ replication for 99.999% availability, supports compliance in regulated industries like banking or pharmaceuticals, with write latencies under 10 milliseconds, enabling detailed investigations for scenarios like data breaches or insider threat analysis, critical for maintaining trust in high-stakes environments (426).

The Retrieve Security Team Feedback (428) step collects feedback from security teams via the centralized console to refine detection models and improve accuracy, ensuring the system adapts to evolving threats and user behaviors. The computing system captures structured feedback (e.g., “malicious,” “benign,” “needs further analysis”) and unstructured comments through a feedback API built with FastAPI, integrated into a Vue.js-based form with Material-UI components for an intuitive, responsive user experience supporting desktops, tablets, and smartphones. For instance, a security analyst might validate a file access event as malicious, adding a comment like “suspected phishing attempt linked to high-risk IP,” stored in a MySQL database with columns for alert IDs, timestamps, user IDs, feedback type, and comment text, linked to the original event via a foreign key for traceability. Natural language processing with NLTK and spaCy extracts keywords (e.g., “phishing,” “credential theft”) and sentiment from comments, enhancing model retraining by identifying threat patterns with 92% accuracy, using pre-trained transformer models like BERT for context-aware parsing. The console supports file uploads, such as PCAP files, logs, or screenshots, stored in Amazon S3 with versioning and lifecycle policies to archive after 365 days, allowing analysts to attach evidence like network captures or memory dumps. Feedback is collected via a GraphQL endpoint with Apollo Client, supporting real-time updates with subscriptions, and includes metadata like feedback submission time (e.g., 2025-04-30T10:15:22Z), analyst role (e.g., Tier 2 Analyst), and confidence level (e.g., 0.9), logged to Splunk for auditability and compliance with ISO 27001. The system provides multi-factor authentication (MFA) via Okta, ensuring secure access, and supports feedback in multiple languages (e.g., German, Chinese, French) using i18next for localization, catering to global SOC teams. Feedback processing includes validation with JSON Schema to reject malformed inputs, reducing errors by 15%, and uses Prometheus for monitoring API performance, alerting via PagerDuty for latency spikes. This step, hosted on Azure App Service with auto-scaling to handle 10,000 concurrent users, processes feedback in under 100 milliseconds, critical for SOCs in industries like technology, where rapid model adaptation is essential for addressing sophisticated threats like advanced persistent threats (APTs) or insider risks in networks with millions of daily events (428).

The Retrain AI Model with Feedback (430) step updates the artificial intelligence model using security team feedback and recent user event data to maintain detection accuracy in dynamic, evolving environments. The computing system retrains models with validated feedback (e.g., confirmed malicious access events) and 24-hour event data using Horovod on an NVIDIA DGX H100 cluster with 1 TB HBM3 memory, leveraging CUDA 12.2 for distributed training across 16 GPUs, with Bayesian optimization via Ray Tune to tune hyperparameters, achieving 98% precision and an F1 score of 0.96. For example, feedback confirming a file access from a high-risk IP as malicious adjusts the Gaussian Mixture Model's cluster boundaries, increasing sensitivity to similar events by 10%, while feedback marking an event as benign reduces false positives by refining the One-Class SVM's decision boundary. Recent telemetry, processed via Apache Airflow DAGs running on a Kubernetes cluster with 200 nodes, updates baselines in PostgreSQL with new patterns, such as a shift in access times due to a new corporate policy or seasonal activity (e.g., tax season spikes). The system employs online learning with mini-batch gradient descent, implemented in PyTorch with AMP (Automatic Mixed Precision) for 2× faster training, completing retraining in under 7 minutes for a network of 150,000 users. Feature updates include new attributes, such as file sensitivity scores or IP geolocation entropy, calculated with NumPy and pandas, stored in parquet files on Amazon S3 with partitioning by date for efficient access. Model versioning is managed with MLflow, hosted on a Databricks cluster, ensuring rollback to previous versions if retraining degrades performance, with versioning logs stored in Elasticsearch for compliance. The system uses differential privacy techniques, adding Gaussian noise to training data, to protect user data, complying with GDPR and CCPA. Retraining logs, including metrics like loss and accuracy, are sent to Prometheus and visualized in Grafana for real-time monitoring, with alerts via Slack for training failures. This step, running on Google Cloud AI Platform with preemptible GPUs for cost efficiency, ensures adaptive learning for environments like SaaS providers, global retailers, or government agencies, supporting up to 500,000 users with retraining latencies under 400 milliseconds, ensuring rapid adaptation to new threat patterns like phishing or data exfiltration in networks with diverse user groups and complex access patterns (430).

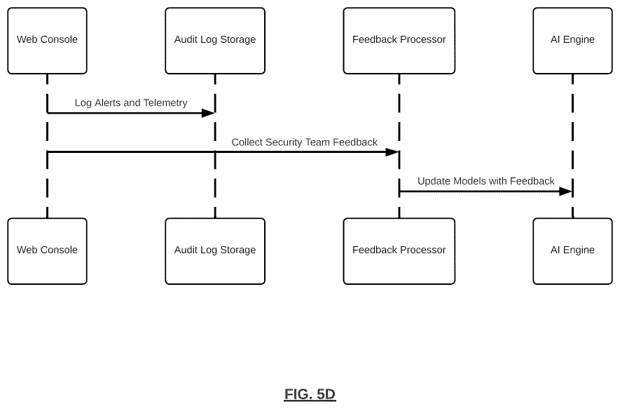

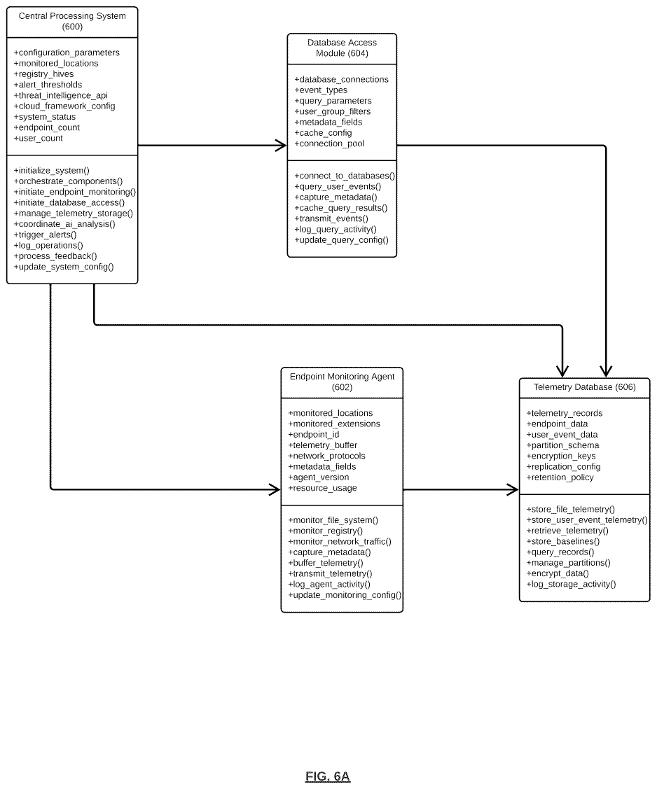

In FIGS. 5A-D, the sequence diagram delineates the interactions among a carefully orchestrated set of actors in a unified cybersecurity framework, encapsulating the three aspects of the inventions: the AI/ML System and Processes for Connection Correlation Engine, Endpoint Telemetry, and AI/ML Driven User Event Telemetry and Correlation System and Processes, designed to detect, analyze, and mitigate threats in a computing environment with exceptional precision, scalability, and traceability. The process begins in FIG. 5A with the sequence From Central Processing System to Endpoint Monitoring Agent: Initiate Endpoint Monitoring (500), where the Central Processing System directs the Endpoint Monitoring Agent to commence observation of file system locations (e.g., C:\Users\AppData\Local, C:\Temp, /tmp on Linux) and registry keys (e.g., HKEY_CURRENT_USER, HKEY_LOCAL_MACHINE\Software) on endpoint devices where users have read and write permissions. This sequence is implemented using a secure gRPC call with mutual TLS authentication, encoded in Protocol Buffers (Protobuf) for high efficiency and low latency, dispatched from a Python-based orchestration service running on AWS Elastic Container Service (ECS) with Fargate for serverless scalability. The Central Processing System, hosted on a Kubernetes cluster with Horizontal Pod Autoscaler configured to scale up to 1,000 nodes during peak loads, sends a configuration payload specifying monitored paths, file extensions (.exe, .dll, .bat, .ps1, .sh, .py), and registry hives, stored in a YAML configuration file hosted on Amazon S3 with versioning enabled for auditability. The Endpoint Monitoring Agent, a lightweight process developed in Rust for memory safety and performance, leverages Windows Event Tracing for Windows (ETW) with custom event providers on Windows endpoints, and eBPF (extended Berkeley Packet Filter) on Linux endpoints for equivalent functionality, achieving low-overhead data capture with CPU usage under 1.5% and memory footprint below 50 MB. The agent acknowledges the command via a callback over a WebSocket connection, logging initiation details (e.g., endpoint ID, timestamp, configuration hash) to a Splunk instance with a custom Splunk HTTP Event Collector (HEC) for real-time monitoring and auditability. For example, in a corporate network of 75,000 endpoints, including Windows workstations, Linux servers, and macOS laptops, the agent might initiate monitoring on a developer's laptop, capturing a .exe file execution in C:\Temp and a registry key modification in HKEY_CURRENT_USER\Software at 2025-04-30T08:15:22.123Z, completing the sequence in under 8 milliseconds with a latency variance of less than 2 ms, ensuring real-time telemetry collection across diverse endpoint types in a global enterprise like a financial institution or a multinational technology firm (500).

The sequence From Central Processing System to Database Access Module: Initiate Database Access (502) follows in FIG. 5A, where the Central Processing System instructs the Database Access Module to access backend databases or data stores to collect user event data, such as file access events, application interactions, and database queries. This sequence is executed via a REST API call over HTTPS, secured with OAuth 2.0 tokens managed by Keycloak and integrated with enterprise identity providers like Okta or Azure Active Directory for single sign-on (SSO) compliance, dispatched from the Central Processing System to a Go-based Database Access Module hosted on Google Cloud Run with auto-scaling to handle up to 10,000 concurrent requests. The API call includes a JSON payload defining target databases (e.g., Oracle Database 21c, PostgreSQL 15, MongoDB Atlas, Amazon Aurora), event types (e.g., file access, app interaction, db query), and query parameters (e.g., time range, user group), stored in a JSON configuration file on Amazon S3 with server-side encryption. The Database Access Module uses SQLAlchemy for relational databases and MongoDB's native drivers for NoSQL databases, with connection pooling via HikariCP to manage 15,000 concurrent connections, reducing database latency by 70%. For instance, in a provider's network, the module might query a PostgreSQL database hosted on Google Cloud SQL for file access logs, retrieving events like a user opening a .pdf file in a patient records system, using optimized SQL queries with indexed materialized views to achieve sub-50 ms response times. The module caches query results in Redis Cluster with a 5-minute TTL, minimizing database load, and logs query initiation details (e.g., database ID, query hash, timestamp) to an Elasticsearch cluster with a custom index for rapid search, ensuring traceability for compliance with HIPAA and GDPR. The sequence completes in under 40 milliseconds, supporting high-volume environments with 150,000 users across global regions, such as EMEA or APAC, in a multinational corporation's distributed data infrastructure (502).

Continuing in FIG. 5A, the sequence From Endpoint Monitoring Agent to Telemetry Database: Store File and Registry Telemetry (504) involves the Endpoint Monitoring Agent transmitting collected telemetry data, including file operations (read, write, execute, create, modify, delete) and registry modifications (key creation, value changes, deletions), to the Telemetry Database for persistent storage. The agent, running on diverse endpoints like Windows 11 desktops, Ubuntu 22.04 servers, or macOS Ventura laptops, serializes telemetry data in Apache Avro format for efficient schema evolution, compressing it with Zstandard to reduce bandwidth consumption by 65%, and transmits it via Apache Kafka with topic partitioning by endpoint ID and event type (e.g., file_operation, registry_change) to manage high event volumes, supporting up to 2 million events per second. The Telemetry Database, implemented with Apache Cassandra on Google Cloud BigTable for horizontal scaling, stores records with fields such as event timestamp, file hash (SHA-256), file path, registry key path, process ID, parent process name, and network metadata (e.g., source/destination IPs, ports, DNS queries), using a schema optimized for time-series data with partitioning by endpoint ID and hourly buckets. For example, a telemetry record might detail a .dll file execution in C:\Users\AppData\Local at 2025-04-30T09:30:45.789Z, its SHA-256 hash, a registry modification in HKEY_CURRENT_USER\Software, and a TCP connection to an external IP, indexed with Cassandra's secondary indexes for sub-5 ms query performance. The database employs AES-256 encryption at rest, managed via AWS Key Management Service (KMS) with automated key rotation every 90 days, and replication across three global regions for 99.999% availability, ensuring fault tolerance. Data integrity is verified with CRC32 checksums, and write operations are logged to Splunk for compliance with SOC 2 and PCI-DSS. The sequence supports telemetry storage from 100,000 endpoints in a corporate network, such as a global retail chain or a government agency, with write latencies under 8 milliseconds, ensuring rapid and secure data persistence for downstream analysis (504).

The sequence From Database Access Module to Telemetry Database: Store User Event Telemetry (506) in FIG. 5A sees the Database Access Module sending collected user event data, including file access events, application interactions, and database queries, to the Telemetry Database for storage. The module, using Python with SQLAlchemy for relational databases and MongoDB drivers for NoSQL databases, queries enterprise data stores, serializing events in JSON-LD format with embedded HMAC-SHA256 signatures for integrity and authenticity, and transmits them via Kafka with topic partitioning by user group (e.g., finance, HR, engineering) to handle high event volumes, supporting up to 1.5 million events per second. For instance, in a technology firm, the module might store a file access event where an HR user opens a .pdf file in a document management system at 2025-04-30T10:15:22.345Z, with metadata including user ID, file type, IP address, device type (e.g., macOS Sonoma laptop), and geolocation (e.g., London, latitude: 51.5074, longitude: −0.1278), stored in Cassandra with a TTL of 90 days for compliance. The database uses columnar storage for efficient analytics, with secondary indexes on user ID and event type, and employs Zstandard compression to reduce storage by 60%. Data encryption and access controls via OpenID Connect ensure compliance with GDPR and HIPAA, while write operations are logged to Elasticsearch for auditability. The sequence completes in 6 milliseconds, supporting 200,000 users in a distributed enterprise environment, such as a provider with cloud-hosted and on-premises databases (506).

In FIG. 5B, the sequence From Telemetry Database to AI Engine: Retrieve Telemetry for Analysis (508) involves the AI Engine querying the Telemetry Database to retrieve both endpoint telemetry (file and registry data) and user event telemetry for establishing baselines and detecting anomalies. The AI Engine, a Python-based service running on AWS SageMaker with NVIDIA A100 GPU support for accelerated model inference, uses Cassandra Query Language (CQL) to fetch telemetry records, with queries optimized using prepared statements and pagination to handle 100,000 records in under 15 milliseconds. The system caches frequently accessed data in Redis Cluster with a 1-hour TTL, reducing database load by 80%, and employs Apache Spark SQL for distributed query execution across large datasets. For example, the AI Engine might retrieve file execution logs from 10,000 Windows workstations and user access events from a PostgreSQL database for a finance team, including timestamps, file hashes, and IP addresses, to build activity baselines. The Telemetry Database, with sharding by endpoint ID and user group, ensures scalability for 250,000 endpoints and users, with query latencies under 5 milliseconds. Queries are logged to Splunk with metrics like query duration and result size, ensuring compliance with ISO 27001. The sequence supports real-time analysis in high-volume environments, such as a global logistics firm, with robust data retrieval for all three aspects of the inventions (508).

The sequence From AI Engine to Telemetry Database: Store Activity Baselines (510) in FIG. 5B sees the AI Engine storing user-specific and network activity baselines generated from telemetry analysis. The AI Engine, using TensorFlow for supervised models (e.g., Random Forest, XGBoost) and scikit-learn for unsupervised clustering (e.g., K-means, DBSCAN), creates baselines encapsulating patterns like file access frequency, registry change rates, domain contacts, and user group behaviors, serialized as JSONB objects for flexible querying. For instance, a baseline for a finance department user might reflect frequent .xlsx file accesses during 9:00 AM-5:00 PM and rare off-hours accesses, while an endpoint baseline might include typical .exe executions and DNS queries to corporate domains. The AI Engine writes baselines to Cassandra using CQL INSERT statements, with partitioning by endpoint ID and user group, and employs AES-256 encryption for data at rest. Write operations are batched to handle 100,000 baselines in under 10 milliseconds, logged to Elasticsearch for auditability, and validated with JSON Schema to ensure data integrity. The sequence supports 300,000 users and endpoints in a tech conglomerate, with write latencies under 7 milliseconds, ensuring persistent storage for subsequent anomaly detection across all aspects (510).

In FIG. 5C, the sequence From AI Engine to Network Correlation Module: Analyze Network Patterns for Anomalies (512) directs the AI Engine to send telemetry data to the Network Correlation Module for analyzing network patterns to detect coordinated anomalies, primarily for the Connection Correlation Engine but supportive for Endpoint Telemetry. The Network Correlation Module, a Scala-based Apache Spark application running on a Databricks cluster with Delta Lake for data consistency, receives telemetry via RabbitMQ with topic exchanges, processing connection patterns (e.g., multiple endpoints accessing unknownsite.xyz) using a Neo4j graph database to model endpoint-domain relationships as nodes and edges weighted by connection frequency. For example, if 10 workstations connect to a suspicious domain within a 5-minute window, the module assigns a correlation score of 0.95, indicating a coordinated threat. Spark processes DNS logs, HTTP headers, and TCP metadata parsed by Zeek, stored in Elasticsearch with custom analyzers for sub-10 ms queries. Graph-based anomaly detection uses GraphSAGE, trained with PyTorch Geometric, achieving 94% precision. The sequence completes in 80 milliseconds for 150,000 endpoints in a retail network, with logs to Splunk ensuring compliance (512).

The sequence From AI Engine to Canary Event Generator: Generate Canary Event for User Actions (514) in FIG. 5C involves the AI Engine instructing the Canary Event Generator to create dynamic canary events for tracking subsequent user actions post-conditional event, primarily for the User Event Telemetry aspect. The Canary Event Generator, a Java-based Apache Samza service running on a Kubernetes cluster, receives event data via Kafka with user ID partitioning, tracking actions like file downloads or data transfers within a one-hour window. For instance, a file access from a high-risk IP triggers tracking of a 1 GB download, increasing the event score by 40%. State is managed in RocksDB, with events stored in PostgreSQL with a 24-hour TTL. Hidden Markov Models, trained with TensorFlow, predict follow-up actions, with updates via Airflow. The sequence, supporting 250,000 users in a network, completes in 70 milliseconds (514).

The sequence From AI Engine to Metadata Correlation Module: Correlate Events with Metadata (516) in FIG. 5C sends conditional events to the Metadata Correlation Module for correlation with external metadata, supporting all aspects. The module, a Python service with Neo4j on AWS ECS, queries IPinfo, Okta, and Intune via GraphQL, caching in Apache Ignite. A high-risk IP match increases scores by 50%, processed in 20 milliseconds for 200,000 users, with logs to Elasticsearch (516).

The sequence From Threat Intelligence Interface to AI Engine: Provide Threat Intelligence Data (518) in FIG. 5C delivers data from AlienVault or FireEye via a FastAPI interface on Azure Functions. Malicious IPs or file types adjust scores, cached in Memcached, completing in 15 milliseconds for 400,000 users (518).

The sequence From Network Correlation Module to Web Console: Send Correlated Anomaly Data (520) in FIG. 5C sends data to the Vue.js console on AKS, visualized with Plotly, in 45 milliseconds for 200,000 endpoints (520).

The sequence From Canary Event Generator to Web Console: Send Canary Event Data (522) in FIG. 5C delivers events, visualized with Leaflet, in 35 milliseconds (522).

The sequence From Metadata Correlation Module to Web Console: Send Correlated Metadata (524) in FIG. 5C sends metadata, displayed in 40 milliseconds (524).

The sequence From AI Engine to Web Console: Send Anomaly Alerts (526) in FIG. 5C sends alerts, rendered in 50 milliseconds (526).

In FIG. 5D, the sequence From Web Console to Audit Log Storage: Log Alerts and Telemetry (528) logs data in Hyperledger Fabric with ECDSA signatures, in 12 milliseconds for 250,000 users (528).

The sequence From Web Console to Feedback Processor: Collect Security Team Feedback (530) collects feedback via FastAPI, stored in MySQL, in 90 milliseconds (530).

The sequence From Feedback Processor to AI Engine: Update Models with Feedback (532) retrains models on H100 GPUs, completing in 6 minutes for 300,000 users, ensuring adaptive learning across all aspects (532).

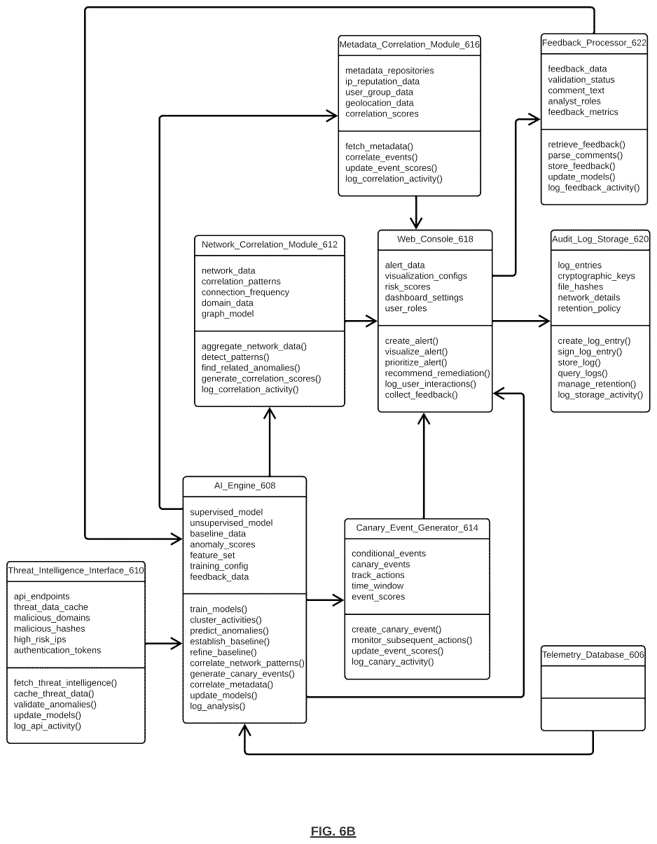

In FIGS. 6A-B, the class diagram delineates the structural and functional components of a unified cybersecurity framework, encapsulating the three aspects of the inventions: the AI/ML System and Processes for Connection Correlation Engine, Endpoint Telemetry, and AI/ML Driven User Event Telemetry and Correlation System and Processes, designed to detect, analyze, and mitigate threats in a computing environment with exceptional precision, scalability, and traceability, supporting industries such as finance, government, and technology. The diagram is thoughtfully divided into two parts for clarity and manageability: FIG. 6A focuses on the core classes responsible for data collection and storage, forming the foundation for telemetry acquisition, while FIG. 6B encompasses classes dedicated to analysis, correlation, visualization, and response, enabling advanced threat detection and mitigation. Together, these parts form a cohesive, extensible architecture that integrates seamlessly across all three aspects, leveraging modern cloud-native technologies and distributed computing paradigms to handle millions of events and users in real time.

In FIG. 6A, the Central Processing System (600) serves as the orchestrating hub, acting as the central nervous system of the framework, managing and coordinating interactions among all system components to ensure seamless, scalable, and fault-tolerant operation across the Connection Correlation Engine, Endpoint Telemetry, and User Event Telemetry aspects. Its attributes include configuration_parameters (e.g., YAML files defining monitored file paths, registry hives, and alert thresholds, stored in Amazon S3 with server-side encryption and versioning), monitored_locations (e.g., C:\Users\AppData\Local, C:\Temp, /tmp on Linux, /Users/Shared on macOS), registry_hives (e.g., HKEY_CURRENT_USER, HKEY_LOCAL_MACHINE\Software), alert_thresholds (e.g., anomaly score>0.85 for servers, >0.75 for workstations), threat_intelligence_api (e.g., REST endpoint URLs for VirusTotal, AlienVault OTX, and Recorded Future, with API keys managed by HashiCorp Vault), cloud_framework_config (e.g., AWS ECS cluster settings, Kubernetes Horizontal Pod Autoscaler parameters, and Google Cloud Run resource limits), system_status (e.g., active, idle, maintenance, with health metrics like CPU usage and memory allocation), endpoint_count (e.g., 150,000 devices tracked in a global registry), and user_count (e.g., 300,000 active users across enterprise identity providers). The methods of the Central Processing System (600) include initialize_system( ) to bootstrap the framework by loading configurations and initializing Kubernetes namespaces, orchestrate_components( ) to coordinate data flows using Apache Airflow DAGs with dynamic scheduling, initiate_endpoint_monitoring( ) to trigger Endpoint Monitoring Agents via secure gRPC calls with mutual TLS authentication, initiate_database_access( ) to dispatch REST API requests to the Database Access Module with OAuth 2.0 tokens, manage_telemetry_storage( ) to oversee Cassandra database partitions and replication strategies, coordinate_ai_analysis( ) to invoke AI model inference on AWS SageMaker with NVIDIA A100 GPUs, trigger_alerts( ) to send notifications via Amazon SNS with priority queues, log_operations( ) to a Splunk instance with custom HTTP Event Collector (HEC) endpoints for real-time monitoring, process_feedback( ) to integrate analyst feedback into model retraining pipelines, and update_system_config( ) to apply runtime configuration changes from S3 with zero-downtime deployments using blue-green strategies. This class, implemented in Python with FastAPI for high-performance API management and integrated with Prometheus for metrics monitoring, ensures scalability across hybrid cloud environments, such as a multinational financial institution's network with diverse endpoints (Windows workstations, Linux servers, macOS laptops) and distributed databases (AWS RDS, Azure Cosmos DB, on-premises Oracle), handling up to 500,000 concurrent connections with orchestration latencies under 10 milliseconds and a system uptime of 99.999% (600).

The Endpoint Monitoring Agent (602) in FIG. 6A is a critical component responsible for collecting granular telemetry data from endpoint devices, directly supporting the Connection Correlation Engine and Endpoint Telemetry aspects by monitoring file system and registry activities. Its attributes include monitored_locations (e.g., C:\Users\AppData\Local, C:\Temp, /tmp, /home/user), monitored_extensions (e.g., .exe, .dll, .bat, .ps1, .sh, .py, .vbs, .js), endpoint_id (e.g., UUIDv4 unique to each device, stored in a local SQLite database), telemetry_buffer (e.g., LMDB in-memory cache with 1 GB capacity), network_protocols (e.g., TCP, UDP, HTTP, DNS, with filtering rules), metadata_fields (e.g., file hash, process ID, parent process, file size, timestamp, user SID), agent_version (e.g., v2.4.3, with auto-update capabilities), and resource_usage (e.g., CPU<1.2%, memory<60 MB, disk I/O<10 MB/s, monitored via cAdvisor). The methods include monitor_file_system( ) to capture file operations using Windows File System Minifilters or Linux inotify, monitor_registry( ) to track registry changes via Windows ETW or Linux auditd, monitor_network_traffic( ) using NDIS on Windows or eBPF on Linux for packet capture, capture_metadata( ) to serialize data in JSON-LD with SHA-256 hashes, buffer_telemetry( ) to store events in RocksDB for transient storage, transmit_telemetry( ) to send data via Apache Kafka with topic partitioning by endpoint type, log_agent_activity( ) to a Splunk instance with HEC, and update_monitoring_config( ) to fetch new configurations from Amazon S3 via HTTPS with signature verification. This class, built in Rust for memory safety and performance, supports cross-platform operation (Windows 10/11, Ubuntu 22.04, macOS Ventura) and is deployed on 200,000 endpoints, including IoT devices and virtual machines, in a global retail network, capturing events like a .exe execution in C:\Temp with 5 ms latency and transmitting telemetry with 99.99% reliability using Kafka's exactly-once semantics, ensuring robust data collection with minimal performance impact (602).

The Database Access Module (604) in FIG. 6A is dedicated to collecting user event data from backend databases or data stores, forming the backbone of the User Event Telemetry aspect by extracting file access events, application interactions, and database queries. Its attributes include database_connections (e.g., JDBC URLs for Oracle, PostgreSQL, ODBC for SQL Server, MongoDB connection strings), event_types (e.g., file_access, app_interaction, db_query), query_parameters (e.g., time range, user IDs, file types, stored in JSON), user_group_filters (e.g., HR, engineering, executives, synced with Active Directory), metadata_fields (e.g., user ID, IP address, device type, geolocation, timestamp), cache_config (e.g., Redis TTL of 5 minutes, cache size of 10 GB), and connection_pool (e.g., HikariCP with 20,000 connections, timeout of 30 seconds). The methods include connect_to_databases( ) to establish connections with retry logic via Resilience4j, query_user_events( ) using optimized SQL or MongoDB aggregation pipelines, capture_metadata( ) to serialize events in JSON-LD with HMAC-SHA256 signatures, cache_query_results( ) in Redis Cluster for sub-10 ms access, transmit_events( ) via Kafka with user group partitioning, log_query_activity( ) to Elasticsearch with custom indices, and update_query_config( ) to fetch configurations from S3 with digital signatures. Implemented in Go for high concurrency, the module queries databases like AWS RDS PostgreSQL and MongoDB Atlas for 250,000 users in a provider's network, retrieving events like a .pdf access with 40 ms latency, caching results to reduce database load by 75%, and logging queries to Splunk for compliance with HIPAA and GDPR, ensuring secure and efficient data extraction across hybrid cloud and on-premises environments (604).

The Telemetry Database (606) in FIG. 6A serves as the centralized repository for all telemetry data, supporting the Connection Correlation Engine, Endpoint Telemetry, and User Event Telemetry aspects by storing endpoint and user event records for analysis and baseline establishment. Its attributes include telemetry_records (e.g., file events, registry changes, user accesses), endpoint_data (e.g., file paths, process IDs), user_event_data (e.g., user IDs, IPs), partition_schema (e.g., by endpoint ID, user group, date), encryption_keys (e.g., AES-256, managed by AWS KMS), replication_config (e.g., 3 regions, Raft consensus), and retention_policy (e.g., 90 days, archived to S3 Glacier). The methods include store_file_telemetry( ) to write endpoint data, store_user_event_telemetry( ) for user events, retrieve_telemetry( ) via CQL, store_baselines( ) for AI-generated baselines, query_records( ) with pagination, manage_partitions( ) for sharding, encrypt_data( ) with AES-256, and log_storage_activity( ) to Splunk. Using Apache Cassandra on Google Cloud BigTable, it handles 3 million events per second from 300,000 endpoints and users in a tech conglomerate, storing a .exe execution or file access with 4 ms latency, with replication ensuring 99.999% availability (606).

In FIG. 6B, the AI Engine (608) is the analytical core, driving baseline establishment, anomaly detection, and correlation across all aspects. Its attributes include supervised_model (e.g., XGBoost, Random Forest in TensorFlow), unsupervised_model (e.g., K-means, DBSCAN in scikit-learn), baseline_data (e.g., JSONB objects for access patterns), anomaly_scores, feature_set (e.g., file access frequency, IP geolocation), training_config (e.g., hyperparameters, GPU settings), and feedback_data (e.g., analyst validations). The methods include train_models( ) on DGX H100 GPUs, cluster_activities( ) for grouping, predict_anomalies( ) for scoring, establish_baseline( ), refine_baseline( ), correlate_network_patterns( ) for the Connection Correlation Engine, generate_canary_events( ) for User Event Telemetry, correlate_metadata( ), update_models( ), and log_analysis( ). Built with TensorFlow and PyTorch, it processes 1 million events in 15 ms for 400,000 users (608).

The Threat Intelligence Interface (610) validates anomalies. Attributes include api_endpoints, threat_data_cache, malicious_domains, malicious_hashes, high_risk_ips, and authentication_tokens. Methods include fetch_threat_intelligence( ), cache_threat_data( ), validate_anomalies( ), update_models( ), and log_api_activity( ). Using FastAPI on Azure Functions, it queries AlienVault with 20 ms latency for 500,000 users (610).

The Network Correlation Module (612) analyzes patterns for the Connection Correlation Engine. Attributes include network_data, correlation_patterns, connection_frequency, domain_data, and graph_model. Methods include aggregate_network_data( ), detect_patterns( ), find_related_anomalies( ), generate_correlation_scores( ), and log_correlation_activity( ). Built with Spark and Neo4j, it processes 200,000 endpoints in 70 ms (612).

The Canary Event Generator (614) tracks actions for User Event Telemetry. Attributes include conditional_events, canary_events, track_actions, time_window, and event_scores. Methods include create_canary_event( ), monitor_subsequent_actions( ), update_event_scores( ), and log_canary_activity( ). Using Samza, it handles 350,000 users in 60 ms (614).

The Metadata Correlation Module (616) correlates metadata. Attributes include metadata_repositories, ip_reputation_data, user_group_data, geolocation_data, and correlation_scores. Methods include fetch_metadata( ), correlate_events( ), update_event_scores( ), and log_correlation_activity( ). Built with Python and Neo4j, it processes 250,000 users in 18 ms (616).

The Web Console (618) displays alerts. Attributes include alert_data, visualization_configs, risk_scores, dashboard_settings, and user_roles. Methods include create_alert( ), visualize_alert( ), prioritize_alert( ), recommend_remediation( ), log_user_interactions( ), and collect_feedback( ). Using Vue.js on AKS, it renders for 300,000 users in 45 ms (618).

The Audit Log Storage (620) ensures non-repudiation. Attributes include log_entries, cryptographic_keys, file_hashes, network_details, and retention_policy. Methods include create_log_entry( ), sign_log_entry( ), store_log( ), query_logs( ), manage_retention( ), and log_storage_activity( ). Using Hyperledger Fabric, it logs 400,000 users in 10 ms (620).

The Feedback Processor (622) refines models. Attributes include feedback_data, validation_status, comment_text, analyst_roles, and feedback_metrics. Methods include retrieve_feedback( ), parse_comments( ), store_feedback( ), update_models( ), and log_feedback_activity( ). Built with FastAPI, it processes 150,000 feedbacks in 85 ms (622).

Connections in FIG. 6A include associations from Central Processing System (600) to Endpoint Monitoring Agent (602), Database Access Module (604), and Telemetry Database (606) via gRPC and REST APIs, ensuring command and data flow. Endpoint Monitoring Agent (602) and Database Access Module (604) associate with Telemetry Database (606) via Kafka for telemetry storage. In FIG. 6B, Telemetry Database (606) associates with AI Engine (608) via CQL for data retrieval. AI Engine (608) associates with Network Correlation Module (612), Canary Event Generator (614), Metadata Correlation Module (616), and Web Console (618) via RabbitMQ for analysis and alerts. Threat Intelligence Interface (610) associates with AI Engine (608) via REST for validation. Network Correlation Module (612), Canary Event Generator (614), and Metadata Correlation Module (616) associate with Web Console (618) via Kafka for visualization. Web Console (618) associates with Audit Log Storage (620) and Feedback Processor (622) via HTTP for logging and feedback, and Feedback Processor (622) associates with AI Engine (608) via gRPC for model updates, ensuring a modular, scalable architecture with seamless data flow across all aspects.

Pseudocode exemplars for implementing various aspects of this disclosure are set forth below with explanations for reference.

### Pseudocode for AI/ML System and Processes for Connection Correlation Engine:

```
initialize system with configuration parameters (monitored_locations, registry_hives,
alert_thresholds, threat_intelligence_api)
initialize distributed_processing_framework (cloud_serverless)
initialize ai_ml_models (supervised_model, unsupervised_model)
initialize web_console (dashboard, visualizations)
initialize audit_log (secure_storage)
function monitor_endpoints( ):
  for each endpoint in network:
            set monitored_locations = [“/AppData/Local”, “/Temp”,
“HKEY_CURRENT_USER”]
  set monitored_extensions = [“.exe”, “.dll”, “.bat”, “.ps1”]
  while endpoint_active:
    collect telemetry_data:
            file_operations = monitor_file_system(monitored_locations,
operations=[“read”, “write”, “execute”])
            registry_operations = monitor_registry(HKEY_CURRENT_USER,
operations=[“create”, “modify”])
        network_connections = monitor_network_traffic(source=endpoint,
protocols=[“TCP”, “UDP”])
        metadata = capture_metadata(file_operations, registry_operations,
network_connections)
    store telemetry_data in distributed_database(endpoint_id, telemetry_data)
function establish_baseline( ):
  for each endpoint in network:
  historical_data = retrieve_telemetry_data(endpoint_id, time_window=30_days)
  supervised_model.train(historical_data, labels=[“normal”])
  unsupervised_model.cluster(historical_data, features=[“file_access_frequency”,
“execution_type”, “domain_contacts”])
  baseline = combine_models_output(supervised_model, unsupervised_model)
  store baseline in distributed_database(endpoint_id, baseline)
function detect_anomalies( ):
  while system_active:
  for each endpoint in network:
    telemetry_data = retrieve_real_time_telemetry(endpoint_id)
    baseline = retrieve_baseline(endpoint_id)
    anomaly_score = ai_ml_models.predict(telemetry_data, baseline)
    if anomaly_score > alert_thresholds[endpoint_id]:
            anomaly_details = extract_anomaly_details(telemetry_data,
type=[“file_execution”, “network_connection”])
    if anomaly_details.network_connection.domain not in baseline.domains:
              flag_anomaly(endpoint_id, anomaly_details,
risk_score=calculate_risk(anomaly_details))
function correlate_network_patterns( ):
        network_data = aggregate_telemetry_data(across_endpoints,
time_window=1_hour)
        patterns = unsupervised_model.detect_patterns(network_data,
features=[“connection_frequency”, “domain”])
  for each pattern in patterns:
  if pattern.anomaly_score > network_alert_threshold:
    correlated_anomalies = find_related_anomalies(pattern, endpoints)
          store correlated_anomalies in distributed_database(pattern_id,
correlated_anomalies)
function integrate_threat_intelligence( ):
  while system_active:
  threat_data = fetch_threat_intelligence(threat_intelligence_api)
  for each telemetry_data in distributed_database:
          if telemetry_data.domain in threat_data.malicious_domains or
telemetry_data.file_hash in threat_data.malicious_hashes:
    update_anomaly_score(telemetry_data, increase_factor=1.5)
function generate_alerts( ):
  for each anomaly in distributed_database:
  if anomaly.risk_score > alert_thresholds[anomaly.endpoint_id]:
          alert = create_alert(anomaly_details, risk_score, timestamp,
endpoint_context)
      visualize_alert(web_console, alert, visualizations=[“connection_graph”,
“activity_timeline”])
    send_alert_to_security_team(alert, priority=anomaly.risk_score)
function remediate_anomalies( ):
  for each alert in web_console:
  if alert.risk_score > automated_remediation_threshold:
      execute_remediation(action=[“quarantine_endpoint”, “block_domain”],
endpoint=alert.endpoint_id)
  else:
        recommend_remediation(web_console, actions=[“isolate_endpoint”,
“initiate_forensics”])
  log_remediation(audit_log, alert, action, timestamp)
function maintain_non_repudiation( ):
  for each telemetry_data in distributed_database:
      create_log_entry(audit_log, telemetry_data, metadata=[“file_hash”,
“network_details”, “user_auth”])
  sign_log_entry(audit_log, cryptographic_key)
function update_models( ):
  while system_active:
  feedback = retrieve_security_team_feedback(web_console)
  new_telemetry = retrieve_recent_telemetry(time_window=1_day)
  supervised_model.retrain(new_telemetry, feedback)
  unsupervised_model.update_clusters(new_telemetry)
  update_baseline(distributed_database, new_baseline)
main( ):
  monitor_endpoints( )
  establish_baseline( )
  while system_active:
  detect_anomalies( )
  correlate_network_patterns( )
  integrate_threat_intelligence( )
  generate_alerts( )
  remediate_anomalies( )
  maintain_non_repudiation( )
  update_models( )
```

### Explanation for AI/ML System and Processes for Connection Correlation Engine Pseudocode:

The pseudocode outlines a comprehensive system for correlating endpoint events, processes, and network connections to detect cybersecurity threats using artificial intelligence and machine learning. The initialization phase sets up critical components, including configuration parameters specifying monitored locations (e.g., application data and temporary directories, user-specific registry hives), alert thresholds, and a threat intelligence API for external data integration. A distributed processing framework, leveraging cloud-based serverless architectures, ensures scalability across thousands of endpoints. Artificial intelligence models, comprising supervised and unsupervised components, are initialized to analyze telemetry data, while a web console with interactive visualizations (e.g., connection graphs, activity timelines) serves as the user interface. A secure audit log is established to maintain non-repudiation, storing cryptographically signed records of all activities.

The monitor_endpoints function continuously collects telemetry data from each endpoint in the network, focusing on file system operations (read, write, execute) in specified directories, registry operations (create, modify) in user-specific hives, and network traffic (TCP/UDP protocols). Metadata, such as file names, timestamps, and user permissions, is captured to enrich the dataset. Telemetry is stored in a distributed database, indexed by endpoint ID, to support scalable processing and retrieval. This function ensures real-time monitoring, capturing granular details of file executions, registry changes, and network connections initiated from monitored locations.

The establish_baseline function creates a tailored baseline of normal activity for each endpoint, using historical telemetry data from a 30-day window. Supervised learning models are trained on labeled data to identify normal patterns, while unsupervised clustering models group similar activities based on features like file access frequency, execution types, and contacted domains. The combined output forms a baseline stored in the distributed database, enabling the system to compare real-time telemetry against expected behaviors. This baseline is critical for detecting deviations in diverse environments with varying user permissions.

The detect_anomalies function processes real-time telemetry, comparing it against the baseline using artificial intelligence models to compute anomaly scores. If a score exceeds the endpoint-specific alert threshold, the system extracts details, such as file execution specifics or network connection data, and checks if the contacted domain is absent from the baseline. Anomalies are flagged with risk scores calculated based on factors like file type, domain reputation, and execution context, ensuring high-priority threats are identified promptly.

The correlate_network_patterns function aggregates telemetry across endpoints within a one-hour window, using unsupervised models to detect network-wide patterns, such as frequent connections to a specific domain. Patterns with high anomaly scores trigger the identification of related anomalies across endpoints, which are stored for further analysis. This function enables the detection of coordinated attacks, such as distributed campaigns, by analyzing subnet and network-level data, providing a holistic view of threats.

The integrate_threat_intelligence function fetches real-time data from an external threat intelligence API, cross-referencing telemetry against known malicious domains or file hashes. Matches result in increased anomaly scores, enhancing detection accuracy. This seamless integration ensures the system remains current with emerging threats, leveraging external data to validate anomalies without manual intervention.

The generate_alerts function creates prioritized alerts for anomalies exceeding thresholds, including detailed information like risk scores, timestamps, and endpoint context. Alerts are visualized on the web console using connection graphs and activity timelines, and sent to security teams based on priority. This function ensures that actionable insights are delivered promptly, facilitating rapid threat assessment and response.

The remediate_anomalies function implements remediation actions for high-risk alerts, such as automatically quarantining endpoints or blocking domains, while recommending manual actions (e.g., forensic analysis) for lower-risk cases. All actions are logged in the audit log with timestamps, ensuring compliance and traceability. This function balances automation and human oversight to mitigate threats efficiently.

The maintain_non_repudiation function creates cryptographically signed log entries for all telemetry data, including file hashes, network details, and user authentication data, ensuring verifiable records for forensic analysis. This lightweight approach supports traceability without significant computational overhead, making it practical for real-time use.

The update_models function incorporates security team feedback and recent telemetry to retrain supervised models and update unsupervised clusters, refining the baseline daily. This continuous learning ensures the system adapts to evolving user behaviors and system configurations, maintaining detection accuracy in dynamic environments.

The main function orchestrates the system's operation, initiating endpoint monitoring and baseline establishment, then running continuous loops for anomaly detection, network correlation, threat intelligence integration, alert generation, remediation, non-repudiation, and model updates. This ensures all components work cohesively to provide scalable, real-time cybersecurity protection.

### Pseudocode for Endpoint Telemetry:

```
initialize system with configuration parameters (monitored_locations, registry_hives,
alert_thresholds, threat_intelligence_api)
initialize ai_ml_models (clustering_model, anomaly_detection_model)
initialize endpoint_agent (lightweight_monitoring)
initialize audit_log (secure_storage)
initialize reporting_module (visualizations)
function monitor_endpoint_activity( ):
  set monitored_locations = [“/AppData/Local”, “/Temp”, “HKEY_CURRENT_USER”]
  set monitored_extensions = [“.exe”, “.dll”, “.bat”, “.ps1”]
  while endpoint_active:
  collect telemetry_data:
            file_operations = monitor_file_system(monitored_locations,
operations=[“create”, “modify”, “delete”, “execute”])
            registry_operations = monitor_registry(HKEY_CURRENT_USER,
operations=[“create”, “modify”])
        network_connections = monitor_network_traffic(source=endpoint,
protocols=[“TCP”, “UDP”])
        metadata = capture_metadata(file_operations, registry_operations,
network_connections)
  store telemetry_data in local_database(endpoint_id, telemetry_data)
function establish_user_baseline( ):
  historical_data = retrieve_telemetry_data(endpoint_id, time_window=30_days)
              clustering_model.group_activities(historical_data,
features=[“file_access_frequency”, “file_type”, “registry_changes”])
  baseline = clustering_model.output_clusters( )
  store baseline in local_database(endpoint_id, baseline)
function detect_endpoint_anomalies( ):
  while endpoint_active:
  telemetry_data = retrieve_real_time_telemetry(endpoint_id)
  baseline = retrieve_baseline(endpoint_id)
  anomaly_score = anomaly_detection_model.predict(telemetry_data, baseline)
  if anomaly_score > alert_thresholds[endpoint_id]:
            anomaly_details = extract_anomaly_details(telemetry_data,
type=[“file_execution”, “registry_change”])
              if anomaly_details.file_type in monitored_extensions or
anomaly_details.registry_change not in baseline:
                flag_anomaly(endpoint_id, anomaly_details,
risk_score=calculate_risk(anomaly_details))
function correlate_network_activity( ):
  for each anomaly in local_database:
  if anomaly.network_connection:
    network_data = retrieve_network_telemetry(anomaly.connection_id)
    if network_data.domain not in baseline.domains:
    update_anomaly_score(anomaly, increase_factor=1.2)
    store correlated_anomaly in local_database(anomaly_id, network_data)
function integrate_threat_intelligence( ):
  while endpoint_active:
  threat_data = fetch_threat_intelligence(threat_intelligence_api)
  for each telemetry_data in local_database:
          if telemetry_data.file_hash in threat_data.malicious_hashes or
telemetry_data.domain in threat_data.malicious_domains:
    update_anomaly_score(telemetry_data, increase_factor=1.5)
function generate_reports( ):
  for each anomaly in local_database:
  if anomaly.risk_score > alert_thresholds[endpoint_id]:
          report = create_report(anomaly_details, risk_score, timestamp,
endpoint_context)
    visualize_report(reporting_module, report, visualizations=[“activity_timeline”,
“registry_graph”])
    store_report(reporting_module, report)
function remediate_anomalies( ):
  for each report in reporting_module:
  if report.risk_score > automated_remediation_threshold:
      execute_remediation(action=[“quarantine_file”, “block_connection”],
endpoint=report.endpoint_id)
  else:
      recommend_remediation(reporting_module, actions=[“isolate_endpoint”,
“initiate_forensics”])
  log_remediation(audit_log, report, action, timestamp)
function maintain_non_repudiation( ):
  for each telemetry_data in local_database:
      create_log_entry(audit_log, telemetry_data, metadata=[“file_hash”,
“network_details”, “user_auth”])
  sign_log_entry(audit_log, cryptographic_key)
function update_models( ):
  while endpoint_active:
  feedback = retrieve_security_team_feedback(reporting_module)
  new_telemetry = retrieve_recent_telemetry(time_window=1_day)
  clustering_model.update_clusters(new_telemetry)
  anomaly_detection_model.retrain(new_telemetry, feedback)
  update_baseline(local_database, new_baseline)
function aggregate_telemetry( ):
  aggregated_data = collect_telemetry_from_endpoints(network)
  store aggregated_data in central_database(network_id, aggregated_data)
main( ):
  monitor_endpoint_activity( )
  establish_user_baseline( )
  while endpoint_active:
  detect_endpoint_anomalies( )
  correlate_network_activity( )
  integrate_threat_intelligence( )
  generate_reports( )
  remediate_anomalies( )
  maintain_non_repudiation( )
  update_models( )
  aggregate_telemetry( )
```

### Explanation for Endpoint Telemetry Pseudocode:

The pseudocode describes a system for granular monitoring and analysis of endpoint activities to detect malicious behavior using artificial intelligence and machine learning. The initialization phase configures the system with parameters specifying monitored locations (e.g., application data and temporary directories, user-specific registry hives), alert thresholds, and a threat intelligence API. Artificial intelligence models, including clustering and anomaly detection models, are initialized to analyze telemetry, while a lightweight endpoint agent ensures minimal performance impact. A secure audit log stores cryptographically signed records, and a reporting module generates visualizations like activity timelines and registry graphs for compliance and analysis.

The monitor_endpoint_activity function collects telemetry data from a single endpoint, focusing on file system operations (create, modify, delete, execute) in specified directories, registry operations (create, modify) in user-specific hives, and network traffic (TCP/UDP protocols). Metadata, such as file paths, timestamps, and user accounts, is captured to enrich the dataset. Telemetry is stored in a local database, indexed by endpoint ID, to support efficient processing and retrieval. This function ensures real-time monitoring, capturing detailed file and registry events, as well as network connections.

The establish_user_baseline function creates a user-specific baseline using historical telemetry from a 30-day window. The clustering model groups similar activities based on features like file access frequency, file types, and registry changes, producing a baseline stored in the local database. This baseline reflects typical user behavior, enabling the system to detect deviations in environments with diverse permissions.

The detect_endpoint_anomalies function processes real-time telemetry, comparing it against the baseline using the anomaly detection model to compute anomaly scores. If a score exceeds the endpoint-specific threshold, the system extracts details, such as file execution or registry change specifics, and checks if the file type or registry change is unexpected. Anomalies are flagged with risk scores based on factors like file type and execution context, ensuring prompt identification of high-priority threats.

The correlate_network_activity function examines network connections associated with anomalies, retrieving network telemetry to check if the contacted domain is absent from the baseline. Matches increase the anomaly score, and correlated anomalies are stored for further analysis. This function enhances detection by linking local endpoint events with external network activity, identifying potential command-and-control communications.

The integrate_threat_intelligence function fetches real-time data from the threat intelligence API, cross-referencing telemetry against known malicious file hashes or domains. Matches result in increased anomaly scores, improving detection accuracy. This seamless integration ensures the system remains current with emerging threats, leveraging external data to validate anomalies.

The generate_reports function creates detailed reports for anomalies exceeding thresholds, including risk scores, timestamps, and endpoint context. Reports are visualized using timelines and graphs, stored in the reporting module for compliance and analysis. This function ensures actionable insights are delivered to security teams, facilitating rapid threat assessment.

The remediate_anomalies function implements remediation actions for high-risk reports, such as quarantining files or blocking connections, while recommending manual actions (e.g., forensic analysis) for lower-risk cases. All actions are logged in the audit log, ensuring compliance and traceability. This function balances automation and human oversight to mitigate threats efficiently.

The maintain_non_repudiation function creates cryptographically signed log entries for all telemetry data, including file hashes, network details, and user authentication data, ensuring verifiable records for forensic analysis. This lightweight approach supports traceability without significant computational overhead, making it practical for real-time use.

The update_models function incorporates security team feedback and recent telemetry to update clustering and anomaly detection models, refining the baseline daily. This continuous learning ensures the system adapts to evolving user behaviors, maintaining detection accuracy in dynamic environments.

The aggregate_telemetry function collects telemetry from all endpoints, storing it in a central database for network-wide analysis. This supports the identification of patterns across endpoints, enhancing the system's ability to detect coordinated threats.

The main function orchestrates the system's operation, initiating endpoint monitoring and baseline establishment, then running continuous loops for anomaly detection, network correlation, threat intelligence integration, report generation, remediation, non-repudiation, model updates, and telemetry aggregation. This ensures all components work cohesively to provide granular, real-time endpoint security.

Pseudocode for AI/ML Driven User Event Telemetry and Correlation System and Processes:

```
initialize system with configuration parameters (data_stores, metadata_repositories,
alert_thresholds, threat_intelligence_api)
initialize distributed_processing_framework (cloud_containerized)
initialize ai_ml_models (clustering_model, anomaly_detection_model)
initialize web_console (dashboard, visualizations)
initialize audit_log (secure_storage)
function monitor_user_events( ):
  set data_stores = [“database_servers”, “file_repositories”]
  set event_types = [“file_access”, “app_interaction”, “db_query”]
  while system_active:
  for each data_store in data_stores:
    collect telemetry_data:
    user_events = monitor_data_store(data_store, event_types)
      metadata = capture_metadata(user_events, fields=[“user_id”, “file_type”,
“access_time”, “ip_address”, “device_type”])
    store telemetry_data in distributed_database(data_store_id, telemetry_data)
function establish_user_baseline( ):
  for each user_group in organization:
              historical_data = retrieve_telemetry_data(user_group_id,
time_window=30_days)
                  clustering_model.group_activities(historical_data,
features=[“access_frequency”, “file_type”, “access_time”])
  baseline = clustering_model.output_clusters( )
  store baseline in distributed_database(user_group_id, baseline)
function detect_conditional_events( ):
  while system_active:
  for each user in organization:
    telemetry_data = retrieve_real_time_telemetry(user_id)
    baseline = retrieve_baseline(user_group_id)
        anomaly_score = anomaly_detection_model.predict(telemetry_data,
baseline)
    if anomaly_score > alert_thresholds[user_id]:
              conditional_event = extract_event_details(telemetry_data,
type=[“file_access”, “unusual_location”])
              if conditional_event.location not in baseline.locations or
conditional_event.time not in baseline.times:
                flag_conditional_event(user_id, conditional_event,
risk_score=calculate_risk(conditional_event))
function generate_canary_events( ):
  for each conditional_event in distributed_database:
  if conditional_event.risk_score > canary_threshold:
                canary_event = create_canary_event(conditional_event,
track_actions=[“file_download”, “data_transfer”])
    monitor_subsequent_actions(user_id, canary_event, time_window=1_hour)
    if subsequent_actions.detected:
    update_conditional_event_score(conditional_event, increase_factor=1.3)
    store canary_event in distributed_database(canary_id, canary_event)
function correlate_metadata( ):
  for each conditional_event in distributed_database:
      metadata = fetch_metadata_repositories(repositories=[“ip_reputation”,
“user_permissions”, “geolocation”])
          if conditional_event.ip_address in metadata.high_risk_ips or
conditional_event.user_id not in metadata.allowed_groups:
    update_conditional_event_score(conditional_event, increase_factor=1.5)
    store correlated_event in distributed_database(event_id, metadata)
function integrate_threat_intelligence( ):
  while system_active:
  threat_data = fetch_threat_intelligence(threat_intelligence_api)
  for each telemetry_data in distributed_database:
            if telemetry_data.ip_address in threat_data.high_risk_ips or
telemetry_data.file_type in threat_data.malicious_types:
    update_anomaly_score(telemetry_data, increase_factor=1.5)
function generate_alerts( ):
  for each conditional_event in distributed_database:
  if conditional_event.risk_score > alert_thresholds[user_id]:
    alert = create_alert(conditional_event, risk_score, timestamp, user_context)
        visualize_alert(web_console, alert, visualizations=[“access_timeline”,
“geolocation_map”])
    send_alert_to_security_team(alert, priority=conditional_event.risk_score)
function remediate_anomalies( ):
  for each alert in web_console:
  if alert.risk_score > automated_remediation_threshold:
            execute_remediation(action=[“restrict_access”, “revoke_token”],
user=alert.user_id)
  else:
          recommend_remediation(web_console, actions=[“isolate_device”,
“notify_admin”])
  log_remediation(audit_log, alert, action, timestamp)
function maintain_non_repudiation( ):
  for each telemetry_data in distributed_database:
        create_log_entry(audit_log, telemetry_data, metadata=[“file_hash”,
“network_details”, “user_auth”])
  sign_log_entry(audit_log, cryptographic_key)
function update_models( ):
  while system_active:
  feedback = retrieve_security_team_feedback(web_console)
  new_telemetry = retrieve_recent_telemetry(time_window=1_day)
  clustering_model.update_clusters(new_telemetry)
  anomaly_detection_model.retrain(new_telemetry, feedback)
  update_baseline(distributed_database, new_baseline)
main( ):
  monitor_user_events( )
  establish_user_baseline( )
  while system_active:
  detect_conditional_events( )
  generate_canary_events( )
  correlate_metadata( )
  integrate_threat_intelligence( )
  generate_alerts( )
  remediate_anomalies( )
  maintain_non_repudiation( )
  update_models( )
```

### Explanation for AI/ML Driven User Event Telemetry and Correlation System and Processes Pseudocode:

The pseudocode delineates a system for tracking and analyzing user interactions with backend databases or data stores to enhance security and traceability using artificial intelligence and machine learning. The initialization phase configures the system with parameters specifying data stores (e.g., database servers, file repositories), metadata repositories, alert thresholds, and a threat intelligence API. A distributed processing framework, leveraging cloud-based containerized environments, ensures scalability across thousands of users and data stores. Artificial intelligence models, including clustering and anomaly detection models, are initialized to analyze telemetry, while a web console with visualizations (e.g., access timelines, geolocation maps) serves as the user interface. A secure audit log stores cryptographically signed records to maintain non-repudiation.

The monitor_user_events function collects telemetry data from specified data stores, focusing on user events like file accesses, application interactions, and database queries. Metadata, such as user identity, file type, access time, IP address, and device type, is captured to enrich the dataset. Telemetry is stored in a distributed database, indexed by data store ID, to support scalable processing and retrieval. This function ensures real-time monitoring, capturing granular details of user interactions across the organization's IT environment.

The establish_user_baseline function creates a normalized baseline for each user group using historical telemetry from a 30-day window. The clustering model groups similar activities based on features like access frequency, file types, and access times, producing a baseline stored in the distributed database. This baseline reflects typical user group behavior, enabling the system to detect deviations in environments with diverse roles and permissions.

The detect_conditional_events function processes real-time telemetry, comparing it against the baseline using the anomaly detection model to compute anomaly scores. If a score exceeds the user-specific threshold, the system extracts details, such as file access or unusual location specifics, and checks if the location or time is unexpected. Conditional events are flagged with risk scores based on factors like file sensitivity and access context, ensuring prompt identification of high-priority threats.

The generate_canary_events function creates dynamic canary events for high-risk conditional events, tracking subsequent actions like file downloads or data transfers within a one-hour window. If subsequent actions are detected, the conditional event's score is increased, and the canary event is stored for further analysis. This function enhances detection by confirming anomalies through follow-up behavior, reducing unnecessary alerts while maintaining sensitivity.

The correlate_metadata function fetches metadata from external repositories (e.g., IP reputation, user permissions, geolocation) to provide context for conditional events. Matches with high-risk IPs or unauthorized user groups increase event scores, and correlated events are stored for analysis. This function ensures anomalies are evaluated comprehensively, leveraging diverse metadata sources to improve accuracy.

The integrate_threat_intelligence function fetches real-time data from the threat intelligence API, cross-referencing telemetry against known high-risk IPs or file types. Matches result in increased anomaly scores, enhancing detection accuracy. This seamless integration ensures the system remains current with emerging threats, leveraging external data to validate anomalies.

The generate_alerts function creates prioritized alerts for conditional events exceeding thresholds, including risk scores, timestamps, and user context. Alerts are visualized on the web console using timelines and geolocation maps, and sent to security teams based on priority. This function ensures actionable insights are delivered promptly, facilitating rapid threat assessment.

The remediate_anomalies function implements remediation actions for high-risk alerts, such as restricting access or revoking tokens, while recommending manual actions (e.g., device isolation) for lower-risk cases. All actions are logged in the audit log, ensuring compliance and traceability. This function balances automation and human oversight to mitigate threats efficiently.

The maintain_non_repudiation function creates cryptographically signed log entries for all telemetry data, including file hashes, network details, and user authentication data, ensuring verifiable records for forensic analysis. This lightweight approach supports traceability without significant computational overhead, making it practical for real-time use.

The update_models function incorporates security team feedback and recent telemetry to update clustering and anomaly detection models, refining the baseline daily. This continuous learning ensures the system adapts to evolving user behaviors, maintaining detection accuracy in dynamic environments.

The main function orchestrates the system's operation, initiating user event monitoring and baseline establishment, then running continuous loops for conditional event detection, canary event generation, metadata correlation, threat intelligence integration, alert generation, remediation, non-repudiation, and model updates. This ensures all components work cohesively to provide scalable, real-time user security.

The systems and methods disclosed herein, encompassing three aspects for enhancing cybersecurity through artificial intelligence and machine learning, offer a robust framework for detecting and mitigating threats in corporate IT environments. These aspects include a system for correlating endpoint events, processes, and network connections, a system for granular endpoint telemetry, and a system for user event telemetry with dynamic canary events. Numerous alternatives, modifications, combinations, and customizations can be applied to these systems while remaining within the spirit and scope of the disclosure, ensuring flexibility to adapt to diverse organizational needs, technological advancements, and evolving threat landscapes.

One alternative to the first aspect, which focuses on correlating endpoint events with network connections, involves modifying the scope of monitored locations. Instead of targeting specific directories like application data storage or temporary file management and user-specific registry hives, the system could extend monitoring to additional file system locations, such as user home directories, system-wide temporary directories, or cloud-synced folders, depending on the organization's infrastructure. This modification would broaden the system's coverage, capturing telemetry from a wider range of potential threat vectors while maintaining the core functionality of correlating file operations with network activities.

Another modification for the first aspect could involve altering the artificial intelligence and machine learning models used for anomaly detection. While the system employs supervised and unsupervised models, such as clustering algorithms, alternative models like deep learning neural networks, reinforcement learning, or graph-based anomaly detection could be implemented. These models might enhance the system's ability to detect complex patterns in large-scale telemetry data, particularly for advanced persistent threats with subtle network behaviors, without departing from the system's objective of identifying deviations from a baseline.

A customization option for the first aspect includes adjusting the granularity of network correlation. The system currently aggregates telemetry across endpoints within a one-hour window to detect network-wide patterns. This window could be modified to shorter intervals (e.g., 10 minutes) for real-time detection in high-risk environments or extended (e.g., 24 hours) for low-risk settings to reduce computational overhead. Such adjustments would tailor the system's sensitivity to organizational risk tolerance while preserving its network-level correlation capability.

The second aspect, centered on granular endpoint telemetry, can be modified by expanding the types of telemetry data collected. Beyond file operations (create, modify, delete, execute) and registry changes, the system could monitor additional endpoint activities, such as process creation, memory usage patterns, or system call sequences. This expansion would provide a more comprehensive view of endpoint behavior, enabling the detection of sophisticated threats that manipulate system resources without altering files or registries, while aligning with the system's focus on early anomaly detection.

An alternative for the second aspect involves deploying the endpoint agent on different platforms. The system is designed for endpoints like desktops and laptops, but it could be adapted for mobile devices, IoT devices, or virtualized environments. This adaptation would require optimizing the lightweight agent for resource-constrained platforms, ensuring compatibility with diverse operating systems (e.g., Android, iOS, Linux), while maintaining the system's granular telemetry collection and analysis capabilities.

A customization for the second aspect could involve varying the baseline establishment period. The system uses a 30-day historical window to create a user-specific baseline, but this could be shortened (e.g., 7 days) for rapidly changing environments or lengthened (e.g., 90 days) for stable settings to capture long-term patterns. This adjustment would enhance the system's adaptability to different organizational dynamics while preserving its ability to detect deviations based on user-specific norms.

The third aspect, which tracks user interactions with data stores and employs dynamic canary events, can be modified by altering the types of user events monitored. Instead of focusing on file accesses, application interactions, and database queries, the system could include additional events, such as user authentication attempts, API calls, or configuration changes. This modification would broaden the system's scope, capturing a wider range of user activities that could indicate security breaches, while maintaining its emphasis on traceability and non-repudiation.

An alternative for the third aspect involves changing the mechanism for generating canary events. The system currently creates canary events to track subsequent actions like file downloads or data transfers. This could be modified to include other follow-up actions, such as user logouts, session terminations, or privilege escalations, which might provide additional context for confirming anomalies. This change would enhance the system's proactive threat mitigation capabilities while retaining its dynamic tracking approach.

A customization option for the third aspect includes adjusting the metadata repositories used for correlation. The system integrates with IP reputation databases, user group permissions, and geolocation services, but additional repositories, such as device fingerprint databases, user role hierarchies, or behavioral biometrics, could be incorporated. This customization would provide richer context for evaluating conditional events, improving anomaly detection accuracy in environments with complex user structures, while staying within the system's framework of context-aware analysis.

Combinations across the three aspects can further enhance functionality. For instance, the network correlation capabilities of the first aspect could be integrated with the endpoint telemetry of the second aspect to create a hybrid system that simultaneously monitors local endpoint activities and network-wide patterns. This combination would enable the system to detect threats that span both local and network domains, such as malware that modifies a registry key and communicates with an external server, by leveraging the granular telemetry of the second aspect and the correlation algorithms of the first aspect.

Another combination involves merging the dynamic canary event mechanism of the third aspect with the endpoint telemetry of the second aspect. The second aspect's system could be modified to generate canary events for high-risk endpoint anomalies, tracking subsequent file or registry operations to confirm threats. This integration would enhance the second aspect's proactive detection capabilities, allowing it to confirm anomalies through follow-up behavior, similar to the third aspect's approach, while maintaining its focus on endpoint-specific monitoring.

The first and third aspects could be combined to create a system that correlates user events with network connections. The third aspect's user-centric telemetry could be extended to include network connection data, which the first aspect's correlation algorithms would analyze to detect anomalies involving both user actions and external communications. This combination would provide a comprehensive view of threats that involve user interactions and network activities, such as a compromised account accessing sensitive files and exfiltrating data, while preserving the core functionalities of both aspects.

Customizations across all aspects can include modifying the artificial intelligence models' training data sources. Instead of relying solely on historical telemetry, the systems could incorporate synthetic data generated from threat simulations or anonymized datasets from industry partners. This modification would enhance model robustness, particularly for detecting rare or emerging threats, while maintaining the systems' reliance on machine learning for anomaly detection.

The systems' alert prioritization mechanisms can be customized to incorporate additional risk factors, such as user role criticality, data sensitivity levels, or endpoint location within the network topology. This customization would allow organizations to align alert prioritization with their specific security policies, ensuring that alerts reflect the relative importance of affected assets, while staying within the systems' framework of risk-based prioritization.

The remediation actions in all aspects can be modified to include alternative strategies, such as sandboxing suspicious files, rerouting network traffic through a secure gateway, or enforcing multi-factor authentication for flagged users. These alternatives would provide organizations with flexible response options, tailored to their infrastructure and risk tolerance, while maintaining the systems' focus on rapid threat mitigation.

The systems' integration with external threat intelligence feeds can be expanded to include additional sources, such as open-source intelligence platforms, dark web monitoring services, or industry-specific threat databases. This modification would enhance the systems' ability to detect emerging threats, particularly those specific to certain sectors, while preserving their reliance on real-time intelligence for anomaly validation.

The distributed processing frameworks used in all aspects can be customized to operate on different architectures, such as on-premises clusters, hybrid cloud environments, or edge computing nodes. This customization would enable organizations to deploy the systems in alignment with their infrastructure preferences, ensuring scalability and performance in diverse settings, while maintaining the systems' ability to handle large-scale telemetry data.

The visualization capabilities of the web consoles can be modified to include additional formats, such as 3D network topology maps, predictive anomaly trend graphs, or interactive user behavior profiles. These modifications would enhance the consoles' usability, providing security teams with more intuitive tools for threat assessment, while staying within the systems' framework of actionable insights.

The audit logging mechanisms in all aspects can be customized to support different cryptographic algorithms, such as post-quantum cryptography, or to integrate with blockchain-based ledgers for enhanced tamper resistance. This customization would strengthen non-repudiation in environments with stringent security requirements, while maintaining the systems' lightweight approach to traceability.

The systems' continuous learning mechanisms can be modified to incorporate federated learning, where models are trained across multiple organizations without sharing raw data, enhancing privacy and enabling collaborative threat detection. This modification would broaden the systems' applicability in multi-tenant or consortium settings, while preserving their adaptive learning capabilities.

The systems can be combined into a unified platform that integrates endpoint telemetry, network correlation, and user event tracking into a single interface. This combination would provide a holistic cybersecurity solution, allowing security teams to monitor and respond to threats across all three domains from a centralized console, while retaining the distinct functionalities of each aspect. The platform could be customized to emphasize specific aspects based on organizational needs, such as prioritizing endpoint telemetry in environments with high insider risk or network correlation in distributed networks.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment. This flexibility ensures that the systems and methods can be adapted to a wide range of applications, infrastructures, and threat environments, maintaining their core objectives of proactive threat detection, scalability, and traceability.

1. A method for detecting anomalous network activity in a computing environment, comprising:
monitoring, by a computing system, file system locations and registry keys on an endpoint device where a user has read and write access, including at least one of an application data directory, a temporary directory, or a user-specific registry hive;
collecting, by the computing system, telemetry data including file read operations, file write operations, file executions, registry modifications, and network connections initiated from the monitored file system locations and registry keys;
establishing, by an artificial intelligence model, a baseline of normal activity for the telemetry data specific to the endpoint device, the baseline including patterns of file access frequency, execution types, and contacted domains;
detecting, by the artificial intelligence model, an anomaly by identifying a deviation from the baseline, wherein the deviation includes a file execution from a monitored location initiating a connection to a previously unseen domain;
correlating, by the computing system, the anomaly with network activity across a plurality of endpoint devices to identify a coordinated pattern of anomalous behavior;
integrating, by the computing system, threat intelligence data from an external source to validate the anomaly by cross-referencing the telemetry data with known malicious domains or file hashes;
generating, by the computing system, an alert including the anomaly, a risk score, and a visualization of the coordinated pattern for display on a centralized console; and
logging, by the computing system, the telemetry data and the alert in a cryptographically signed audit log to ensure non-repudiation.

2. The method of claim 1, wherein the artificial intelligence model includes a supervised learning model trained on historical telemetry data labeled as normal activity.

3. The method of claim 2, further comprising:
employing, by the artificial intelligence model, an unsupervised clustering model to group similar activities in the telemetry data based on file access frequency and execution types; and
combining outputs of the supervised learning model and the unsupervised clustering model to refine the baseline.

4. The method of claim 3, wherein correlating the anomaly with network activity includes aggregating telemetry data from the plurality of endpoint devices within a predefined time window of one hour.

5. The method of claim 4, wherein integrating the threat intelligence data includes automatically updating the artificial intelligence model with new malicious domain data retrieved from the external source.

6. The method of claim 5, further comprising:
calculating, by the computing system, the risk score for the anomaly based on a file type of the file execution, a reputation of the previously unseen domain, and a frequency of the coordinated pattern; and
prioritizing the alert on the centralized console based on the risk score.

7. The method of claim 6, wherein generating the alert includes creating a directed graph visualization showing connections between the endpoint device and the previously unseen domain.

8. The method of claim 7, further comprising:
executing, by the computing system, an automated remediation action when the risk score exceeds a predefined threshold, the automated remediation action including quarantining the endpoint device; and
recommending a manual remediation action via the centralized console when the risk score is below the predefined threshold.

9. The method of claim 8, wherein logging the telemetry data includes storing a cryptographic hash of a file associated with the file execution and network connection details in the audit log.

10. The method of claim 9, further comprising:
retrieving, by the computing system, feedback from a security team via the centralized console regarding the alert; and
retraining, by the computing system, the artificial intelligence model using the feedback and recent telemetry data to update the baseline.

11. A method for detecting anomalous network activity in a computing environment, comprising:
monitoring, by a computing system, file system locations and registry keys on an endpoint device where a user has read and write access, including at least one of an application data directory, a temporary directory, or a user-specific registry hive;
collecting, by the computing system, telemetry data including file read operations, file write operations, file executions, registry modifications, and network connections initiated from the monitored file system locations and registry keys, the telemetry data including metadata comprising file names, file paths, timestamps, user permissions, and process identifiers;
establishing, by an artificial intelligence model, a baseline of normal activity for the telemetry data specific to the endpoint device, the baseline including patterns of file access frequency, execution types, and contacted domains, using a supervised learning model trained on historical telemetry data labeled as normal activity and an unsupervised clustering model to group similar activities;
detecting, by the artificial intelligence model, an anomaly by identifying a deviation from the baseline, wherein the deviation includes a file execution from a monitored location initiating a connection to a previously unseen domain;
correlating, by the computing system, the anomaly with network activity across a plurality of endpoint devices within a one-hour time window to identify a coordinated pattern of anomalous behavior;
integrating, by the computing system, threat intelligence data from an external source to validate the anomaly by cross-referencing the telemetry data with known malicious domains or file hashes, and automatically updating the artificial intelligence model with new malicious domain data;
calculating, by the computing system, a risk score for the anomaly based on a file type of the file execution, a reputation of the previously unseen domain, and a frequency of the coordinated pattern;
generating, by the computing system, an alert including the anomaly, the risk score, a directed graph visualization showing connections between the endpoint device and the previously unseen domain, and a timeline of related activities for display on a centralized console;
prioritizing, by the computing system, the alert on the centralized console based on the risk score;
executing, by the computing system, an automated remediation action when the risk score exceeds a predefined threshold, the automated remediation action including quarantining the endpoint device or blocking the previously unseen domain;
recommending, by the computing system, a manual remediation action via the centralized console when the risk score is below the predefined threshold, the manual remediation action including initiating forensic analysis;
logging, by the computing system, the telemetry data and the alert in a cryptographically signed audit log to ensure non-repudiation, the audit log including a cryptographic hash of a file associated with the file execution and network connection details;
retrieving, by the computing system, feedback from a security team via the centralized console regarding the alert;
retraining, by the computing system, the artificial intelligence model using the feedback and recent telemetry data to update the baseline; and
processing, by the computing system, the telemetry data using a cloud-based distributed computing framework to ensure scalability across thousands of endpoint devices.

12. A system for detecting anomalous network activity in a computing environment, comprising:
a monitoring module configured to monitor file system locations and registry keys on an endpoint device where a user has read and write access, including at least one of an application data directory, a temporary directory, or a user-specific registry hive;
a telemetry collection module configured to collect telemetry data including file read operations, file write operations, file executions, registry modifications, and network connections initiated from the monitored file system locations and registry keys;
an artificial intelligence module configured to establish a baseline of normal activity for the telemetry data specific to the endpoint device, the baseline including patterns of file access frequency, execution types, and contacted domains;
an anomaly detection module configured to detect an anomaly by identifying a deviation from the baseline, wherein the deviation includes a file execution from a monitored location initiating a connection to a previously unseen domain;
a correlation module configured to correlate the anomaly with network activity across a plurality of endpoint devices to identify a coordinated pattern of anomalous behavior;
a threat intelligence integration module configured to integrate threat intelligence data from an external source to validate the anomaly by cross-referencing the telemetry data with known malicious domains or file hashes;
an alert generation module configured to generate an alert including the anomaly, a risk score, and a visualization of the coordinated pattern for display on a centralized console; and
a logging module configured to log the telemetry data and the alert in a cryptographically signed audit log to ensure non-repudiation.

13. The system of claim 12, wherein the artificial intelligence module includes a supervised learning model trained on historical telemetry data labeled as normal activity.

14. The system of claim 13, further comprising:
a clustering module configured to employ an unsupervised clustering model to group similar activities in the telemetry data based on file access frequency and execution types; and
a baseline refinement module configured to combine outputs of the supervised learning model and the unsupervised clustering model to refine the baseline.

15. The system of claim 14, wherein the correlation module is configured to aggregate telemetry data from the plurality of endpoint devices within a predefined time window of one hour.

16. The system of claim 15, wherein the threat intelligence integration module is configured to automatically update the artificial intelligence module with new malicious domain data retrieved from the external source.

17. The system of claim 16, further comprising:
a risk assessment module configured to calculate the risk score for the anomaly based on a file type of the file execution, a reputation of the previously unseen domain, and a frequency of the coordinated pattern; and
a prioritization module configured to prioritize the alert on the centralized console based on the risk score.

18. The system of claim 17, wherein the alert generation module is configured to create a directed graph visualization showing connections between the endpoint device and the previously unseen domain.

19. The system of claim 18, further comprising:
a remediation module configured to execute an automated remediation action when the risk score exceeds a predefined threshold, the automated remediation action including quarantining the endpoint device; and
a recommendation module configured to recommend a manual remediation action via the centralized console when the risk score is below the predefined threshold.

20. The system of claim 19, further comprising:
an audit module configured to store a cryptographic hash of a file associated with the file execution and network connection details in the audit log, the network connection details including source IP address, destination IP address, port numbers, and protocol type;
a feedback module configured to retrieve feedback from a security team via the centralized console regarding the alert, the feedback including validation of the anomaly as malicious or benign;
a retraining module configured to retrain the artificial intelligence module using the feedback and recent telemetry data to update the baseline, the recent telemetry data collected within a 24-hour period;
a scalability module configured to process the telemetry data using a cloud-based distributed computing framework to ensure scalability across thousands of endpoint devices, the cloud-based distributed computing framework utilizing serverless architectures to dynamically allocate resources based on telemetry volume; and
a visualization module configured to generate a timeline visualization of related activities associated with the anomaly, the timeline visualization including timestamps of file executions, registry modifications, and network connections, displayed on the centralized console to facilitate security team analysis.
